(19) United States
(12) Patent Application Publication
(10) Pub. No.: US 2026/0162139 A1
(43) Pub. Date: Jun. 11, 2026

(54) SYSTEM AND METHOD OF PROVIDING A VENDOR PORTAL TO MANAGE A PROCESS OF SELLING PRODUCTS AND PROVIDING BENEFITS

(71) Applicant: Grapevine Codes LLC, Huntingtown, MD (US)

(72) Inventors: Thomas M. ISAACSON, Huntingtown, MD (US); Joshua Lyman ISAACSON, Huntingtown, MD (US); Mason Tate ISAACSON, Huntingtown, MD (US); Lucas Thomas ISAACSON, Huntingtown, MD (US); Adam Dennis TURNER, Pleasant Grove, UT (US); Tanner Steven OSBURN, Mapleton, UT (US)

(21) Appl. No.: 19/464,749

(22) Filed: Jan. 30, 2026

Related U.S. Application Data
(63) Continuation-in-part of application No. 18/963,370, filed on Nov. 27, 2024.
(60) Provisional application No. 63/603,703, filed on Nov. 29, 2023.
(60) Provisional application No. 63/618,515, filed on Jan. 8, 2024.
(60) Provisional application No. 63/696,039, filed on Sep. 18, 2024.

(51) Int. Cl. G06Q 30/0214; G06Q 30/0601

(52) U.S. Cl. CPC G06Q 30/0214; G06Q 30/0641

(57) ABSTRACT

A system is configured to present, via a vendor interface, a product-management view. The system can receive one or more of: product data for a product offered for sale; configuration input associated with a respective physical object to be configured with or on units of the product, the respective physical object including at least one of a near field communication tag or a graphical code; and a benefit rule specifying a benefit to be provided to a first buyer of the product when a second buyer purchases a second product based on interaction between a second buyer device and the respective physical object. The system stores configuration records associating the product, the respective physical object, and the benefit rule. When the second buyer device interacts with the respective physical object and the second buyer purchases the second product, a purchasing service provides the benefit to the first buyer.

### PRIORITY CLAIM

The present application is a continuation-in-part of U.S. patent application Ser. No. 18/963,370, filed Nov. 27, 2024, which claims the benefit of U.S. Provisional Application No. 63/603,703, filed Nov. 29, 2023, U.S. Provisional Application No. 63/618,515, filed Jan. 8, 2024 and U.S. Provisional Application No. 63/696,039, filed Sep. 18, 2024, the contents of which are incorporated herein by reference.

### FIELD OF THE INVENTION

The disclosure introduces a new approach to sharing and purchasing products that people love. In general, a purchasing service is used as part of an ecosystem where each product can be marked with a unique code (via a near field communication tag or a visual object like a quick response code (QR code)) and the code is used to associate the individual first buyer with a first product so marked. Then, a friend can scan the marking or code of the first product with their mobile device and buy (as a second buyer) their own product (a second product) with a benefit being provided to the first buyer automatically for encouraging the purchase of a second product by their friend.

### BACKGROUND

In the general economy, people buy products online or in person in stores. Typically, the buyer will take the product home and enjoy the product. In some cases, a friend or family member may see that same product and desire one for themselves. In that case, the friend or family member will either purchase the same product online by going to Amazon.com or a merchant website or application or go to a store and buy one for themselves.

### BRIEF SUMMARY

The present disclosure addresses weaknesses in the core aspect of our economy. Mainly, when a buyer buys a product and then later when a friend or family member (FOFM) or other person wants to buy the same product, there is no easy mechanism to give the original buyer a benefit for contributing to the second purchase of the product. This disclosure introduces an entirely new ecosystem in which products can be marked with an object that is scannable such that when the first product is purchased, the first buyer of the product is associated with the first product and the object (which can have an individual code associated with the first product). When the object is scanned by a mobile phone of a friend who can be a second buyer. The second buyer can buy their own version of the product (a second product purchased by a second buyer). Because the ecosystem stores the association between the first buyer and the first product via the object, the first buyer can automatically get a benefit, such as a discount on another purchase or any type of benefit, such as a rebate or can in a user account. The disclosed approach can change the incentive structure within our entire economy and can enable the entire world to be a mall where products can be purchased and where each owner of a product can be an affiliate or salesperson, promoting products they have purchased and like.

The approach can be broadened to encompass any mechanism of storing in a database a connection between the first buyer of the first product. The connection can be made at the point-of-sale, through an existing record of a transaction such as via Amazon.com, or after the sale manually by a user adding their name and identification of the product and/or their purchase of the product to a database. Later, in general, the first product can be identified via a device of a second buyer, and in some manner, the identity of the first buyer can be obtained (such as through facial recognition, a confirmation text, a scan of a visual object, or other mechanisms) and a database can be checked for whether the first buyer did buy the first product. Then the second buyer can buy a second product for themselves and based on the connection recorded in the database of the first buyer purchase of the first product, the first buyer gets some kind of benefit.

In some aspects, the techniques described herein relate to a method including: identifying a first product being purchased by a first buyer; storing an association of the first product and the first buyer in a database; receiving an identification of the first product from a second buyer device; processing a purchase of a second product by a second buyer based on the identification; and providing a benefit to the first buyer based on the purchase of the second product.

In some aspects, the techniques described herein extend the purchasing service into a social referral platform that maintains, for each registered user (a “first buyer”), a dynamically updated social graph or friends list. The social graph may be built from explicit friend selections, imported contact lists, or repeated referral interactions, and may drive interfaces that show recent purchases made by friends, recommended products based on friends' activity, and attribution of second-buyer purchases back to specific first buyers. The system can further track streak metrics representing consecutive time periods in which one or more second-buyer purchases occur, and can unlock enhanced rewards, tiers, or promotional status when a user's streak satisfies defined thresholds. Users may designate “favorite” products and view analytics and dashboards highlighting favorite products and top-selling products for that user, including historical referral counts, conversion rates, and cumulative rewards.

In some aspects, additional referral and sharing mechanisms are supported. Beyond scanning a code on a physical product, a first buyer device and a second buyer device may engage in a phone-to-phone near-field communication (NFC) exchange in which the first buyer device emulates or transmits a digital object associated with a product the first buyer previously purchased. The second buyer device can receive the object and transition directly into a purchase flow for the corresponding product. The purchasing service may also generate shareable URLs or product links encoded with product and referrer identifiers for posting on external channels such as social-media platforms or messaging applications. These links can be treated as virtual objects that may be saved in a wallet or library and later redeemed; when a delayed purchase occurs through such a link, credit is still attributed to the originating first buyer.

In some aspects, the purchasing service can orchestrate promotional campaigns and sponsored placement around these referral objects. Campaigns may define time-limited modifications to baseline benefit and discount parameters, such as increased rewards to first buyers, enhanced discounts to second buyers, or boosted streak progression for eligible transactions. Campaigns may target particular products, categories, or user segments and may be surfaced via user-interface treatments such as badges, countdown timers, banners, or “product of the week” placements that incentivize early purchasing and sharing of featured products. Vendors or the service operator may bid for premium placement within campaign interfaces, define bundled or down-sell offers, or specify category-level priority rules that determine which products are highlighted when multiple qualifying products compete for attention. Real-time analytics measuring campaign performance, conversion funnels, and geographic response patterns may feed back into dynamic adjustment of campaign parameters.

In some aspects, sponsored placement can occur within multiple consumer-facing user-interface surfaces of the purchasing service, including a home feed, a campaign landing page, a “featured products” strip, a product detail page module, a “recommended for you” carousel, or a search or browse results list. In some implementations, the placement surface is selected based on the user's current interaction context (for example, browsing a category, viewing a referral object, or interacting with a favorites list), and the purchasing service selects one or more sponsored products to display according to campaign rules, placement scores, and applicable caps.

In some aspects, a vendor-facing configuration portal is provided that enables merchants and brands to onboard products into the purchasing service and to define how those products will participate in the referral-benefit ecosystem. Through a product-management view presented via the vendor interface, a vendor user can supply or edit product data (such as titles, images, variants, pricing information, categories, and fulfillment parameters) and associate each product with a respective physical or digital object that will be deployed on or with the product. The object can include, for example, a near field communication (NFC) tag embedded in or attached to a unit of the product, a graphical code (such as a QR code or other machine-readable symbol) printed on packaging, or a purely virtual object rendered within a digital wallet, social-media widget, or other software surface. Via the same product-management experience, the vendor can define one or more benefit rules that specify how benefits are to be granted to a first buyer when a second buyer purchases a second product based on interaction between a second buyer device and the configured object.

The vendor portal allows these configurations to be persisted as structured configuration records in a back-end database of the purchasing service, thereby associating, for each configured listing, the underlying product definition, the physical or digital object identifiers to be deployed on units of that product, and the benefit rules and constraints applicable to subsequent referral transactions. Benefit rules can, for example, specify a reward rate, a fixed or tiered credit amount, eligibility conditions, time windows, product or category scopes, caps on total benefit liability, or differentiated treatment for in-person scans versus online link activations. At runtime, when a second buyer device interacts with a configured object and the second buyer completes a qualifying purchase of the corresponding second product, the purchasing service consults the stored configuration records to determine the applicable benefit rule, attributes the transaction back to the first buyer associated with the original object, and automatically provides the defined benefit to the first buyer while optionally updating vendor-facing analytics and dashboards that summarize performance of the configured products and campaigns from the perspective of the vendor-organization.

In some aspects, a comprehensive vendor application or web portal allows merchants and brands (“vendor-organizations”) to manage their participation in the ecosystem. A vendor user may belong to multiple vendor-organizations and can switch among them via an organization overview interface. For each organization, a product dashboard enables enrollment of new products, editing of product metadata, and generation or export of associated objects (e.g., QR codes, NFC identifiers, or purely digital objects). A checkout-simulation tool can emulate the second-buyer purchase experience for a given product, allowing vendors to preview and tune product landing pages and purchase flows. Vendor-facing analytics can present product-level and organization-wide statistics such as total second-buyer sales, referral counts, top-performing products, campaign-driven conversions, and geographic distributions of activity. A vendor account dashboard may further support management of branding assets, store locations, benefit-policy defaults, fulfillment regions, and team permissions with role-based access control and audit logging.

In some aspects, the vendor application includes an integrations dashboard for connecting vendor-organizations to third-party payment and commerce platforms such as Stripe, Square, Shopify, and other processors or storefronts. Through this dashboard the purchasing service can guide vendors through authorization flows, retrieve catalog and account metadata, configure mapping between products and external SKUs, and receive normalized transaction events from multiple providers. The purchasing service can then determine when an external transaction corresponds to a qualifying second-buyer purchase associated with a particular object and can apply benefit-granting rules accordingly. Integration status views, error alerts, sandbox testing environments, and multi-platform event normalization logic can be provided to ensure that referral tracking and benefit payouts operate consistently across heterogeneous commerce systems.

In some aspects, the purchasing service maintains, for each first buyer, a monetary or cash-equivalent user balance representing accumulated reward value from qualifying second-buyer purchases. The user balance may be stored in an account controlled by the purchasing service and may increase as additional referred purchases occur. The first buyer may redeem all or part of the user balance by applying it directly to new purchases made through the service, by transferring value to an external financial account, or by using a payment credential or debit-type instrument provisioned into a digital wallet and backed by the stored balance. When the credential is used at participating merchants, the purchasing service can authorize transactions based on the available user balance and settle payments from the central account.

In some aspects, the techniques described herein further support a local-sale or “garage-sale” mode enabling sellers to rapidly list multiple physical items for local purchase. A seller device associated with a seller account may enter a local-sale mode in which the seller specifies item descriptions and prices for numerous items. The system can generate item-specific machine-readable codes (e.g., QR codes) and arrange them in a print layout aligned with adhesive label sheets for consumer printers. The seller can affix the printed codes to the physical items; a buyer scanning a code is presented with a purchase interface for that item, and payment proceeds are credited to the seller account. The service can support inventory status tracking, multi-item carts for buyers scanning multiple codes, selection among different payment providers, optional location-based gating to ensure proximity to the sale site, offline creation of codes with later synchronization, and seller-facing summaries of local-sale performance.

In some aspects, a website or enterprise-grade portal exposes additional tools including an add-on or plug-in marketplace, an application-programming-interface (API) library, and sandbox environments that enable developers and larger merchants to extend or integrate the purchasing service with existing systems. These tools can support custom integrations, specialized analytics modules, experimental campaign types, and enterprise reporting dashboards. Vendor-facing, consumer-facing, and platform-operator dashboards may present rich metric sets including, for example, sales volume, referral counts, conversion rates, average order values, scan-to-purchase ratios, repeat-purchase behavior, demographic and device breakdowns, geographic heat maps, and aggregated balances and cash-flow data maintained by the service. Such metrics can be used by vendors to optimize product offerings and campaigns, by consumers to understand their own referral performance and reward accumulation, and by the service operator to monitor ecosystem health, liquidity, and growth.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE SEVERAL VIEWS OF THE DRAWINGS

The accompanying drawings are presented to aid in the description of various aspects of the disclosure and are provided solely for illustration of the aspects and not limitation thereof.

FIG. 1 illustrates an ecosystem for managing purchases of products from a product initially bought by another person, in accordance with some aspects of this disclosure;

FIG. 2 illustrates a point-of-sale device, in accordance with some aspects of this disclosure;

FIG. 3 illustrates the use of a purchasing service, in accordance with some aspects of this disclosure;

FIG. 4 illustrates a product manufacturing operation, in accordance with some aspects of this disclosure;

FIG. 5A illustrates a wallet or application for managing purchases, in accordance with some aspects of this disclosure;

FIG. 5B illustrates a method of processing product purchases, in accordance with some aspects of this disclosure;

FIG. 5C illustrates redeeming a benefit at a time of a purchase, in accordance with some aspects of this disclosure;

FIG. 5D illustrates the use of a product wallet, in accordance with some aspects of this disclosure;

FIG. 5E illustrates a user interface to use at a point-of-sale, in accordance with some aspects of this disclosure;

FIG. 6A illustrates a method of providing a benefit to a first buyer, in accordance with some aspects of this disclosure;

FIG. 6B illustrates a method of providing a benefit to a buyer of a product, in accordance with some aspects of this disclosure;

FIG. 6C illustrates a method of sending objects to a first buyer device based on a purchase of a product, in accordance with some aspects of this disclosure;

FIG. 6D illustrates a method of granting a benefit to a buyer of a product, in accordance with some aspects of this disclosure;

FIG. 6E illustrates a method of transmitting a payment token to a merchant server, in accordance with some aspects of this disclosure;

FIG. 7A illustrates an ecosystem of businesses and services, in accordance with some aspects of this disclosure;

FIG. 7B illustrates a method for providing a benefit to a buyer of a product, in accordance with some aspects of this disclosure;

FIG. 7C illustrates a method of using a code management service, in accordance with some aspects of this disclosure;

FIG. 7D illustrates a method of providing a buyer of a product on a social media platform a benefit, in accordance with some aspects of this disclosure;

FIG. 8A illustrates a method of providing a benefit to a buyer of a product, in accordance with some aspects of this disclosure;

FIG. 8B illustrates a method of providing a benefit to a buyer of a product, in accordance with some aspects of this disclosure;

FIG. 8C illustrates a method of providing a benefit to a buyer, in accordance with some aspects of this disclosure;

FIG. 8D illustrates another method of providing a benefit to a buyer, in accordance with some aspects of this disclosure;

FIG. 9A illustrates a method of monitoring purchases for a buyer who has received a benefit, in accordance with some aspects of this disclosure;

FIG. 9B illustrates a method of using facial recognition to recognize the first buyer;

FIG. 10A illustrates a checkout flow, according to aspects of the disclosure;

FIG. 10B illustrates a checkout flow, according to aspects of the disclosure;

FIG. 10C illustrates a checkout flow with user feedback, according to aspects of the disclosure;

FIG. 10D illustrates a method of jumping out of and back into a checkout flow with user feedback, according to aspects of the disclosure;

FIG. 10E illustrates a method of providing a checkout flow, according to aspects of the disclosure;

FIG. 10F illustrates another method of providing a checkout flow, according to aspects of the disclosure;

FIG. 10G illustrates another method of providing a checkout flow, according to aspects of the disclosure;

FIG. 10H illustrates a method of providing a service based on a service request, according to some aspects of this disclosure; and

FIG. 11A illustrates an example user interface for a vendor-organization in connection with the concepts disclosed herein;

FIG. 11B illustrates various process flows for different ideas in connection with the concepts disclosed herein;

FIG. 12A illustrate a method aspect for manage social referral relationships among users, according to aspects of the disclosure;

FIG. 12B, illustrates a method aspect for providing referral and sharing mechanisms according to aspects of the disclosure;

FIG. 12C, illustrates a method aspect for operating a purchasing service that can orchestrate promotional campaigns and sponsored placement around these referral objects according to aspects of the disclosure;

FIG. 12D, illustrates a method aspect for operating a comprehensive vendor application or web portal allows merchants and brands (or vendor-organizations) to manage their participation in the ecosystem according to aspects of the disclosure;

FIG. 12E illustrates a method related to a vendor portal used to configure the operation of the basic concepts disclosed, according to aspects of the disclosure;

FIG. 13A, illustrates a method aspect for a vendor-facing integration platform, according to aspects of the disclosure;

FIG. 13B, illustrates a method aspect for providing benefits to the first buyer in a first user account, according to aspects of the disclosure;

FIG. 13C, illustrates a method aspect for operating a garage-sale mode for users to sell items, according to aspects of the disclosure;

FIG. 13D, illustrates a method aspect for providing an application programming interface to enable integration with other services, according to aspects of the disclosure;

FIG. 14A illustrates a method aspect related to social media posting and using a social media widget, according to aspects of the disclosure;

FIG. 14B illustrates an artificial intelligence model-assisted process, according to aspects of the disclosure; and

FIG. 15 illustrates a computing system, in accordance with some aspects of this disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

What is needed in the art is an entirely new infrastructure that encourages each person who buys a product to turn around and be a salesman for that product. The infrastructure disclosed herein achieves that goal and introduces a new incentive for each person who loves a particular product to be granted a benefit if a friend or family member (FOFM) buys the same product based on their influence. There are a number of different examples of how to first establish and record in a database a connection between the first buyer of a product and then later to identify the first product, and the first buyer and confirm in the database that there is a record of the purchase of the first product by the first buyer, and then to enable a second buyer to buy their own product (the second product) and provide a benefit to the first buyer because they were the means by which the second buyer bought the second product. Any example or any embodiment can have one of more features that can be mixed with any other one or more features of any other example or embodiment. It is contemplated that any individual feature is available for use in connection with any other feature no matter which example discusses a respective feature.

Various examples can include or be claimed as devices, applications configured on a mobile device or on a point-of-sale device, a desktop computer or any other computing device. For example, the processes disclosed here as performed by an application on a mobile device can be claimed. Separately, processed performed by a website, or a payment service, or a merchant device at a point of sale or a combination of different merchant devices (like a POS device for Apple Pay, and a QR code scanner, and/or another merchant device) can be the subject of separate claims for their respective operations. Methods, systems and computer-readable media can each be the subject of a claim. In some cases, where a method is described as being performed by a mobile device, for example, a complementary method is considered disclosed as being performed by another device in wireless communication with the mobile device. The first example discussed next relates to the use of a scannable code to establish the connection between a buyer and a product.

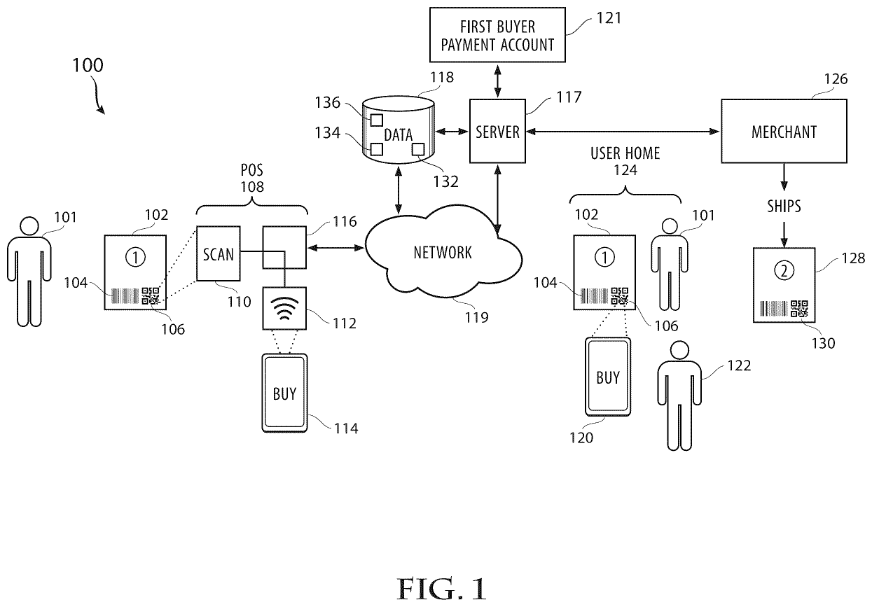

FIG. 1 illustrates an influencer benefit system 100 that includes a point-of-sale 108 where a first buyer 101 buys a first product 102 that has a universal product code (UPC) symbol 104 and an object 106. When the user 101 buys the product, they can use a credit/debit car, Apple Pay, Google Pay, Samsung Pay or any other payment mechanism (such as a digital wallet or cryptocurrency) using a first buyer device 114 at a point-of-sale device 112. A salesperson or the first buyer 101 scans the UPC symbol 104 using a point-of-sale scanner 110 at a point-of-sale location or POS 108. The POS 108 can represent any one or more devices used at the point-of-sale to grant discounts through quick response code (QR code) scanning, or receiving payments through near-field communication links, etc. The point-of-sale scanner 110 can scan both the UPC symbol 104 and the object 106. In another aspect, a point-of-sale system can include on near-field communication (NFC) device that is used to receive payments for Apple Pay or Google Pay, etc., which can be configured to be in a state to scan a near field communication tag or chip associated with a product. The POS 108 can also include a visual scanner that can also be placed in a state of scanning a visual object. These existing point-of-sale devices can be reprogrammed to accomplish the association of the first buyer 101 with the first product 102 at the POS 108.

In some cases, just by using a payment process or merchant such as Amazon, a purchase such as pair of shoes by Joe can be connected in the database 118 to the shoes. This can occur without a specialized visual code on the product but can simply occur at the time of sale where the product is connected to the buyer in a database. As outlined herein, the database can then be coordinated with social media network of a second buyer when the second buyer might perform a scan of the product or even select the product say on Amazon (which can also occur because their friend previously bought the first product 102) independent of a visual scan of a code or a product. The connection between the first buyer 102, the first product 102 can therefore occur through a number of different ways after the first product 102 is purchased as long as the database record in the database 118 is established. Later, when the first product 102 is chosen (like on Amazon), or scanned by a second buyer's phone 120, then an API call or other access to the database 118 can occur to determine the connection. Then, when the purchase is made, the first buyer 101 receives a benefit for their support or help in the second buyer 122 buying their own version of the first product 102.

As noted above for Amazon, they already know who has purchased the product given their account for each Amazon user. Thus, Amazon's existing data that links purchasers to the products they have purchased could include an extension of that database to the concepts disclosed herein where whether via a physical object, biometric or facial recognition, visual scanning of the product purchased by the first buyer, or other means, once the user's name is identified, a database access could occur in which an Amazon account could be checked to see if that person bought the product scanned and if so, then the second purchaser, buying their own product, can cause a benefit to be given to the first purchaser for their next Amazon purchase or for a purchase from the same merchant or manufacturer of the first product.

In one aspect, an updated UPC symbol 104 can include data that indicates or causes the POS 108, upon scanning the UPC symbol 104, to initiate a “product association process” or one or more steps needs to be taken to scan the object (electronically or visually) associated with the first product 102 to establish the association with the first buyer 101. For example, an NFC device can be placed in a state to receive a scan of an NFC tag on a product as instructed via a user interface for a clerk or person at a self check-out stand. Then the NFC device may be returned or placed in a later state to receive a payment via interaction with the first buyer device 121. Similarly, a scanner can be placed in a state to scan a visual object on the first product 102 and then later placed in a state to scan for a discount code.

If the user uses cash, then a graphical interface can be presented to a salesperson to enter in their personal information if desired. Data can also be inputted automatically using software stored on 114 such as an app or asset in the digital wallet, the information can be automatically inputted at the POS 108. By scanning the object 106 and obtaining payment data for the user, a database record can be made by a store server 116 that can be transmitted via a network 119 to a database 118 and/or a purchasing service 117 operating on a network-based server. The purchasing service 117 manages the association between the first buyer 101 and the first product 102 in the context of later purchases of the product by other buyers. Note that other buyers will not literally buy the very same product as the first buyer 101 but will typically buy their own product or a similar product prompted by their experience with the first product 102.

In one example, the first buyer 101 will register a payment account to yield a registered payment account 136 stored in the database 118 of the purchasing service 117 which identifies a first buyer payment account 121 in order to enable the processes disclosed herein. For example, once the purchasing service 117 has the record of the first buyer payment account 121, then the purchasing service 117 can monitor purchases of the first buyer 101 using that first buyer payment account 121 to grant (where applicable) the benefit such as a discount the next time the user makes a purchase at the merchant. In some aspects, the purchasing service 117 can establish a “policy” in which the first buyer 101, the merchant and any other data can be established for automatic monitoring of the first buyer 101 purchases such that when the first buyer 101 makes a purchase at the same merchant that sold the first product 101, a discount or some benefit is provided, such as a rebate back to their account or some other benefit.

Note that as used herein, the object 106 can also broadly encompass a graphical object such as a UPC symbol, an NFC tag, a QR code or similar type of code or any object that can transmit or transfer data to the second buyer device 120. For example, a near field communication (NFC) chip or tag on the product could be scanned when near the second buyer device 120 that can transfer the necessary data as disclosed herein to enable the second buyer 122 to purchase the second product 128.

There are a number of different ways in which the association of the first buyer 101 and the first product 102 product can be made. For example, the first buyer device 114 can be used to scan the object 106 at the point-of-sale 108 thus identifying the association which can be stored in the database 118. There may need to be some interaction at the point-of-sale to make the connection and the association but there are a number of different ways in which the association can be identified.

The first buyer 101 is thus identified as the person buying the first product 102. With the object 106 fixed on the first product 102, the first buyer 101 can go home 124 or to any other location with the first product 102. The first buyer 101 can then become a promoter of that product to their friends. When the FOFM decides they like the product, they can easily buy one for themselves and the first buyer 101 can get an automatic benefit. A second buyer 122 can use a second buyer device 120 to scan (using a camera on the second buyer device 120) the object 106 on the first product 102. For example, if the first product 102 is a lamp, the first buyer 101 can have the lamp at home and the second buyer 122 can desire to have the same lamp. The second buyer 122 when they scan the object 106 retrieves the information in the object 106. The information causes the second buyer device 120 to access a purchasing service 117 that can include a database 118 from which the association between the first buyer 101 and the first product 102 is retrieved. With the information about the first product 102 and the first buyer 101 available, the purchasing service 117 can enable a number of different actions.

For example, the purchasing service 117 can process a purchase and delivery of a second product 128 to the second buyer 122. Such a process can be done while remaining on the purchasing service 117 site or application or can be coordinated with a merchant server 126. The merchant server 126 for example might receive a transition automatically from the purchasing service 117 to a shopping cart where the second buyer 122 is ready to “one click” purchase the lamp for themselves. The lamp the second buyer 122 buys would be the second first product 102. The purchasing service 117 also processes a benefit to the first buyer 101 based on their influence in causes the purchase of the second first product 102 by the second buyer 122. For example, the first buyer 101 might receive money into a bank account, or a credit for a later purchase that the first buyer 101 might make, or a discount on another lamp purchased by the merchant, or a coupon designating those credits and or rewards may be stored on a digital wallet on the first buyer device 114 and so forth. In this regard, the payment account (typically an open-loop account, but this disclosure is not limited to open-loop accounts) can be tied to or registered with the purchasing service 117 such that the benefit can be provided. The result of the registration process is a registered payment account 136 stored in the database 118 of the purchasing service 117 for later use in connection with the principles disclosed herein. The purchasing service 117 can be connected to or have access to a first buyer payment account 121 of the first buyer 101. The first buyer 101 may register their first buyer payment account 121 with the purchasing service 117 (the registered payment account 136) to enable the purchasing service 117 to provide the benefit to the first buyer 101. There may be different accounts or mechanisms of providing the benefit to the first buyer 101 but in general one or more accounts can be registered with the purchasing service 117 by the first buyer 101 to enable the receipt of the benefit associated with a later sale.

In some aspects, a payment account of the first buyer 101 at their bank or credit card company, or a digital wallet holding cryptocurrency, or some other value holding account can be credited or tied to the purchasing service 117 such that the benefit can be granted. For example, a credit for the merchant who sold the first product 102 can be provided to the first buyer 101 such that the next time they make a purchase of another product, they receive a discount or rebate, or some other benefit associated with the later purchase.

The user experience is important in transactions like those disclosed. In some aspects, the second buyer 122 has already decided that they desire to buy the lamp. They may not want to shop for similar lamps, but they may just want to quickly buy one. The second buyer 122 experience can be that once they scan the object 106 with the second buyer device 120, they land on a checkout page served from the merchant server 126 populated with the lamp and configured for a purchasing process that they are capable of using. They may be able to simply purchase using Apple Pay or Google Pay given the configuration of their second buyer device 120 (who made it), their browser, or any other approach. If they have none of these payment processes, they can add their payment information in a traditional manner and make the purchase. The purchasing service 117 can manage or cause the transition to occur so that the second buyer 122 has a seamless experience.

While the second buyer 122 is being transitioned to the merchant server 126, the first buyer 101 can have the benefit provided via the purchasing service 117 based on the data in the database 118. Again, the benefit can be any number of different types of benefits including access to a venue, a discount, a free product or accessory, and so forth.

The first buyer 101 can have an application or registration with the purchasing service 117 that maintains all of their benefits. The user can for example, go to the merchant server 126 via the Internet 119 and purchase another lamp or product and their discount can be added at a point-of-sale for the first buyer 101 to realize the benefit. The first buyer 101 may receive a physical or virtual gift card or credit card with credit already applied as well.

In one aspect, the first buyer 101 can also buy the first product 102 again and a special treatment can occur because the first buyer 101 purchases another lamp or another game. In that case, a specific discount or other benefit which might be different from a different later FOFM buyer.

In one aspect, the purchasing service 117 can cause the second buyer 122 to land in a “state” like at amazon.com in a purchasing context to be able to “one-click” purchase the second first product 102. In one aspect, the user interface can be configured to enable the second buyer 122 to alter the product they buy. They may want to pick different color, or to pick a different size (shoes) or to continue shopping in a similar vein. The benefit provided to the first buyer 101 can be maintained or adjusted depending on what the ultimate second product 128 is. The manner in which the second buyer 122 lands in a checkout page with different types of options may be configurable based on the product and other offerings. A merchant maybe able to establish from a set of templates or configurable user interfaces to enable the second buyer 122 to just buy the same product again. Or, if it is clothing or shoes where the second buyer 122 needs to make color, or size, or shape or other types of decisions, then those options can be presented in the landing user interface for the second buyer 122. The second buyer 122 may also be presented with accessory options or alternate options like users do when they are close to a purchase on Amazon.com for example.

In some aspects, the second buyer 122 can also get a benefit for purchasing the product from an interaction with the object 106. The second buyer 122 may get a discount while the first buyer 101 gets a free accessory, for example. The purchasing service 117 may cause another item to automatically be shipped to the first buyer 101 upon the second buyer 122 purchasing the second product 128.

In some aspects, the second buyer 122 is transitioned to a merchant website served by the merchant server 126 in a state in which the second buyer 122 can easily purchase the second product 128. The second product 128 is usually going to be the same as the first product 102. However, the second buyer 122 may want to browse and buy something similar but not the exact same color, size, shape or have some other characteristic. The user interface can be configured to present options in this regard related to the characteristic of the second product 128 relative to the first product 102. In some respects, the purchasing service 117 may reduce the benefit for the first buyer 101 as the second product 128 becomes more different than the first product 102.

In some aspects, if the first product 102 is a lamp, and the second product 128 that the second buyer 122 purchases is a computer, then the benefit to the first buyer 101 might be reduced by a certain amount because of the substantial differences in the two products.

Another option at POS 108 is instead of a graphical object that requires a camera application to scan, an NFC chip could be incorporated into the product 102 that only requires the second first buyer device 114 to be brought into proximity. Specifically, products like clothes or fabrics that have a graphical object imprinted thereon would diminish the value or would be hard to place and access from a second buyer 122. Upon scanning the NFC chip as the object 106, the purchase information, product designation would be pulled up in an App Clip delivered from the merchant server 126 or website or “one-click” purchase state, where the buyer wouldn't need to open or download a separate application or open a browser. An App Clip is a feature offered by Apple® in which a portion of an application is provided to user device for the purpose of achieving a task such as completing a purchase. The user does not have to download the whole application but just the user interface necessary to perform the basic task. Users can then download the full application but the App Clip is just a portion of the application needed to finalize the task. The data that could be displayed is the product information and options to tailor it specifically to second buyer 122 such as size, color, etc. Also, the benefits that would be provided to the first buyer 101 or the second buyer 122 and the order of purchase 102 such as NFT identifier/receipt can be maintained.

In one aspect, the benefit might be implemented at the merchant discretion, or it may be made conditional on some other factors. For example, a discount may be provided but for products purchased that are over $100 in value. There might be a timing requirement such as a purchase being made during a time window or on a holiday or before the holidays. The benefit in some aspects may not be for the merchant that sold the first product 102 but might be at a different merchant or for a service from a service provider. In this manner, merchants can coordinate campaigns which can be mutually beneficial such as where merchants might be adjacent to each other in a mall.

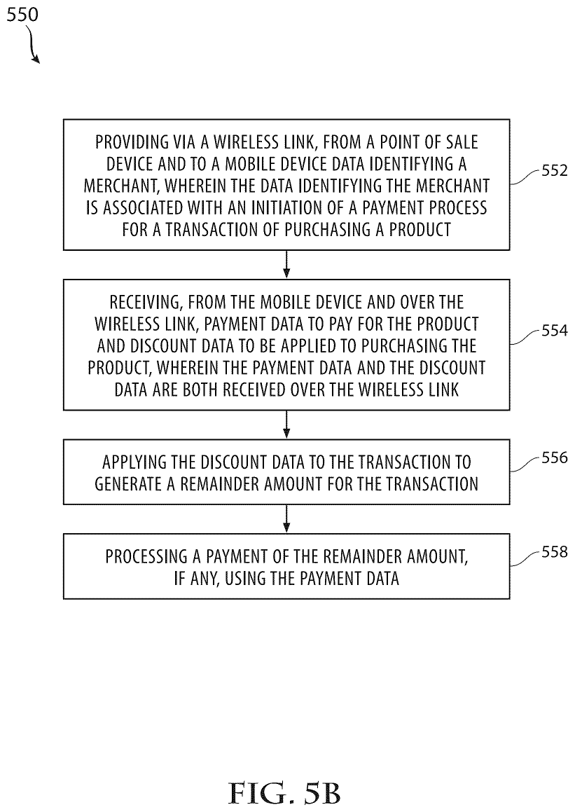

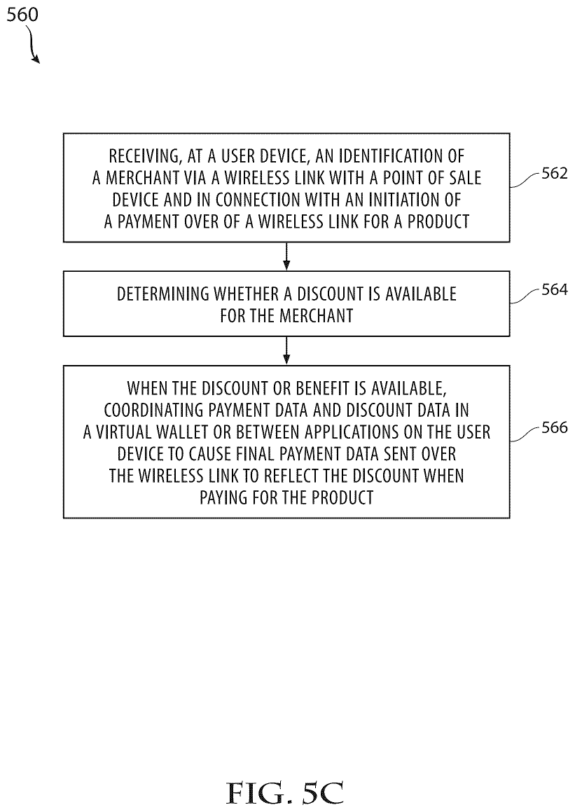

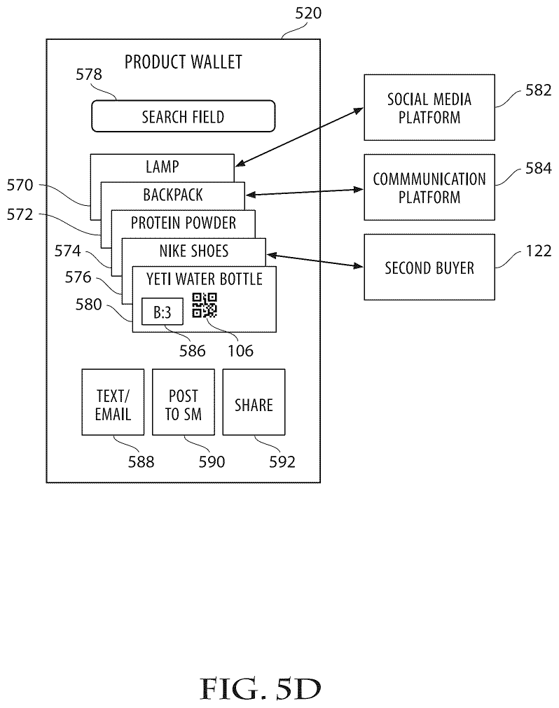

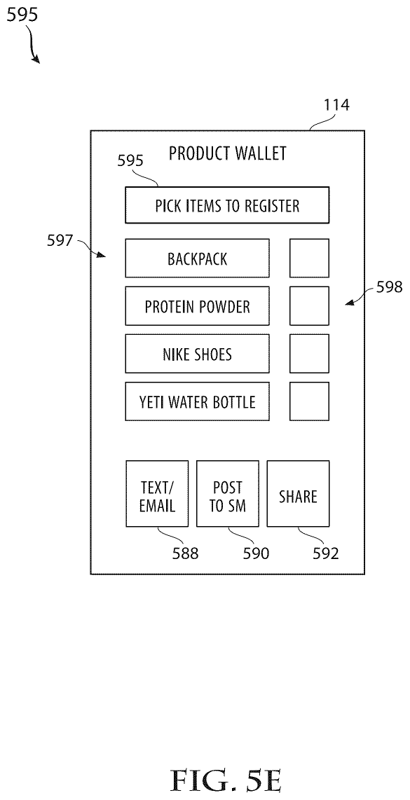

In one aspect, resellers like Amazon.com might provide a code as well independent of the merchant. For example, if a person buys a Samsung TV on Amazon.com, they may receive the physical TV with an object 106 configured on the side or available for display on the TV for scanning by a second buyer 122. Amazon.com might also provide an object 106 as well that could be stored in a virtual wallet (e.g., virtual wallet 502 in FIG. 5) which could grant a separate benefit for using Amazon.com again, such as free shipping or a discount on a next purchase over a certain threshold amount of money. In some aspect, the purchasing service 117 could generate a combined object 106 which, when scanned by the second buyer device 120, causes a first benefit for later purchases or activities associated with a reseller like Amazon.com as well as a benefit from buying another product from the merchant such as Samsung even if it is from a different merchant or distribution facility from Amazon.com. Storing payment accounts and product information for the first buyer 101 and the second buyer 122 and having the ability to track purchases on a merchant level as well as on a product level enables such combined benefits.

In one aspect, when the second buyer 122 scans or interacts with an object 106 via the second buyer device 120, the second buyer 122 may be given an option to purchase a second product 128 immediately or the second buyer 122 may want to store the object 106 or data associated with the object 106 (i.e., data about first buyer 101 and the first product 102) for later reference. For example, the second buyer 122 may store the data in a wallet or application such that later, when the second buyer 122 decides to buy the product, the stored data can be referenced to confirm that the second product 128 was purchased and thus the benefit can accrue to the first buyer 101. The second buyer 122 can be a FOFM.

In one aspect, the benefit to the first buyer 101 can be flexibly applied. For example, when the second buyer device 120 scans the object 106 and is brought to a checkout page on the merchant server 126 who sold the first product 102, the purchasing service 117 will receive the initial indication that the object 106 has been scanned. The purchasing service 117 can immediately send a notice such as a text to the first buyer device 114 that a benefit is on the way to the first buyer 101 because the second buyer 122 is about to buy the second product 128. The first buyer 101 can choose to store the benefit in a virtual wallet or in an application or may choose to give the benefit (say it is a 3% discount on a purchase) to the second buyer 122 for that very transaction to purchase the second product 128. The process here may be applicable because the first buyer 101 may have no intention of buying another purse or may have moved away or is not interested in another lamp from the store. Thus, one aspect of this disclosure relates to the fungibility of the benefits provided to the first buyer 101 both dynamically at the time of the purchasing the second product 128 (before or even after the purchase), as well as later on a secondary market or through giving the benefit to a friend via email, text, social media sharing and so forth. The benefits can even be sold on secondary market as described in more detail below.

Each communication between the purchasing service 117 and other components such as a point-of-sale 108 or a merchant server 126 can be achieved through an application programming interface (API). User browsers (Chrome, Safari, Edge, etc.) can be programmed with API capability and calls. Similarly, the purchasing service 117 and the merchant server 126 as well as one or more of the points of sale 108 devices can be programmed to make or receive API calls to achieve the processes disclosed herein. For example, the point-of-sale 108 devices can combine data about the object 106 connected with the first product 102 and can receive data about the first buyer 101 (such as through Apple Pay) and generate an API call to transmit the data to the purchasing service 117 to store the association in the database 118. Where payment processes like Apple Pay, Samsung Pay and Google Pay utilize APIs for application or web-based payments, those APIs can also be modified to include the data about the first product 102. For example, when the user makes a payment using a payment token for Apple Pay, the payment token and/or the API data transmitted can add data about the object 106 and/or the product. Thus, Apple or Google or Samsung could be positioned to manage the purchasing service 117 at their networks. The use of APIs can simplify the services offered by the purchasing service 117 such that it is easy for companies to implement the concepts disclosed herein for their products. The purchasing service 117 can coordinate (via various APIs) between merchants, payment services, companies like Apple and Google that provide their payment services, and so forth, to enable the concepts disclosed herein.

In another aspect, the first buyer 101 can choose to buy the first product 102 having the object 106 configured thereon or to receive the object 106 electronically. For example, the first buyer 101 may be given the option online to pay an extra $1 to buy the coat with the NFC chip as the object 106 configured on a sleeve. The first product 102 costs more to make with the object 106 but the first buyer 101 may be confident and that they would like to share the first product 102 and have friends or family buy a second product 128 and thus give them a greater benefit than the small extra cost of the first product 102. For example, the first buyer 101 might, while in an online checkout page, have an option to click a box or interact with an online button to have the product sent with the object 106 and to associate the person with the object 106.

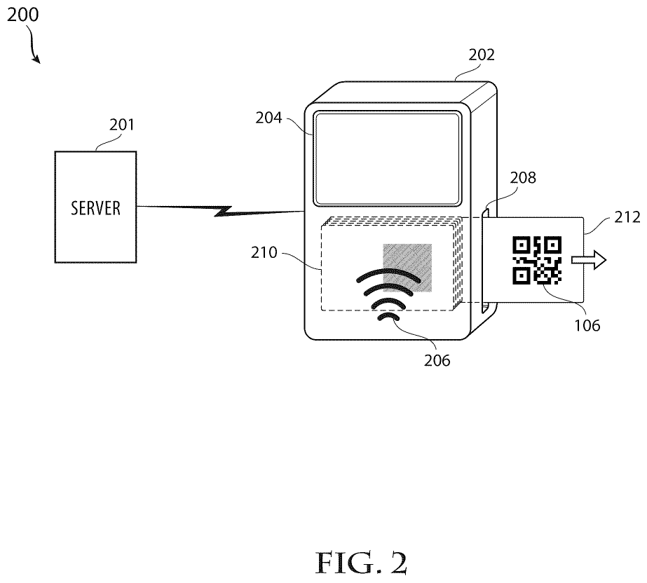

FIG. 2 illustrates a point-of-sale device infrastructure 200 that includes a server 201 and a dispensing point-of-sale device 202. The dispensing point-of-sale device 202 is different from other point-of-sale devices in the following ways. The dispensing point-of-sale device 202 can include a display 204, a near field communication component 206 that enables a second buyer device 120 to pay with Apple Pay or Google Pay or other payment mechanism, and a storage compartment for storing a set of stickers 210. The set of stickers 210 can be configured in connection with a printer (not shown) that can print the object 106 on a printed sticker 212 when appropriate. In some aspects, it might be expensive or not feasible to produce products with respective unique object 106. In such a scenario, the server 201 may determine that an object 106 should be associated with the first product 102 being purchased. A scan of the UPC symbol 104 on the first product 102 may identify that there is no object 106 on the first product 102. In this case, the dispensing point-of-sale device 202 or other interactive device may ask the first buyer 101 if they desire to register or have the first product 102 be active in a program where a second buyer 122 can buy the product and they can receive benefits. There may be options presented to the first buyer 101 about what kind of features associated with a registration they may want.

In some aspects, the first buyer 101 may choose to have one or more stickers printed by the dispensing point-of-sale device 202. The printed sticker 212 can have the object 106 that is recorded in the database 118 as connecting the first product 102 and the first buyer 101. The flexibility of this approach is that the first buyer 101 can then simply stick the printed sticker 212 on the first product 102 as they desire.

The system can also provide the object 106 to a virtual storage location for the user on the first buyer device 114. In this manner, the actual first product 102 does not need to have an object 106 printed on the first product 102 or a box associated with the first product 102 but the first buyer 101 can pull up via a virtual wallet or other storage application the object 106 that can be used by the second buyer 122 to scan via a second buyer device 120 to make a similar purchase.

In another aspect, where the first buyer 101 has the object 106 stored virtually or accessible via an application, they could also print out stickers at a home printer (not shown) if needed. For example, if a sticker on a product gets damaged and is no longer readable, the user could print another sticker at home and attach it to the product for easy scanning later. Or the user could pull up the object 106 on their mobile device to have their friend scan to purchase the product.

The first buyer 101 may also have the option to pause or discontinue their specific object 106 via the application (i.e., a user interface to the purchasing service 117) and reinstate their object 106 when they want the second buyer 122 to scan, thus saving the reward benefit system for a desired friend. Otherwise, object 106 will always be available for scan. The approach here might be applicable where the benefit is limited. For example, the first buyer 101 might be able to receive two or three “benefits” such as discounts for having friends purchase a second product 128. But beyond that, there might be no more discounts or benefits available. The first buyer 101 can control when the benefits apply and when they don't. The option for the first buyer 101 might be applicable where their friend might want to buy three sets of shoes or three of the lamps which might enable the benefit to be greater for the first buyer 101 than if a friend bought one pair of shoes or one lamp.

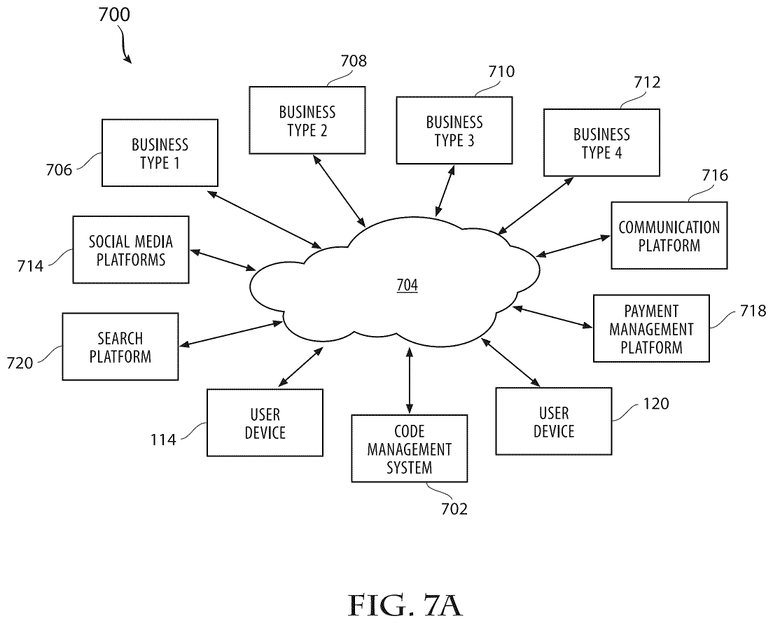

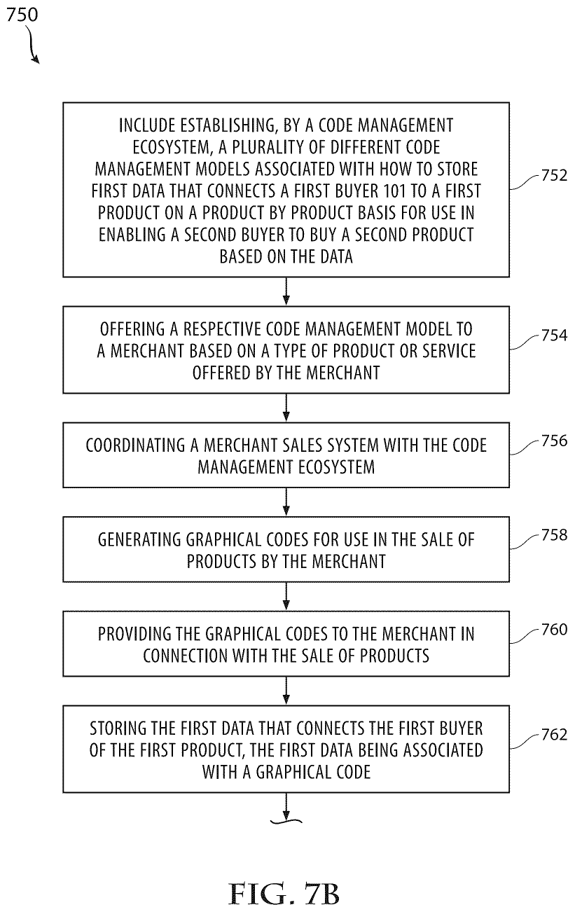

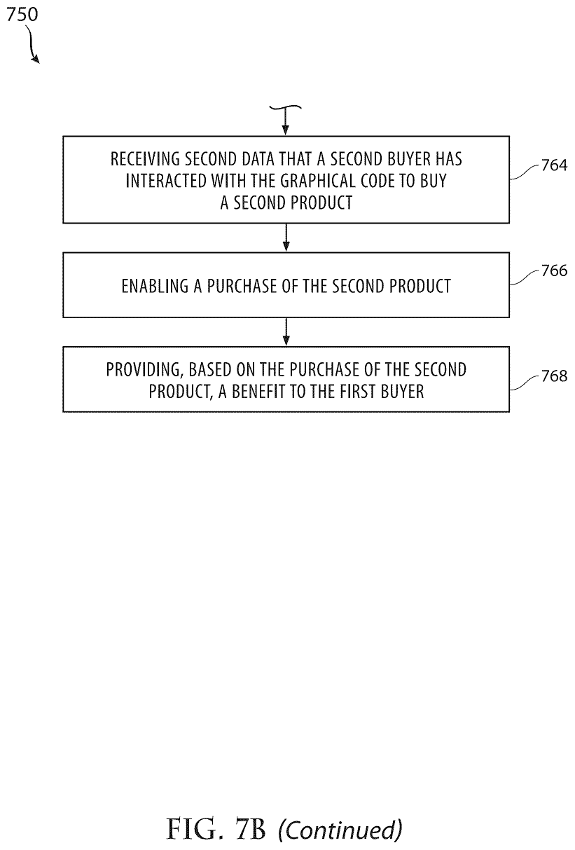

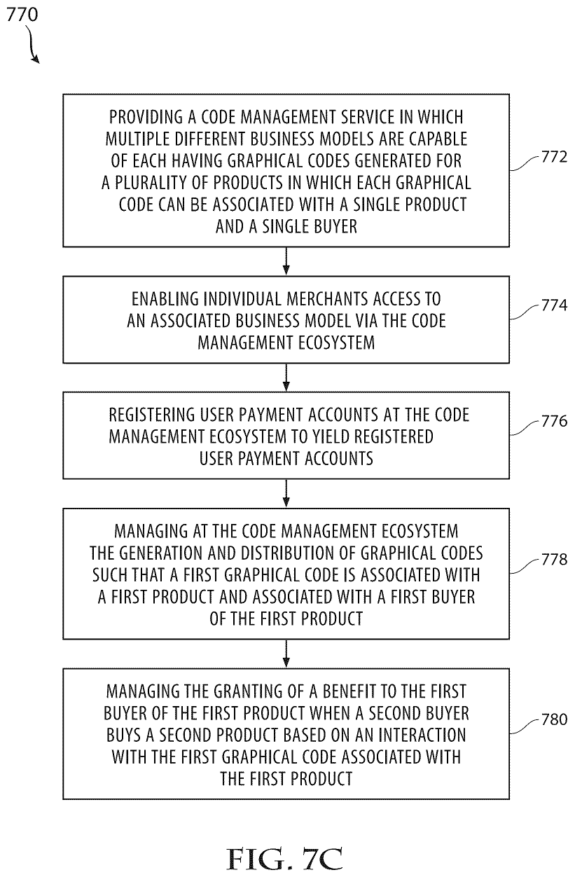

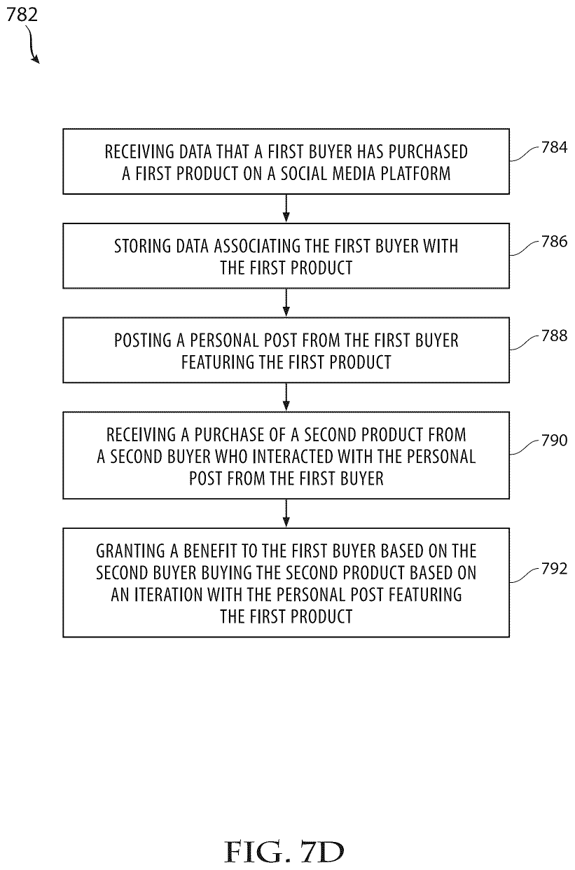

The dispensing point-of-sale device 202 can include any computer components shown in the computing device 700 disclosed in FIG. 7. The dispensing point-of-sale device 202 can include a storage compartment for a set of stickers 210, a dispensing mechanism for dispensing stickers from the set of stickers, a printer, a processor and a computer-readable memory storing instructions which, when executed by the processor, cause the processor to perform operations including one or more of receiving information about graphical object to be printed, the graphical object comprising data about a product being purchased, a buyer of the product, and data to enable automatic access to a purchasing service; printing, via the printer, the graphical object on a sticker from the set of stickers to generate a printed sticker; and dispensing, via the dispensing mechanism, the printed sticker and/or sending the object 106 in a digital form to a wallet or other storage device associated with the first buyer 101. Note that a server 201 may perform some of the above operations and just send a graphical object to the dispensing point-of-sale device 202 for printing. The dispensing point-of-sale device 202 is shown as being an integrated device with set of stickers 210, storage, printing and dispensing infrastructure combined with the near field communication component 206. In another example, a separate sticker dispensing device could be available at a point-of-sale 108 which can be instructed by a server 201 to generate a printed sticker 212 that includes the object 106. The user can then stick the printed sticker 212 on the product for later scanning.

The first buyer 101 may opt into the opportunity to register their first buyer payment account 121 with the purchasing service 117 to obtain benefits from later sales or may pay for the right to receive further benefits. At the time the relationship is established between the first product 102 and the first buyer 101, there can be a user profile established which sets forth the governing policies for that relationship going forward such as defining benefits for a first-generation purchase, a second-generation purchase (from the influence of the second buyer 122) and so forth. The first buyer 101 may be able to adjust user profile settings associated with managing their benefits as later purchases are made of products that they influence. They might be able to upsell or purchase a higher value benefit or adjust timelines or other parameters. For example, the user profile may manage benefits of purchases within 6 months of the original purchase of the first product 102 and different benefits for purchases after 6 months. Users may be additional or enhanced benefits for purchases prior to holidays such as Christmas.

In one aspect, the object 106 printed as shown in FIG. 2 might be on a receipt that the first buyer 101 can then scan with their phone which will trigger a confirmation to “add object to wallet”. The object in this case might be a first object that enables the first buyer 101 to easily add a second object to a wallet to confirm the purchase and connect the first buyer with the purchase. In this regard, the object 106 may not necessarily be stuck physically to the product, but the first object 106 (or another graphical object for this particular purpose), when scanned by the first buyer 101 phone, can initiate the storage of the second object 106 which is later to be scanned by the second buyer device 120 or which can be sent to the second buyer device 120 by text, email or other communication.

In one aspect, a person (an influencer) does not even have to buy the first product 102. The user may go to an application or website and download an object 106 to store in a user wallet or application. The benefit available to an influencer who has not purchased the first product 102 may be adjusted relative to a first buyer 101 of the first product 102. But the influencer may still desire to promote a product that they like. This disclosure includes the concept of a person receiving an object 106 and being associated with a product even without buying the product.

In another aspect, a point-of-sale could just have a stack of individual, unique objects 106 on stickers. Rather than printing each one using the dispensing point-of-sale device 202, the clerk or the person could just take one sticker from the stack and stick it on their product or on the box whatever is applicable. Then the user can scan that object 106 and the first time you scan the object 106 can enable the user to be connected to the product. Data from the receipt of the purchase or data from scanning a UPC symbol 104 on the product by the first user device 114 can be used, or manual entry of information about the product, can be provided. The user may scan a receipt for example. Then the first buyer 101 has their data registered in the purchasing service 117 ready for use and there is an object 106 printed on a sticker that is attached to the product. After registering the first user, the second buyer 122 when they scan the object 106 is processed differently because the system records that the first scan was by the first buyer 101. The second buyer 122 can then buy their own second product 128 and the benefit can be granted to the first buyer 101 as described herein. As can be appreciated, there are many ways to connect the first buyer 101 to the first product 102 and the object 106.

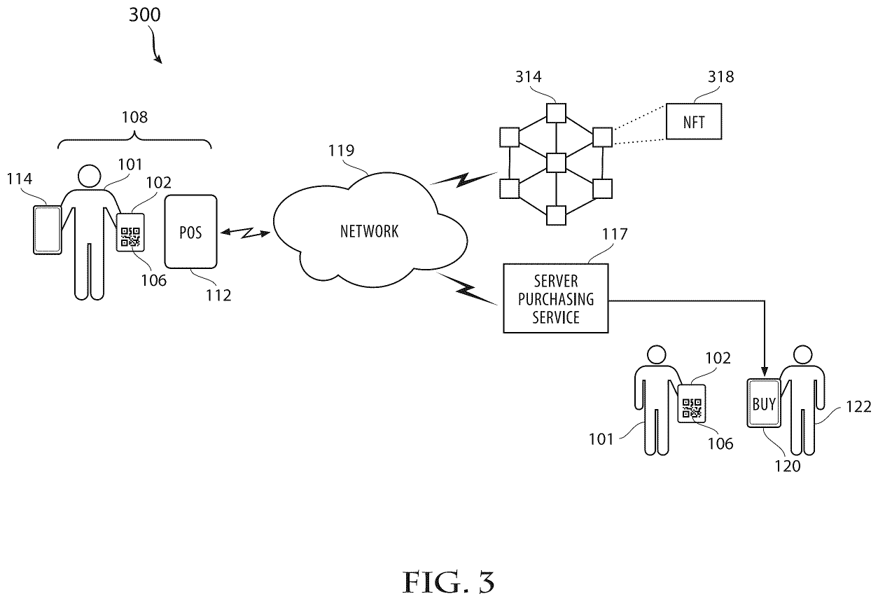

FIG. 3 illustrates an example blockchain-based system 300 in which the first buyer 101 uses their first buyer device 114 to buy the first product 102 which has an object 106 either printed on it or associated with it at the time of purchase or in another manner. The system transmits through the Internet 119 data associated with the purchase. The purchasing service 117 can receive and store the data and cause information about the transaction to be recorded on a blockchain network 314. For example, a non-fungible token or NFT 318 can be created or recorded in a block of a blockchain network 314 that can confirm immutably that the first buyer 101 purchased the first product 102. The information about the purchase and the creation of the NFT 318 can enable a number of benefits or features with the overall process.

With this approach, where products have their own unique number or code assigned to them, one can take advantage of this in ways not previously possible. For example, there is huge value in owning the first Model-T Ford that rolled off the assembly line. It's a famous vehicle. With the principles disclosed herein, one can announce a new baby stroller or new backpack and since each product is numbered, one can provide benefits for those who buy the first one or the first ten. Sales can be divided up from in-store sales to online sales. For example, the merchant can announce that products 1-100 are in stores tomorrow and products 101-1000 will be available online the following Monday. Benefits and tailored experiences can be provided for specifically numbered products. The buyers of the first ten in store and the first forty online can get an extra discount or benefit or be able to customize the experience of their friends that buy the products based on scanning the unique object on their products. The first buyer 101 can have a picture taken of them with the product and a non-fungible token (blockchain recorded record of the image) made in connection with that picture. That NFT can then be owned by that user. The would-be great value of an NFT for the image of the first Model-T owner buying that car. The disclosed approach enables confirmation of purchasing transactions for such new products. For example, this could occur for the first Tesla for sale or the first Tesla truck.

In one aspect, a package of services and experiences can follow any transaction from the first buyer 101, to the second buyer 122, and so on. For example, the first buyer 101 can take a picture with their phone as part of Apple Pay at the point-of-sale or even virtually if they want and can submit through an app or other means the photo for creating an NFT of that moment. A second buyer 122 might want to confirm that they purchased their product from the first buyer 101 or a famous person like Tom Cruise and get a picture taken that can be from the same device that they scanned the graphical object from, and that picture can be made into an NFT which confirms their experience and their identity as the second buyer 122. Note that there is the famous episode on Seinfeld where George Costanza thinks he bought the actor Jon Voight's car. It turns out that he bought a dentist's car. The dentist also was named John Voight. The disclosed approach can enable confirmation of the chain of ownership from owner to owner which can enhance the value and intrigue around any product.

These NFTs can be held by the buyer(s) or sold in a marketplace. Furthermore, the blockchain technology involves each block in the blockchain being connected to a previous block through a hash, time stamp and transaction data. The blocks are connected. In a similar way, each transaction from the first buyer of a product to subsequent generations of buyers, can be recorded on a blockchain such that there is an immutable and confirmed record of the connection of members of the “family tree” of buyers from the original buyer or first buyer 101.

Tracking the family tree of purchases back to an original purchase can enhance the experience of buying any specific product. For example, if one knows that their friend purchased a pair of shoes from a scan of the object 106 associated with the shoes of Tom Cruise (who was the first buyer 101), then they might more likely want to purchase those shoes not just in general but from their friend (which is the second buyer 122) because of the direct connection to someone famous. The approach to purchasing products disclosed herein creates a social media-type of connection to the purchasing experience and the specific product that previous does not exist in the marketplace.

Social influencers can use the object 106 or code on their Facebook page or postings or on any social media posting or messaging. Once the first buyer 101 purchases the first product 102, there can be a transaction record or NFT 318 generated that is “registered” on the blockchain network 314. Then, the first buyer 101 can receive a set of services associated with that purchase. Social media networks, companies like Shopify and BigCommerce, can have accounts to help monetize further interactions based on the first purchase of the first product 102. For example, the first buyer 101 can register with a chosen service (i.e., the purchasing service 117) and then use the object 106 or code in online in posts, on stickers, or anywhere to obtain benefits when people scan and buy the second product 128 for themselves. Different benefit structures can be provided to the first buyer 101 or subsequent buyers based on a differentiation between activities like a bigger benefit for in-person physical sales or online posting from social media sales.

A blockchain network 314 typically includes: (1) a physically distributed group of compute nodes; (2) a respective instance of a consensus algorithm that is loaded on to each compute node of the group of compute nodes such that, when a consensus is gained from the instances of the consensus algorithm for a transaction, the transaction is recorded on a distributed ledger, and (3) a respective instances of the distributed ledger is loaded on each of the distributed compute nodes such that the transaction is immutably recorded on the distributed ledger.

The purpose of the blockchain network 314 is to record a transaction in an immutable way that cannot be changed absent an action by the distributed consensus algorithm. Thus, data associated with a transaction, transitions from one state (being in one memory location and capable of being deleted or changeable in general) to being in an “immutable” state (being stored in a blockchain structure across multiple nodes on a distributed ledger of a blockchain network) in which it can only be changed (or spent or transferred or burned) based on another result of the consensus algorithm.

Achieving an immutable state for data is the goal of the blockchain network 314. The blockchain network 314 solves the double-spend problem, which is a problem of being able to spend the same money (or cryptocurrency) twice. A block in the blockchain network 314 is linked to a previous block using cryptography in that each block contains a cryptographic hash of the previous block, a timestamp, and the transaction data. This linking of blocks (thus the name blockchain) protects the data from being changed in ways that are not applicable when data is simply stored in memory on a generic computer. The structure of the transactions recorded in blocks on a blockchain network 314, and how the blocks are linked together in a chain, prevents a second transaction or a double-spend of the cryptocurrency. Thus, the data associated with the transaction and that is recorded on the distributed ledger is literally “a transformation or reduction of a particular article [the transaction data in a first state of being changeable] to a different state [i.e., a second or different state of becoming stored in a blockchain structure on the distributed ledger in an immutable way or in an immutable state] or thing.”

In another aspect, at the point-of-sale, the UPC symbol 104 may be modified to include an indicator that for this particular product, an object 106 should be generated. In this regard, At the point-of-sale 108, an identification of the product through the UPC symbol 104 is received, if a trigger or marker on the UPC symbol 104 (or through a user input or an employee input at the point-of-sale 108) is received, the marker can cause a series of steps to occur. Data identifying the first product once purchased by the first buyer 101 can be transmitted to the purchasing service 117 along with an identification of the first buyer 101. At a first such purchase, the first buyer 101 can be asked if they would like to register their first buyer payment account 121 with the service to receive the object 106, download an application (such as application 508 shown in FIG. 5), establish a virtual wallet (such as virtual 502 in FIG. 5), and be registered to be able to enable friends such as the second buyer 122 to purchase the second product 128. The first time the user buys such a product that is in the system, the clerk at the store, may ask if they would join the service or become registered, and if so, then the information may be sent to the purchasing service 117 for processing. Then, a notification is sent to the user to either download the application, or a text might be received with the object 106 that they can add for example to their Apple Wallet or that is used to create a product wallet (see product wallet 520 in FIG. 5A). Once registered, later products that quality with a market can automatically have object 106 generated tying the user to the product. A picture of the product could be provided with the object 106 such that the user's product wallet can be searched for a picture of the desired product that a friend might want to scan and buy the second product 128.

Further, the transaction in this case has occurred that identifies the first product 102 and the first buyer 101 and thus, if the user registers their payment account or is registered and thus an object 106 is created, the object 106 can be recorded on the blockchain network 314 to confirm that the user bought that product.

As noted elsewhere as well, the user can also transmit via email, text, social media, or other means the object 106 such that a friend can click on the object 106 received on their mobile device or computer and be brought to the vendor website or to a checkout page featuring the first product 102 and configured to enable the second buyer 122 to purchase the second product 128 while granting the benefit to the first buyer 101. In this regard, the second buyer 122 is not scanning a graphical object like a QR code but is rather interacting with an object they received from the first buyer 101 that is coded to initiate the transition to the merchant website or application for purchasing the product.

In another aspect, the UPC symbol 104 can include a bit or other data indicating to a point-of-sale device 112 that the product has an object 106 associated with it. The clerk or self-checkout in this case could instruct the person to scan the object 106 via an NFC point-of-sale device or visually scan the object 106 via a visual scanning point-of-sale device. The devices can be placed in a “state” of scanning the object 106 (instead of scanning for payment data or a discount QR code). After the point-of-sale 108 obtains the data from the object 106, the point-of-sale 108 can return to its normal state or another state when ready to receive payment data or a discount from a QR code.

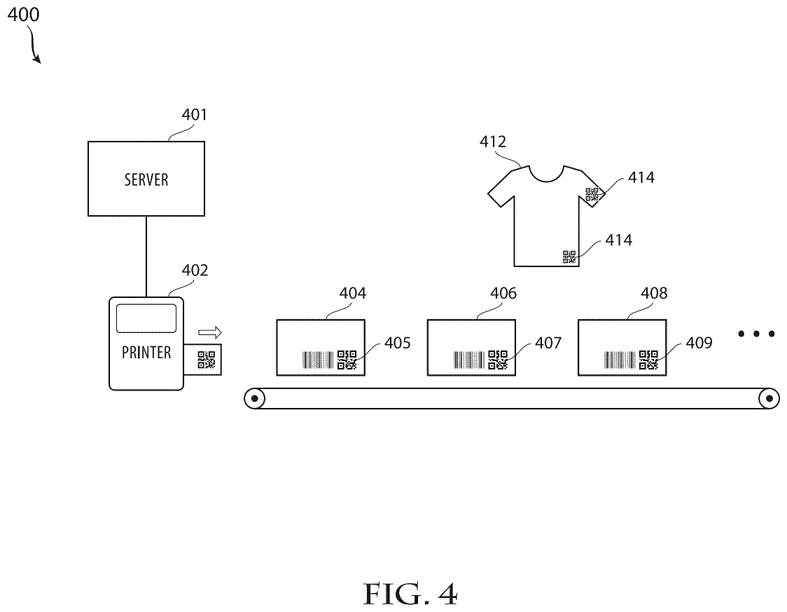

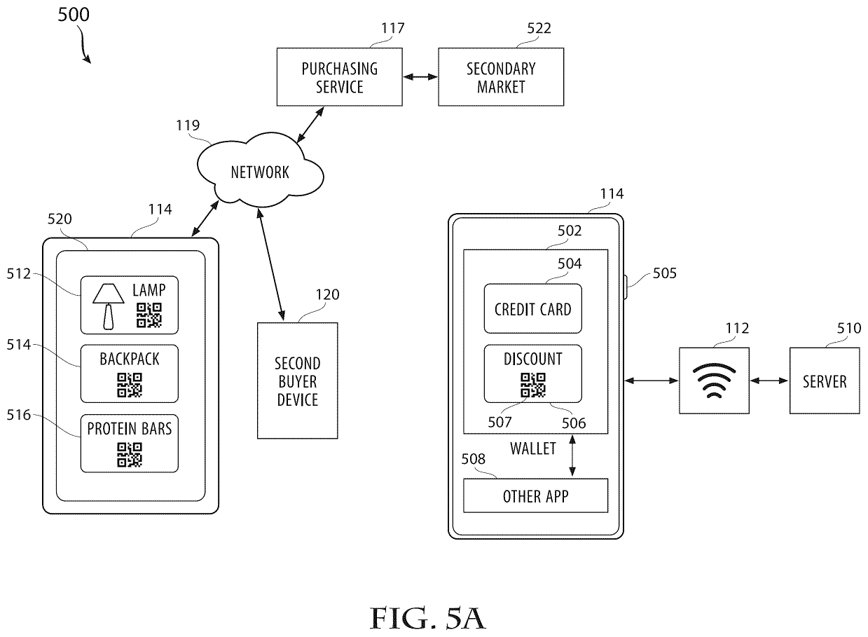

FIG. 4 illustrates a manufacturing facility 400 in which a printer 402 is connected to a server 401 such that the printer 402 causes a unique graphical object to the printed on each product. For example, each respective product of a group of products 404, 406, 408 has a respective graphical object 405, 407, 409. FIG. 4 illustrates how the individual graphical objects 405, 407, 409 can be printed at the time of manufacturing. The graphical objects 405, 407, 409 can be put on boxes (such as a monopoly box or box of playing cards), on labels such as for clothing or shoes, on a door such as in a vehicle, on an underside of a product such as a drone or remote-control truck, or on any location that is convenient to print or etch the graphical object.

At making the product 404, 406, 408, the server 401 can generate unique codes for each product. The generation can be random or can be based on a geographic region so that regional information is also provided. Also, the code can include the country produced in, date produced, the facility it was printed in, details for the item it is intended for, or any sort of relevant non-reprogrammable information. In this example, if a manufacturing facility is structured such that a group of products 404, 406, 408 is known when it is made that it will be delivered to Florida, then the respective graphical object 405, 407, 409 can include regional information. In this manner, if a later second buyer 122 after the first buyer 101 purchases the first product 102 buys another product, the object 106 on the first product 102 can identify location information associated with the first product 102. That information can also be compared to location information gained from the second buyer device 120. If the location of the second buyer device 120 is in Texas, then important business data can be gathered indicating that the first product 102 was sold in Florida (say the lamp), and then was moved to Texas where the object 106 on the lamp was scanned by the second buyer device 120.

An article of clothing 412 like a shirt is shown as being manufactured in which an example clothing object 414 is inserted or printed on the article of clothing 412 on a sleeve or at a bottom portion of the clothing. Various locations upon the article of clothing 412 where the clothing object 414 can be provided are on a tag, on the collar, on a sleeve, on a pocket and so forth. Different articles of clothing 412 may cause different locations because another person must scan or move their second buyer device 120 to the clothing object 414 to make the purchase. Thus, for modesty, the positions on the article of clothing 412 may be carefully chosen. A belt for example may have the clothing object 414 configured on a side portion when the belt is worn. Similar to pants. The location may be on a side portion or knee or other location that would be easy and proper to scan.

The clothing object 414 can be a NFC tag configured in a compartment of the clothing. The compartment can be identified by a logo or visual object that identifies where one would bring their second buyer device 120 to make a purchase. When the article of clothing 412 is scanned at a point-of-sale or online, the UPC symbol or other identification of the product can identify that this clothing has a clothing object 414. A point-of-sale 108 device can be placed in a mode of having the clothing object 414 brought near it for scanning a visual code or for scanning an NFC tag which can then identify uniquely the article of clothing 412 and enable the connection to be made with the user as the user becomes identified by using Apple Pay, Google Pay, or by manual identification. The connection between the article of clothing 412 and the first buyer 101 is thus stored in the database 118 of the purchasing service 117.

When the user buys the article of clothing 412 online, the processing at a warehouse or other location can include a worker or a robot who grabs the article of clothing 412 and scans the clothing object 414 to identify the article of clothing 412. The buyer is already identified as they are buying online. The buyer may also buy the item and have it shipped to their home prior to the connection being made. The buyer may then activate the connection at home by scanning the clothing object 414, the purchasing service 117 can be placed in a state for that purchase of waiting for the initial scan to make the connection. There can be an open item in the purchase history that can give notice to the user that they have not yet registered the product. Once the user connects the product to the buyer, then the purchase history can be updated to reflect that they have established the connection and that the open task is closed. Thus, second buyers 122 can scan the object 106 or clothing object 414 to make the purchase of the second product 128. Thus, part of this disclosure involves the tracking of connection tasks for products in which the connection between the first buyer 101 and the first product 102 are made at home after the product is delivered or purchased. A purchase history like on Amazon.com or in a user app can be the place where a graphical user interface can report and enable the user to track their connection tasks. Once the first buyer 101 scans the object 106 or clothing object 414 to make the connection, the purchasing service 117 can switch to another state where later scans of the object 106 or clothing object 414 are expected to be a second buyer 122.

For example, a user may buy a product which has a scannable object and at the point-of-sale no connection was made or record made of their purchase. For example, perhaps they purchased the object in cash and have a receipt. The user could go home and utilize an application on their mobile device or some other application and identify the product (including scanning a receipt perhaps) and identify themselves as the purchaser and submit the data to a database for enabling them to receive a benefit if a friend or other person buys their own product via interactions with the user. Various approaches to fraud protection can be used such as pinging the user's payment account or confirming a photo of a receipt to insure that the person actually bought the product.

In the example of data such as facility, date, and national location, such information can be used to identify and confirm authenticity of the product made for sale. For instance, some products may have different models made at different times and places. The use of the object 106 in this case will ensure the product has the proper qualities stated (i.e., manufacturing components, materials, hand-made, etc.), and that it is a genuine product. Such a data log will prevent fraud and allow for purchasers to have confirmation as to the authenticity of their product. Such data can be recorded as well on the blockchain network 314 as shown in FIG. 3.

The purchasing service 117 can receive all such information and track the location of products and purchasers of products using this location-based data. Advertisements, manufacturing and distribution schedules and strategies can be adjusted based on the business intelligence gathered as described herein. In this regard, the purchasing service 117 can receive business intelligence data such as locations, timing and individuals who make later purchases based on the first buyer 101 purchasing the first product 102. Such data can be aggregated and reported to merchants to enable them to adjust distributions of products or to pre-stock products in certain areas based on predictions (i.e., machine learning or artificial intelligent model predictions) of future sales of the product or related products and to aid in creating a consumer profile that allows the company to tailor suggested purchases, advertisements, and their marketing mix.

In another aspect, say the product is a car. The first buyer 101 loves their car and lets the second buyer 122 test drive it. The second buyer 122 desires the same car or a similar car. They can scan the object 106 and trigger a series of events beyond just a simple sale. Inventories can be checked, appointments can be made (with references to a dealer calendar and a calendar of the second buyer 122), loan documents can be initiated, and so forth based on the scan of the object 106. Thus, the second buyer 122 can scan the object 106 and know that 35 miles away is a dealer with a similar car with an appointment available tomorrow at 2 PM for a test drive. The user could be presented with a series of options of similar cars within 100 miles of them and then select one or two to go test drive and the appointments can be requested. Or, the second buyer 122 can just purchase the vehicles online as they have already test driven the first buyer's car and the purchase can be made, with a loan structure if needed. In all these scenarios, the series of events is triggered automatically depending on an application programming, data associated with the object 106, back-end network server capabilities, access to information associated with the second buyer 122 (i.e., have they enabled the purchasing service 117 access to their calendar), and so forth.

Note that this approach also enables referrals for different types of services beyond just a product sale. A builder or a dentist could provide an object 106 that enables their clients to have their FOFMs scan the object 106 and get scheduled for a cleaning or a meeting to discuss a project. The “product” here would be some kind of service that is available. The referring person (the first buyer 101) can then receive a benefit if the second buyer 122 purchases the services based on the referral.

In one aspect, each purchase of a user can also be processed in the following way. When the first buyer 101 buys a first product 102 that has a unique graphical code or object 106 associated with it, an alternative approach is to provide an application or website or other approach to providing the user with the graphical object 106. When the first buyer 101 buys a lamp using Apple Pay at the hardware store, the lamp can be “in the system” as a product that the first buyer 101 can get a unique graphical object 106 for. When the transaction occurs and there is an identification of the first product 102 and the first buyer 101, the first buyer 101 can receive in a wallet (i.e., the Apple Wallet or other app) the graphical object 106 and a description of the lamp as the first product 102. Then, 1 year later as a friend or a second buyer 122 desires to buy a similar lamp, the first buyer 101 just needs to pull up their wallet and find the lamp and the object 106 can be displayed on their device screen. The FOFM or second buyer 122 can just scan the object 106 from the first buyer's phone and purchase a lamp for themselves. This aspect eliminates the need to physically print an object 106 on the first product 102.

In yet another aspect, a graphical user interface can be presented when the second buyer 122 scans the object 106 either on the first product 102 or on the first buyer's phone. The interface can enable options to be presented. What if the second buyer 122 wants to buy that very product (i.e., the actual first product 102 or lamp), and not a new one for themselves. In that case, depending on the type of product, the scanning of the object 106 can trigger a purchase of the very item from the first buyer 101 by the second buyer 122. In some ways, this could easily automate the sale of products that need licensing or other transfer requirements like for a car purchase or other purchase where the application can help with paperwork to be signed or registrations to take place. In other words, the type of product can cause a different series of steps to be initiated which can include licensing or other transfer requirements if the second buyer 122 wants to buy the actual first product 102 from the first buyer 101. For example, a gun sale might require some kind of transfer documents which could be triggered based on the scan and easily (and legally) managed. The second buyer 122 and the first buyer 101 can handle the transaction using identity confirmations (fingerprint scans, facial scans, retinal scans, multimodal input, etc.) on their respective phones (i.e., similar to Apple Pay or other payment processes that confirm the identity of the user) and even signing title documents to make the transaction easier.

As identification cards are digitized and added to these wallets as well, further capabilities can be implemented to verify identity and authorize transactions. For example, the state of Maryland allows for a driver's license to be added to Apple Wallets which can then be used at TSA scanners and checkpoints. Such data or applications that relate to user identity can be accessed by the purchasing service 117 to confirm an identity of the first buyer 101 and/or the second buyer 122.

Note that the graphical object 405, 407, 409 may also be replaced with near field communication (NFC) chips where such devices will work with the particular product. For example, clothing or a backpack where an NFC chip can be built or placed into a tag or other location of the backpack for easy scanning is also possible.

FIG. 5A illustrates a variation on the concepts disclosed herein. The wallet and point-of-sale system 500 can be configured to improve the payment experience at a point-of-sale when a discount or benefit is provided. In many applications such as at restaurants, users gain points by making purchases. When they have enough points, then they can get a free meal or free pizza for example. To redeem the reward, often a QR code is generated in an application that is scanned at a point-of-sale. There is required in this case at the point-of-sale an optical scanner such as point-of-sale scanner 110 that scans the QR code and a separate point-of-sale device 112. This process requires two different interactions. The following simplifies the payment process into one interaction rather than two.

A driver's license or other form of identification in the wallet can be used to verify identity within higher level transactions such as a gun purchase or vehicle purchase. A user interface can prompt a verification via face id or fingerprint. This data can be stored or linked to a transaction.

What is needed is a coordination between a payment mechanism like a virtual wallet 502 on a first buyer device 114 either internal or externally to generate a package of data that can be transmitted via a near field communication component on a point-of-sale device 112. For example, a virtual wallet 502 can include a credit card 504 or other payment device. The virtual wallet 502 may also hold other items like a scannable discount 506 or airline tickets or other items. Typically, the virtual wallet 502 just holds these items and does not perform any intelligence or operations between such items. However, through the following approach, improvements can be made.

First, when the user is at a store or restaurant, such as Chipotle, the user may have a discount 506 stored in their virtual wallet 502. The discount 506 can, for example, be for a free burrito or free meal. There is a quick response code or QR code 507 that would be first scanned at the point-of-sale 108. In order to combine the processes, however, when the computer server 510 at the point-of-sale initiates the point-of-sale device 112, it can cause via the wireless link information to pass to the first buyer device 114 indicating that the payment to come is at a Chipotle restaurant. The virtual wallet 502 on the first buyer device 114 can receive that information and determine whether there is a discount 506 available for Chipotle. If the discount 506 is available the information passed to the point-of-sale device 112 can not only include a payment token or other payment information as occurs in the Apple Pay and other payment processes, but can also pass along the discount data such that the computer server 510 can identify that the discount should be applied to the purchase. The actual purchase amount processed can then be adjusted to zero or to some other amount based on the discount being passed through the near field communication to the point-of-sale device 112. This eliminates the need for a separate scan operation for the QR code 507.

The user interface presented to the user to accomplish the payment for the product can be altered to indicate or to receive confirmation to use the available discount 506 stored in the virtual wallet 502. Typically, the payment process involves the user moving the first buyer device 114 close to the point-of-sale device 112 which causes an instruction on the user interface to press a side button 505 twice and then provide a facial recognition (or some other biometric authentication or other kind of authentication) to confirm the identity of the user and to make the payment. However, if a discount 506 is identified in the virtual wallet 502 or from another application such as application 508 on the first buyer device 114, then the user interface may indicate that a free meal discount is being applied to this payment. For example, it may state “You will apply your free meal discount at Chipotle in this payment if you press twice”. The process may be adjusted to say, “If you don't want the free meal at Chipotle applied at this time, press the side button 505 three times [or once, or some other number].” In this general manner, the regular payment process can be adjusted to cause or receive an indication to use the normal process or to apply the discount. The user may need to touch a selectable object on a touch-sensitive display to confirm the application of the discount to the current payment process. There are a number of ways that the confirmation could be provided to apply the discount.

In order to implement this process, the application 508 may be enabled to communicate data with the virtual wallet 502. For example, the virtual wallet 502 may have a registration of various discounts earned from different applications. The user may be able to use the application 508 to earn points, scan receipts or use QR codes to obtain benefits, but then can coordinate the status of the benefits with the virtual wallet 502. In this regard, the virtual wallet 502 may know for example that the user has a free pizza at Mod Pizza, and a free meal at Chipotle and when the user makes purchases at either of those locations, the virtual wallet 502 can coordinate the application of the benefit or discount with the payment data from the credit card 504, cryptocurrency, or other payment instrument, and simplify the process of redeeming the discount into one transaction rather than two.

While the near field communication protocol is discussed above, any wireless link or wireless protocol could apply, such as BlueTooth, 5G or Wi-Fi. There is no limitation on the wireless link being near field unless that requirement is specifically claimed.

In yet another aspect, the disclosed approach applies to online sales. For online purchases, a group of products can be produced in which a unique graphical object 106 is configured on each respective product. Using advanced robotics, the location of each product on a shelf in a warehouse for example can be known in advance as they can be staged as product 1, product 2, product 3 and so forth. Each would have its respective unique object 106 configured thereon. Then, as Mary goes online and orders a watch, or lamp, or whatever the product is, a robot could retrieve product number 3 from the shelf, receive identifying information for Mary as the first buyer 101, and the product/buyer data 132 can be stored in the database 118. Then, later, as John (the second buyer 122) scans the unique object 106 with his mobile device or the second buyer 122, the purchasing service 117 can identify the product number 3, access the database to determine that Mary was the first buyer 101, cause a new product or a new lamp (the second product 128) to be delivered to John and charged to John, and provide to Mary the benefit.

Note that John also can have the same benefit provided to him in that when his product (the second prod) is pulled from the shelf, it will have its unique graphical object. Say the second product 128 has a number 213 with its unique object 106. A new product/buyer data 132 is stored at the database 118 with John being associated with product number 213. Then, when John's friend Joe sees John's lamp and wants one, Joe scans the object 106 on the base of John's lamp (or on some other location) and orders a lamp, then John gets a benefit. Note as well that the benefits can be multi-generational in that the system knows that Joe bought one from John and John bought one from Mary. So, Mary could get a little benefit when Joe buys from John as she started the chain of buyers. A “family tree” can be generated which ties together each transaction. The multigenerational transactional data can be stored and integrated into a social media platform or can represent important business intelligence data as well.

Further, when these transactions take place, graphical user interfaces can be provided to one or more of Mary's user device, John's user device and Joe's user device. Adjustments can be made at each stage. For example, when Mary buys the lamp, she can designate a bonus gift to any friend that buys from her. Perhaps it's a Giftya or perhaps it's a discount. Photos can be taken of Mary buying the lamp which data can be stored in the database and used for a social media posting. For example, Venmo requires a note about each transaction and provides a feed of these transactions to friends. There could be a social media feed made up around the history of a particular product. The product (specific product number) could have a social media account generated for it and each time another person buys a product from that initial product, a posting could be made on the feed. In this manner, a particular product could become famous through so many people wanting to make a purchase that is attached to an individual product. The purchasing could spread like virus (in a positive way) as people scramble to be part of the “family” of purchases generated from a famous product.

In one example, say Tom Cruise bought a pair of shoes which are sold and associated to him with a graphical object thereon. A friend Jane buys the shows based on his object 106. As each person buys the shoes based on a respective object 106, the history of the particular product can be provided or confirmed such that they know the “family history” of their respective purchase. People may want to purchase from Jane's shoes knowing that she purchased them from an object 106 associated with the shoes purchased by Tom Cruise. The process can be akin to the excitement of buying Jon Voight's car for George Costanza in Seinfeld. People can feel personally connected to the product. In one aspect, each transaction can be immutably stored on a blockchain network to confirm its authenticity.

In another aspect, the original buyer from the store can opt-in to a social media treatment for the product. For free or for a small fee, the user may select to begin one or more a social media accounts (Instagram, Facebook, Twitter, etc.) dedicated to the specific product. The first buyer 101 can take a picture of themselves with the first product 102. The first buyer 101 could choose handles which are confirmed to be available (“Jane Doe's Great Lamp”). Then, the database entry in the database 118 is generated for the user and the first product 102, the purchasing service 117 can automatically generate a new entity on the one or more social media platforms. Then, as later purchases are made from that original product, a family tree can be generated with later purchasers from that original lamp can be placed in their position in the family tree and the social media accounts can be updated. Later buyers can be asked to give comments as to why they purchased the product, have a picture or video taken, and have that data added to the social media account as a post or other data attached to the account. In other words, social media experiences can be focused around the family history of purchases that started with the first buyer 101 buying the first product 102.

The “product family tree” can be dynamic and changing and perhaps can cause the desire to purchase the product from a product in the family tree more desirable for users. A new kind of viral opportunity exists where people via social media may connect and want to buy the same product from a particular person in the tree or as high up in the tree as they can.

New user groups can become established as members of a group, for example for a Facebook page, can be those who purchased the product as part of the same family. The exclusive group can of course exchange comments and questions in the normal manner on social media.

In one aspect, with a family tree being shown, the social media platform may allow social media commerce abilities to occur where a person in the group or a new person (say Joan) could be allowed to access the family tree and choose a person (say Fred) in the family tree, and then buy the lamp “from” that person. The social media platform can sell the product and deliver it to the buyer and then give the benefit to the particular person selected in the family tree as though the buyer had purchased it from a scan of the graphical object 106 physically. In one example, this approach could occur where in the above example on Fred's feed on his social media account he comments that he bought a Lamp and that posting can be tied to the family tree or the system that manages the processed disclosed herein. A friend Joan may see Fred's posting and desire to purchase the lamp. The posting can be configured such that Joan can buy the lamp from Fred's posting, Fred gets the benefit as outlined here, and Joan gets added to the family tree and gets to join the group for that Lamp.

For privacy reasons, in some cases, buyer data can be anonymized if at the time of purchase the buyer decides not to have their information shared on the social media platform or as part of the tree. A placeholder can be provided to show a purchase, but no identifying information can be included.

In some aspects, also shown in FIG. 5A is the first buyer device 114. The first buyer 101 can receive a product wallet 520 that stores objects 106 associated with purchases. For example, the first product 102 can be a lamp 512, or a backpack 514 or protein bars 516. Each of these products is confirmed to be purchased by the first buyer 101 (including on the blockchain network 314) and can be stored in the product wallet 520. As noted above, data associated with a purchase such as one of the entries in the product wallet 520 can be transmitted to the second buyer 122 on the second buyer device 120. Then, the second buyer 122 can access the purchasing service 117 via the received object 106 (again, by clicking on it rather than by scanning as the second buyer device 120 already has received the object 106.

In other aspects, the discount 506 or benefit provided to the first buyer 101 can store data associated with the second buyer 122. This data can make the experience of redeeming the discount 506 more enjoyable for the first buyer 101. For example, when the first buyer 101 goes back to the merchant to buy another product and has a discount 506 available, when the first buyer 101 uses the discount 506, a notice can be provided in connection with the discount 506 that says something like: “You have 10% off because your friend John bought a lamp like the lamp you bought. Congratulations and thank you for the recommendation!”. In other words, part of this process is integrating data about the second buyer 122 into a purchasing experience for the first buyer 101 of another product from the same merchant that sold the first product 102. The approach could also apply to however or wherever the benefit is applicable whether at the same merchant or not.

The approach shown in FIG. 5A in which the virtual wallet 502 can be used to combine a discount 506 with data from a credit card 504 in communication to a computer server 510 is helpful. For example, the first buyer 101 might have received a benefit for having the second buyer 122 buy the second product 128 by scanning an object 106 on the first product 102. With the benefit (in this case, a discount 506) stored in the virtual wallet 502 of the first buyer 101, when the first buyer 101 returns to the store, when the first buyer 101 makes a purchase of another item, the computer server 510 can query whether there is an available discount 506 and if so, the data associated with the discount 506 can be retrieved and provided to the computer server 510 to redeem the discount 506 (such as reducing the new item cost by 5%) and process the payment. In this case, the exchange of information can occur during an Apple Pay or Google Pay or other payment process which can cause a graphical user interface interaction with the user to ask to apply the discount or not, and then a payment token that is generated per the process can be generated with the proper cost taking into account the benefit. The process can be implemented based on a coordination via the virtual wallet 502 between items held within the wallet or between the virtual wallet 502 and a separate application 508 that perhaps manages the use of objects 106 as disclosed herein.

In yet another aspect, the first buyer 101 who receives a benefit or discount 506 can also share that discount 506 with any other person. For example, if the second buyer 122 purchases the second product 128 based on a scan of the object 106 on the first product 102 bought by the first buyer 101, the first buyer 101 may never return back to that merchant because they have moved or do not need any more lamps. Thus, the first buyer 101 could actually give their benefit such as the discount 506 to the second buyer 122 to enable them to directly receive a discount 506 on the second product 128 that they are buying.

In one aspect, an entire secondary market could be established in which benefits are traded or sold. The purchasing service 117 could include a secondary market 522 that enables people to sell for cash their benefits that they do not think they can redeem. For example, if the first buyer 101 has a 5% discount 506 available for purchase at a furniture store, the value of that discount might be expected to be say $50. Given an expected value, the first buyer 101 might be willing to sell that benefit or discount 506 for $25 thus leaving still one discount or benefit left to a second person who bought that benefit on the market. The discount 506 could then be transferred from a first wallet of the first buyer 101 to a second wallet of the second person, as adjusted to account for the sale, to enable the second person to then take advantage or redeem the benefit. The benefit may remain the same or may be adjusted based on one or more factors such as timing, value, cost of the sale of the benefit in the secondary market 522, and so forth.

The product wallet 520 can also be integrated into a company application or website for the user. In some cases, an “app” can be used for tracking purchases and earning rewards at restaurants or other stores. Such an app can be updated to store the purchasing history of products that have associated objects 106. For stores such as Ethan Allen, or a sporting foods store or furniture store, etc., the user may be able to see their purchases, receive notices of special programs related to their goods and so forth. The purchasing service 117 or code management server 702 can provide such information to the merchant to inclusion in their application options.

FIG. 5B illustrates a method 550 implemented by the wallet and POS system disclosed in FIG. 5A. The method 550 can be practiced from the standpoint of the first buyer device 114 or from the standpoint of the point-of-sale device 112 and associated infrastructure. The method 550 can include providing via a wireless link, from a point-of-sale device and to a mobile device data identifying a merchant, wherein the data identifying the merchant is associated with an initiation of a payment process for a transaction of purchasing a product (552), receiving, from the mobile device and over the wireless link, payment data to pay for the product and discount data to be applied to purchasing the product, wherein the payment data and the discount data are both received over the wireless link (554), applying the discount data to the transaction to generate a remainder amount for the transaction (556) and processing a payment of the remainder amount, if any, using the payment data (558). The discount data can represent any benefit associated with the purchase.

From the standpoint of the mobile device or the first buyer device 114, the process would be mirrored where the first buyer device 114 would receive an identification of the merchant via a wireless link and in connection with the initiation of a payment over the wireless link for a product. An application, virtual wallet 502 or other component of the first buyer device 114 would determine whether a discount is available for that merchant. If so, a payment process would be modified such that additional information or steps required would be implemented to confirm whether the discount should be applied to the current transaction that has been initiated. If so, then the data that is passed over the wireless link to the point-of-sale device 112 (i.e., not through an optical scan of a QR code but through Apple Pay, Google Pay, Samsung Pay, etc.) is not only the payment data (such as a one-time use payment token), but also the data about the application of the discount. The computer server 510 then processes the discount, applies it, and charges the lower amount for the purchase if there is any amount left to be charged.

The process may be implemented in several steps as well. For example, the point-of-sale device 112 may provide via the wireless link the merchant data and the user interaction discussed above may confirm that the discount should be applied. The computer server 510 may then cause a revised amount to be identified as being associated with a one-time payment token for that amount and then that payment token can be provided over the wireless link to the point-of-sale device 112. In other words, rather than the payment process being initiated in which the point-of-sale device 112 sends data to the first buyer device 114 that a $21 payment token should be transmitted via the wireless link, and the first buyer device 114 transmits that payment token after the user clicks twice on the side button 505 and provides a facial recognition confirmation. In this new scenario, if a discount is available, the payment interactions for the user can be modified to confirm that the discount can be applied, then after the two clicks and facial recognition, the confirmation of the application of the discount is sent to the point-of-sale device 112 and based on the application of the discount, a new amount is transmitted to the first buyer device 114 and a payment token is generated which is configured for the discounted amount. In some cases, the actual user interaction with the mobile device might not change (such as when a notice is provided that by clicking twice and applying facial/motion recognition the payment will be made with the discount applied), but there will be more exchanges of information to confirm the proper amount for payment data transmitted to the point-of-sale device 112. These additional interactions can be transparent to the user experience.

In one example process, the merchant or clerk can initiate a payment process at a register and cause the payment process to begin. This is typically where the user brings the first buyer device 114 near to the point-of-sale device 112 to pass the payment information via a wireless link. In this new case, if the merchant has a discount program, the merchant using the point-of-sale device 112 can initially indicate the identity of the merchant so that the first buyer device 114 can check if there are any discounts for that merchant and perhaps confirm with the user to apply the discount to the current purchase. If so, or if not, that information is passed via the wireless link to the point-of-sale device 112 and the final amount of the purchase, if any, is calculated and transmitted back to the first buyer device 114 for the virtual wallet 502 to generate the payment token or pass the payment information to the point-of-sale device 112. This scenario is applicable where the payment token is generated for one-time use for a specific amount and whether the discount applies or not needs to be determined before sending the payment token.

Again, embodiments can be claimed from the standpoint of a virtual wallet 502, an application 508, a mobile device such as the first buyer device 114, the points of sale device 112, the computer server 510 or any other network-based device or a combination of two or more of these devices.

FIG. 5C illustrates another aspect of this disclosure. A method 560 can include one or more of: receiving, at a user device, an identification of a merchant via a wireless link with a point-of-sale device and in connection with an initiation of a payment over of a wireless link for a product (562); determining whether a discount (or other benefit such as access to a venue, tickets to a show, or a reservation at a restaurant) is available for the merchant (564); and, when the discount or benefit is available, coordinating payment data and discount data in a virtual wallet or between applications on the user device to cause final payment data sent over the wireless link to reflect the discount when paying for the product (566).

Note that the discount data might be for the benefit of the first buyer or might be simply the data about the first buyer 101 in the second buyer wallet. For example, some cases described herein involve the second buyer scanning the object 106 or receiving the object 106 at a first time and not making a purchase at that time. They might want to make the connection to the first buyer 101 as the one who introduced them to the product but wait to make the purchase. The discount 506 in this case may represent a code or object 106 that identifies the product and the first buyer 101 such that when the second buyer 122 at a second, later time, buys the second product 128, the system can coordinate (within the virtual wallet 502 or between the virtual wallet 502 and the application 508) the data contained in the discount 506 and cause the benefit to be provided to the first buyer 101. For example, the process may cause a discount 506 to be deposited in the virtual wallet 502 of the first buyer 101 when the second buyer 122 buys the second product 128 such that when the first buyer 101 goes back to the store, the benefit is stored and available for application in the virtual wallet 502 of the first buyer 101.

FIG. 5D illustrates another aspect of the product wallet 520. In this aspect, the first buyer 101 may purchase may “first products” 102. Each product can have an associated entry in the product wallet 520. The first buyer 101 may buy a lamp 570, a backpack 572, some protein powder 574, a pair of Nike shoes 576, and a YETI Water bottle 580. The first buyer 101 may have many products which are in the purchasing service 117 registration database 118. Because there may be many products in the product wallet 520, the user can be presented with a search field 578 in which the first buyer 101 can search for products to either pull up the object 106 for scanning by another device or to take some other action. From this user interface, the first buyer 101 can select an item and then choose to text/email 588 the item or otherwise send the item via a communication via a communication platform 584 like an email application or texting application. The first buyer 101 can select to post to social media (SM) 590 or to a social media platform 582. The first buyer 101 may also share 592 the item with a second buyer 122. For example, the second buyer 122 may use the second buyer device 120 to scan the object 106 shown in FIG. 5D. The first buyer 101 can then share 592 the benefit embodied in the YETI Water bottle 580 item with the second buyer 122 so that when the second buyer 122 completes the transaction, the second buyer 122 gets the benefit such as a discount on the YETI Water bottle 580 that they want to buy. At that time, the YETI Water bottle 580 entry would disappear from the product wallet 520.

The new functionality disclosed with respect to the product wallet 520 is the ability to store multiple product entries that the user can search through and then choose what to do with each individual entry. The first buyer 101 may just be able to pull up a particular entry for a friend to scan or may be able to take various actions for that entry such as posting on a social media site, social media platforms 582 or to take other actions. When posting on the social media platform 582, note that the connection between the first buyer 101 and the product will remain such that anyone who interacts with the object 106 or buys the product from the first buyer 101 social media posting will cause a benefit to be provided to the first buyer 101.

Each entry in the product wallet 520 can be one of several types of items. For example, the entry such as the backpack 572 may represent or contain an object 106 for scanning by a second device. If the first buyer 101 just purchased the backpack 572, then they will not yet have any benefits from a second buyer 122 purchasing the same backpack 572. But, for YETI Water bottle 580, not that there is an item B:3 586 which can indicate that three people (three second buyers 122) have purchased a YETI Water bottle 580 via a connection with the first buyer 101 such that there are three benefits available to the first buyer 101. Again, one or more of these benefits can be shared with others. The first buyer 101 could share 592 all of these benefits with a second buyer 122 or may select a single benefit (like a 10% discount or a 5% discount) with the second buyer 122 or may send a text/email 588 which can be accepted by a second buyer 122. The second buyer 122 may have their own product wallet 520 that can store the benefit for their use when they make a purchase at the merchant. The benefit may be product-based or merchant-based. It could also be affiliate-based where a partner company that sells complementary products can implement or enable the benefit.

FIG. 5E illustrates a user interface 595 on a first buyer device 114. The user interface 595 can be presented as part of a sales process online or at a physical point-of-sale. The system may receive the items that are being purchased. Say the user bought 10 items at a store. A subgroup of those items is likely available to register with the purchasing service 117. However, the first buyer 101 may not want to register every single item. The user interface 595 provides the opportunity to the first buyer 101 to take some actions at the point-of-sale. The first buyer 101 can Pick items to register 595. A variety of products 597 are listed with boxes 598 to enable the first buyer 101 to select which ones to register at the purchasing service 117.

Other functionality could be included such as the ability to text/email 588 a benefit or an object to a second buyer 122, to post to SM 590 or to share 592 an item with a friend. For example, the user may select the backpack and Nike shoes and post those two purchases to social media 590 or text/email 588 them to a friend.

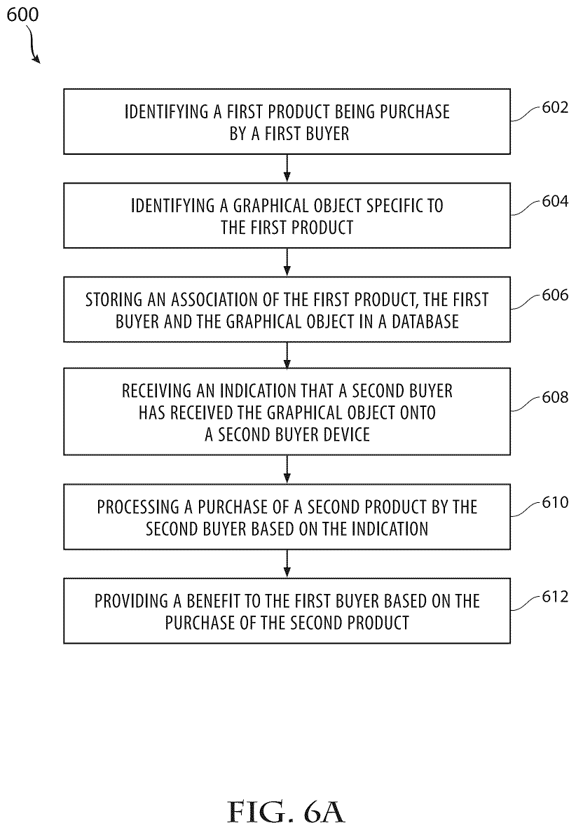

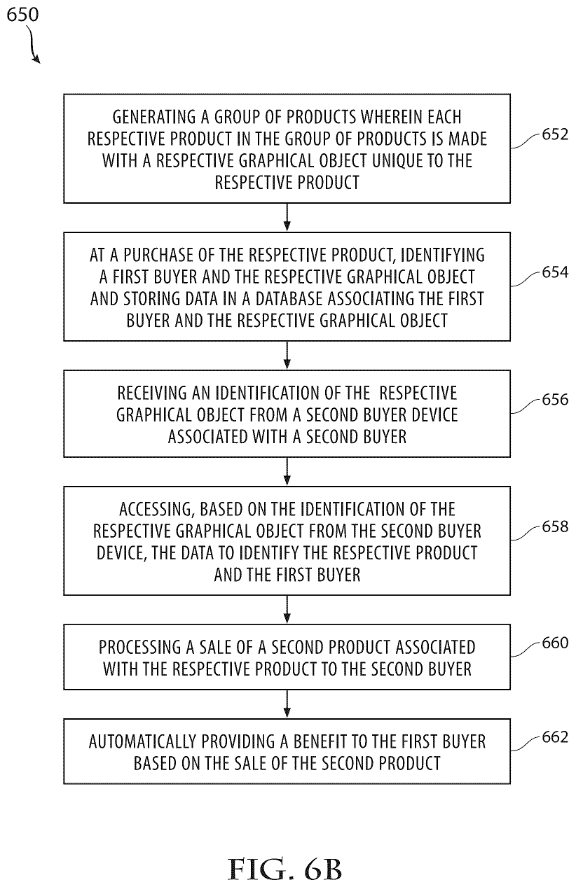

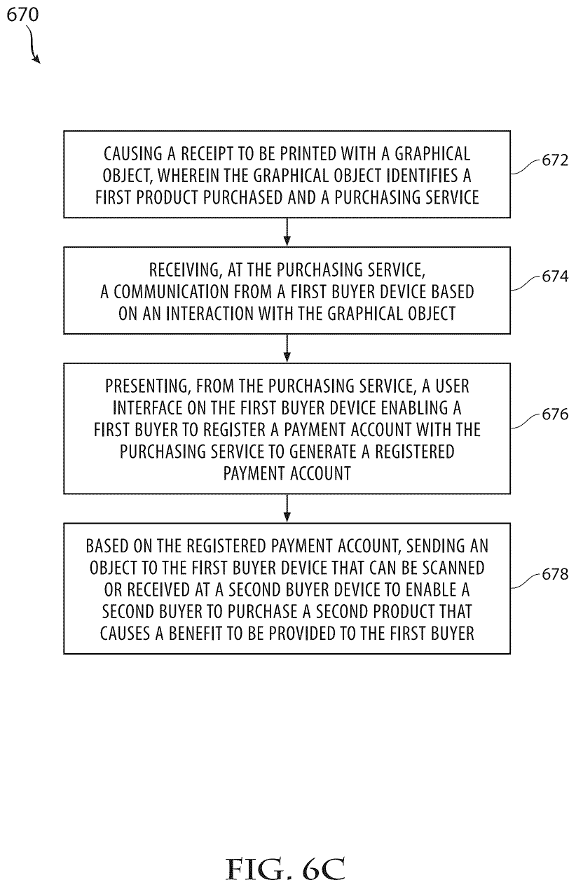

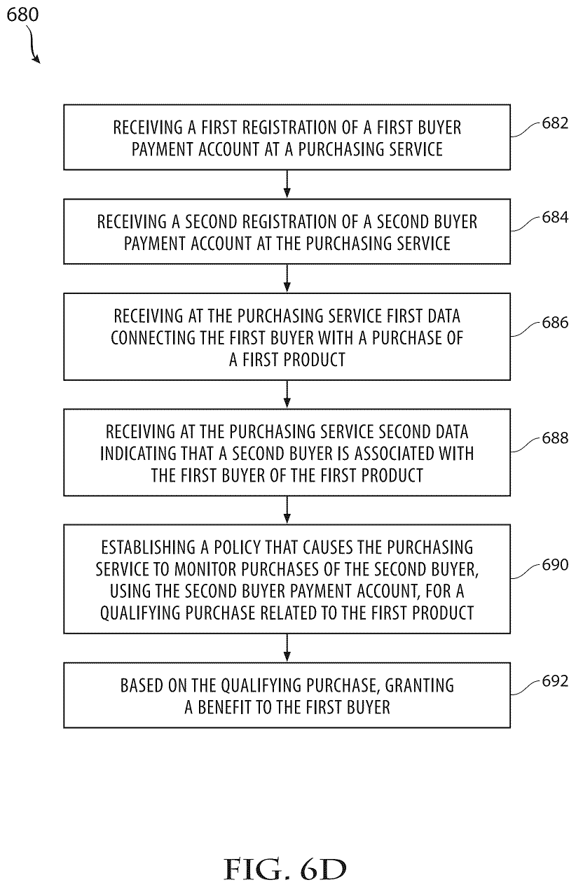

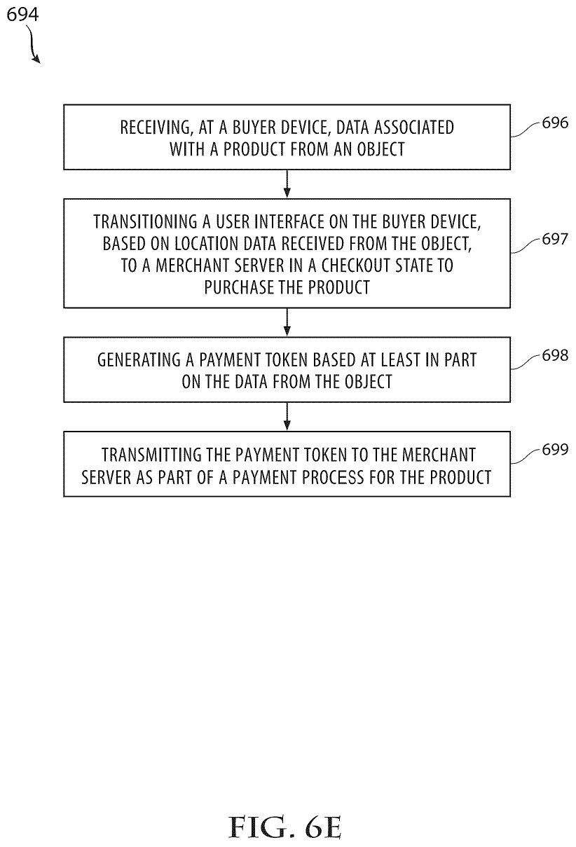

FIG. 6A illustrates a method 600 including one or more of identifying a first product being purchased by a first buyer (602), identifying a graphical object specific to the first product (604), storing an association of the first product, the first buyer and the graphical object in a database as well as linking any relevant data pertaining to the graphical object (606), receiving an indication that a second buyer has received the graphical object onto a second buyer device (608) (e.g., the second buyer has scanned the object 106 and thus obtained the URL and/or other data contained there, or that the second buyer device 120 has been used to receive data from a NFC chip on the product, or has received a communication containing the data, etc.), processing a purchase of a second product by the second buyer based on the indication (610) and providing a benefit to the first buyer based on the purchase of the second product (612).

Again, note that the receiving of the graphical object in the method of FIG. 6A can include receiving data associated with the object whether graphical or via a wireless communication channel or link. There are a number of different ways in which the second buyer device 120 receives the data that is used to initiate the purchase of the second product 128 so that the second buyer 122 can get the second product 128 and the first buyer 101 can get the benefit.

FIG. 6B illustrates a method 650 that includes one or more of generating a group of products wherein each respective product in the group of products is made with a respective graphical object unique to the respective product (652), at a purchase of the respective product, identifying a first buyer and the respective graphical object and storing data in a database associating the first buyer and the respective graphical object (654), receiving an identification of the respective graphical object from a second buyer device associated with a second buyer (656), accessing, based on the identification of the respective graphical object from the second buyer device, the data to identify the respective product and the first buyer (658), processing a sale of a second product associated with the respective product to the second buyer (660) and automatically providing a benefit to the first buyer based on the sale of the second product (662).

FIG. 6C illustrates an example approach. In some cases, a user may not be registered with a code service or purchasing service 117 and get a receipt for a product. The receipt can include a code or a graphical object that can be later scanned by a user's mobile device. The graphical object in this case on the receipt identifies the product that was just purchased and can include data such as a universal resource locator (URL) for a purchasing service 117. Then, later, the user can scan the graphical object on the receipt and be taken to a registration user interface operated by the purchasing service 117. The user can register a credit card 504 or first buyer payment account 121 and thus enable the ability to receive an object 106 (note which is different than the graphical object on the receipt) which can be stored in a product wallet 510 and later scanned by friends to buy the same product for themselves. Or a friend may receive an email or text having the object 106 attached which can be used or interacted with to enable the second buyer 122 to buy the second product 128, while granting a benefit to the first buyer 101.

In this case, the product itself may or may not have an object 106 affixed to it. The user may receive after registration an object 106 that can be stored in a virtual wallet 502 or product wallet 510 or which can be printed on a sticker which can be then affixed to the product. The virtual wallet 502 or product wallet 510 can store many graphical objects 106 associated with various products the user has purchased. A user interface could enable the user to search for products in the virtual wallet (such as backpack or lamp) to find the object 106 which a friend may want to scan.

The product wallet 510 might also include the ability to prune extra objects 106. The user might be able to go through if there are many products each with an object 106 and side swipe or delete certain objects 106 from the product wallet 510.

FIG. 6C illustrates a method 670 that includes one or more steps of causing a receipt to be printed with a graphical object, wherein the graphical object identifies a first product purchased and a purchasing service (672), receiving, at the purchasing service, a communication from a first buyer device based on an interaction with the graphical object (674), presenting, from the purchasing service, a user interface on the first buyer device enabling a first buyer to register a payment account with the purchasing service to generate a registered payment account (676) and, based on the registered payment account, sending an object to the first buyer device that can be scanned or received at a second buyer device to enable a second buyer to purchase a second product that causes a benefit to be provided to the first buyer (678).

Yet another aspect is shown in FIG. 6D and includes the idea of establishing at a first time a connection between the first buyer 101 and the second buyer 122 but without processing a purchase of the second product. For example, the first buyer 101 may have a large item like a couch or a stove. The second buyer 122 may be in the market but not ready to buy. The second buyer could scan an object 106 or otherwise get connected in the purchasing service 117 with the first buyer 101 without buying the particular object. However, assuming both the first buyer 101 and the second buyer 122 are registered with the system, the connection between the two people and the first product 102 can be established in the purchasing service 117. For example, the object 106 may be stored in a product wallet 510 of the first buyer 101 and scanned using the second buyer device 120. The scanning in this example may give the second buyer 122 a chance to make a purchase of the second product 128 or may ask if they want to defer such that later when they use their registered payment account 136 at the merchant that the purchase will apply the benefit to the first buyer 101. A policy 134 can be established at the purchasing service 117 which then is used to monitor the purchases of the second buyer 122 using the registered payment account 136. The second buyer 122 may for example use a VISA card for purchases generally. As the second buyer 122 goes about making purchases using their registered VISA card, finally they may desire a month or two later, that it is time to buy the second product 128. When they do, they can just use their VISA card. The purchasing service 117 monitors their purchases and upon detecting that they made the purchase according to the policy 134, then the purchasing service 117 can automatically provide the benefit (e.g. a refund, money, discount or another policy 134 established for the first buyer 101) to the first buyer 101. In one example, a policy 134 can be established for the first buyer 101 which involves a discount (say 10% off) of their next purchase at the merchant. In that case, the purchasing service 117 monitors the purchases using the first buyer payment account 121 for purchases at the merchant to automatically implement the benefit when a qualifying purchase is made.

All of these transactions can be coordinate with social media accounts, email accounts or text phone numbers such that when any event discussed herein occurs, one or both of the individuals involved gets a notice or reminder or posting related to the event. For example, if the first buyer 101 is George and the second buyer 122 is Fred, when George redeems his discount at the merchant based on Fred buying a lamp based on his relationship with George, a message can be sent to Fred that George just redeemed his discount.

FIG. 6D shows a method 680 that includes one or more of receiving a first registration of a first buyer payment account at a purchasing service (682), receiving a second registration of a second buyer payment account at the purchasing service (684), receiving at the purchasing service first data connecting the first buyer with a purchase of a first product (686), receiving at the purchasing service second data indicating that a second buyer is associated with the first buyer of the first product (688), establishing a policy that causes the purchasing service to monitor purchases of the second buyer, using the second buyer payment account, for a qualifying purchase related to the first product (690), and, based on the qualifying purchase, granting a benefit to the first buyer (692).

The timing of the purchase of the first product, and then the receipt of the second data indicating that the second buyer is to be associated with the first buyer of the first product, and then the actual purchase of the second product by the second buyer, can all be at separate and independent times. For example, the first buyer may buy a lamp on Monday. The second buyer may scan with their mobile device an object or receive a text or email with the object that they interact with. A user interface may enable the second buyer to indicate that they do not want to buy the product now but that they may later. Then, the policy can be established such that when the second buyer simply buys the second product (their own lamp) at the merchant, that the first buyer gets the benefit of the friend referral. Another policy might be established for the first buyer so that when they return to the lamp store, and make another purchase, a discount is automatically applied. The benefit can be of any type such as a discount, access to a venue, a free accessory, a rebate, and so forth.

In another aspect, if an object 106 is stored in a virtual wallet 502 and the first buyer 101 wants to share that product with the second buyer 122, then the virtual wallet 502 or other user interface can be configured such that the object 106 can be emailed, texted, shared over a social media platform (such as social media platform 714 in FIG. 7A) such that the friend can receive the communication and can launch a purchasing process from the communication. The second buyer 122 can be brought after clicking on the email or a link or other interactable object to a checkout page of the merchant with the product preconfigured in a state where the user can easily buy the product and have it delivered to them. The checkout process is further configured upon the purchase being accomplished to grant the benefit to the first buyer 101 who sent the communication. Thus, when the second buyer 122 tells the first buyer 101 that they love those shoes, the first buyer 101 can just send the object 106 to the second buyer 122 via email or text or through any communication channel.

The concept of registering a payment account to generate a registered payment account 136 and enabling the benefit to the first buyer 101 by monitoring purchases using the registered payment account 136 can be achieved using concepts disclosed in U.S. Pat. No. 11,416,846, issued Aug. 16, 2022, incorporated herein by reference.

FIG. 6E illustrates another aspect. Normally, when Apple Pay or Google Pay is used via an API build into a browser, via an app, or at a point-of-sale device 112, the merchant will send some data such as via a “payment request” about the merchant and the amount of money to be paid. Then a payment token is created that is transmitted to an e-commerce back-end system that decrypts the token and submits it to a payment processor. In the approach disclosed herein, the object 106 or other feature such as a near field communication (NFC) chip on the product, can have the same information provided. For example, such data associated with the object 106 can include merchant capabilities, supported networks, country code, billing contact fields, billing contact, shipping contact, application data, coupon codes, line items, currency codes, shipping types, shipping methods, recurring payments, deferred payments, cost of product, and so forth. Thus, the process can obtain some data from the object 106 such as a cost of the item, product description, merchant data, or any other merchant data that might be used for example in an Apple Pay or Payment Request API call that initiates a payment process. From the second buyer device 120, a software module can obtain information about the second buyer 122 such as payment information, name, address, phone number and so forth.

Thus, when the second buyer 122 uses their second buyer device 120 to interact with the object 106, much if not all of the necessary information can be received for generating a one-time use token (such as in Apple Pay) to enable the merchant to submit to a payment processor.

In one example, the second buyer 122 uses their second buyer device 120 to interact with the object to identify the product, the amount, the merchant, and perhaps a necessary URL to enable the second buyer 122 to land on the merchant checkout page ready to “one-click” purchase the second product 128 using their preferred or often used payment method, such as Apple Pay, Google Pay or Samsung Pay. The approach has several benefits. One is that less data needs to be exchanged compared to a normal “payment request” approach for Apple Pay, Google Pay and Samsung Pay. This is because some of the necessary data is obtained from the object 106 and from the second buyer device 120. Next, it is desirable for the second buyer 122 to have a positive experience with the merchant website or back-end server. If the second buyer 122 lands on a convenient checkout page for the product and is in position to simply confirm the payment for the second product 128, the experience will be positive for the second buyer 122. The approach disclosed herein simplifies the process of how the payment enabled by a one-time use token such as in Apple Pay can occur. In another aspect, the second buyer 122 can land on a checkout page of the merchant and the standard Apple Pay, Google Pay, Samsung Pay (or any other payment approach enabled for the second buyer 122) approach including the use of payment requests to obtain data over an application programming interface (API) can be executed.

In one aspect of the disclosure, the registration of the registered payment account 136 is achieved in a number of different ways. For example, when a user purchases a product at a point-of-sale device 112, the user can be presented as part of an Apple Pay or Google Pay process if they want to receive an object 106 which associates them with the purchase and which enables them to receive a benefit if a friend buys the same product through interaction with the object 106. In that case, the user's payment account (VISA, Mastercard, Amex card) can become the registered payment account 136 to which the benefit can be directed if the second buyer 122 purchases a second product 128.

FIG. 6E illustrates a method 694 that includes one or more of: receiving, at a buyer device, data associated with a product from an object (696), transitioning a user interface on the buyer device, based on location data received from the object, to a merchant server in a checkout state to purchase the product (697), generating a payment token based at least in part on the data from the object (698) and transmitting the payment token to the merchant server as part of a payment products for the product (699).

FIG. 7A illustrates an example code management ecosystem 700. In this case, as has been noted above, there are many different ways of implementing the basic concept of establishing a connection or relationship between a buyer and a product and generating an object 106 that embodies that relationship. The object 106 can be scanned by a second buyer 122 who then buys a second product 128 thus causes the code management system 700 to grant a benefit to the first buyer 101.

However, there are many different business types and product types from building supplies, to energy food products, to games, to electronics and furniture and virtual products like software services. Implementing the general concepts disclosed herein can vary based on the company or product type. The code management ecosystem 700 can provide services to any company having a particular product type. For example, application programming interfaces (APIs) can be developed for different types of products. As shown in FIG. 7A, a code management server 702 can be used to store or manage multiple different business types such as a first business type 706, a second business type 708, a third business type 710 and a fourth business type 712. These different business types might be divided or characterized as business that sell physical products that can receive or have printed on the product or a box storing the product a graphical object 106. Other products might be best suited for an NFC tag as the object 106 that is configured in clothing or a portion of the product. The third business type 710 might be a service provider such as a doctor, dentist, cleaning company, yard care company and so forth. The fourth business type 712 might sell software or virtual products such that purchasers of their products at best can receive a digital copy of a graphical object 106 that can be stored in a virtual wallet 502. In some cases, the code management system 702 might transmit electronically an object 106 for each product made in a factory that is then used by the business to make the products. Other companies might provide a product catalogue and access to point-of-sale data and receive a dynamically-generated object 106 to print on a receipt at the point-of-sale. Later, when the first buyer 101 scans the object 106 on the receipt using a first buyer device 114, the code management system 702 registers the user and records the connection of the first buyer 101 with the particular product. The object 106 is then ready for scanning by a friend.

The code management system 702 then can manage multiple different verticals or business types and provide services related to the generation of the proper object 106 on a product by product basis. The code management server 702 can manage the relationship with social media platforms 714 for the users of the system and provide the back-end support for the entire ecosystem much like payment management platforms 718 like Shopify or BigCommerce manages payments for companies.

Another service can be a communication platform 716 which can enable any type of communication such as texts, email, social media messaging, telephone calls, video calls and so forth. An object 106 associated with a first buyer device 114 can be shared via any kind of communication via the Communication platform 716 with a second buyer device 120.

As noted above with respect to the purchasing service 117, the code management server 702 can include many if not all of the same features such as a registration of a registered payment account 136 of a user for access.

In one example, the business could be a restaurant. Here, the first buyer 101 might be someone who ate at the restaurant and desires to recommend the restaurant to a friend. One approach can be to enable the user to scan a barcode on a receipt to obtain an object 106 that they can then share with their friend via text or email. In another aspect, the ability to receive an object 106 can be integrated into an Apple Pay or Google Pay process. For example, when paying with Apple Pay at a point-of-sale 108, the first buyer 101 clicks twice on a side button of the iPhone and then looks at the iPhone for facial recognition (or other confirmation procedure) to confirm the payment. Another interaction could be built into this process in which the user clicks on an object that says, “generate and store in a wallet an object to share with a friend”. When the payment is confirmed or completed, the first buyer 101 can receive an object 106 in their virtual wallet 502 that associates the person with having purchased a meal at the restaurant. The interaction may include an option to pick a contact or enter an email address or phone number of their friend such that the object 106 can be generated and sent to the second buyer device 120 ready to use. The purchasing service 117 at this stage can set up a policy that governs or stores data about the second buyer 122 and their payment account and the restaurant such that when the second buyer 122 uses their payment account to buy a meal at the restaurant, then the first buyer 101 gets the discount or benefit activated. In other words, the system can monitor purchases using the second buyer payment account and when a qualifying purchase is made by the second buyer 122 according to the policy, then the benefit is provided to the first buyer 101. When that benefit is affirmed, the purchasing service 117 may create another policy for the first buyer 101 such that the purchases of the first buyer 101 using the first buyer payment account 121 are monitored for a qualifying purchase (at the right restaurant) using the first buyer payment account 121, that the discount is applied to that transaction.

The first buyer 101 may also have a visual or other object on their mobile device that the second buyer 122 can scan. The first buyer 101 may recommend a certain restaurant like Mod Pizza and say, “here, scan this code to get a discount and I'll get some points at the restaurant as well”. The second buyer 122 can scan the code and get perhaps set up with the application for the store (i.e., the process can include checking on whether they have downloaded the app or whether they need to download the app), or may register or ask the second buyer to register with the purchasing service. Then, the second buyer may have a “reward” in their app or may automatically be tracked for a purchase at the restaurant based on tracking or automatic monitoring of the payments using their credit or debit card (or other payment mechanism) and receive the reward, while the first buyer 101 can also, based on the transaction, get their benefit for the referral. Again, the second buyer 122 may get a benefit merely by making the purchase via the monitoring system tracking their credit card/debit card purchases for a triggering purchase according to a policy set up when they scanned the object on the phone of the first buyer 101. The policy identifies the first buyer 101 as the referring person, the second buyer 122 as the person who may buy the second product, the benefit to be provided to the first buyer 101 and any discount or other benefit to the second buyer 122 when they complete a purchase.

Note that there are several layers of policies that can be established for monitoring purchases using specific payment accounts. The first policy can apply for the second buyer 122 to enable the knowledge of the second purchase to be obtained to grant the benefit to the first buyer 101. Then, another policy can be established to enable the granting of the benefit to the first buyer 101. This process of course can work for any business model and not just restaurants.

Another aspect of using a code management server 702 can be where a company might provide a product catalogue to the code management server 702 such that unique codes can be generated in advance or dynamically for individual purchases of the products in the catalogue. Furthermore, the catalogue may identify which products need objects generated and which do not. Not every product will be desirable to have an object created. For example, a candy bar or a Matchbox car may not need codes generated, but other products are more likely to be admired by friends where they might desire the product for themselves.

Furthermore, the code management server 702 or the merchant might also generate objects 106 for products during a window of time. A new product launch might include the advertisement that friend codes or object 106 will be printed on the first 200 purses or bicycles to urge the first group of buyers in that if their friends buy off of them, they get some benefit. Or, merchants may desire objects 106 to be generated during the holidays or as part of a surplus of products or for some other reason. Thus, the timing of when objects 106 are available to consumers can be controlled and limited. The objects 106 may also grant different benefits such as higher benefits for the earlier purchased items versus lower benefits for a later batch or for products purchased a month after the launch. In this manner, merchants can select or control when the objects are created to push timings of when friends share or urge their friends to purchase the same product.

The principles disclosed herein can also be integrated into a payment management platform 718 like Shopify and BigCommerce that manage payment solutions for small businesses. For example, the code management server 702 can coordinate with Shopify each sale and generate an object 106 that is transmitted to the first buyer 101. Product catalogues, pictures, product descriptions, product categories or types, and so forth can be shared such that Shopify or a similar service can modify its services to add the option to associated buyers and specific purchased products as disclosed herein. APIs could be developed with syntax or structures for providing the information. For example, the API could receive information associated with a product and the person buying the product at the code management server 702 and the code management server 702 can generate an object 106, return the object 106 and store the data for later processing.

With respect to social media platforms 714, for example, for Facebook Shops, merchants share their product catalogue with the social media platform 714 and are able to advertise on the social media platforms 714. Under one framework, when buyers want to purchase a product on a social media platform 714, the buyer stays on the platform to make the purchase rather than transitioning to the merchant site to make the purchase. This is generally called “social media commerce” and works for many social media platforms 714 such as Facebook, Instagram, TikTok, etc. One adjustment to the process of purchasing products on social media platforms could be the integration of the process with the code management server 702 in which products that are tagged virtually for having an object 106 created for that instance of the product can be sold in such a way that the product and the buyer can be associated and their data stored for further processing when friends when to buy the same product. The checkout experience on a social media platform 714 can include an option for the buyer to register with the code management server 702 and to set up a wallet or receive an object 106 for the product which they can then use to share the product with friends who want to buy one for themselves. If the user is already registered, the checkout experience might include just a confirmation that an object 106 should be generated for the user. If the product is made with a physical object (like a visual code on a Monopoly game box) already, the checkout experience might just notify the user that the object 106 is printed on the box for showing to their friends if they want to buy a second product 128.

In one aspect, the ability of the first buyer 101 to register a payment account with the purchasing service 117 or the code management server 702, the ability to confirm the creation of an object 106 for the first product 102, the ability even to make notes or other instructions with respect to the data associating the first buyer 101 with the first product 102, can all be integrated into the payment process on a site, through Apple Pay, Google Pay, and other payment services, through payment management platforms 718, through social media platforms 714, through search engine payment services such as Buy on Google or other google advertisement processes such as where clicking on a Google advertisement lands the user in a checkout page of the merchant website, ready to buy. In one example, a search platform 720 like Google can coordinate with the code management server 702. In this scenario, Google could pass information about an identity of the searcher or person clicking on the advertisement using an API or other means that enables the identity to be connected to the product (which Google has through linking a product catalogue from the merchant) as part of the purchasing process at the merchant website. the coordination to enable the underlying association between the buyer and the product can occur a variety of different purchasing contexts.

Some users may not want an object 106 created for each product that qualifies or is tagged or identified as being available for an object 106. Otherwise, the user's product wallet 510 might get too full. Thus, part of this disclosure is the ability or option at a point-of-sale or other user interaction to select which product purchases will generate objects 106.

Whether a social media platform 714, a search platform 720, a communication platform 716 or a payment management platform 718, the approach can include linking or communicating from a business a product catalogue similar to what occurs with Google, Shopify, Facebook, Instagram, Amazon.com, etc. The product catalogue can be communicated to the code management server 702 or just to the other entity. The data communicated can include a flag or metadata identifying an individual product as one that should offer a “friend code” or object 106 in connection with the sale. The data could indicate that the product has an object 106 printed and available for scan at a checkout. in this scenario, a clerk or the person could be prompted to scan the object 106 at the checkout and a confirmation of the registration or storage of that data associated with the product is received at the code management server 702. Identifying the first product 102 could be done through one device at a point-of-sale which scans a UPC symbol 104 while a scan of the object 106 might occur by a second device at the point-of-sale 108.

Claims with respect to a catalogue use can cover the process from both a merchant server 126 and the search platform 720 or social media platform 714 or other platform such as the code management server 702. For example, from the merchant server 126, a method can include transmitting a product catalogue to another platform that includes identification data of which products either need an object 106 generated for their sale or which products will need to have an object 106 shipped with the product physically. The merchant server 126 may receive digital objects 106 electronically for electronic use or for printing an individual unique object 106 on a unique product or the merchant may receive a shipment of physical objects 106 like NFC chips or tags to integrate into the products. Then, the merchant server 126 may transmit or receive information associated with the processes described herein to enable the association of the first buyer 101 with the first product 102 to be established and recorded or stored (e.g., in memory or on the blockchain network 314) through use of the object and then later enable the second buyer 122 to buy the second product 128 based on an interaction with the object 106.

From the platform side, claims can cover the processes from that standpoint where the platform may receive a product catalogue that includes a listing of products and individual products that are identified as needing an object 106 or having an object 106 associated with each product. The information may cause adjustments with respect to how advertisements are presented (i.e., with a notice that this product has a “friend code” available), how checkout flows are implemented (e.g., such as where a user lands on a merchant checkout page from a google advertisement with instructions or the ability to manage the use of the object 106 disclosed herein), and/or how the product is sold at a point-of-sale 108 such as where additional user interactions may be used to confirm the use of the object 106, confirm the desire to implement the processes disclosed herein, register a user with the purchasing service 117 or the code management server 702, and so forth. Thus, steps or operations related to generating objects 106, scanning objects 106, transmitting data, receiving data, storing data in a database 118, presenting a user interface, receiving interactions with selectable objects on a user interface, registering users, accessing payment accounts, delivering benefits or discounts, and so forth can be claimed from the standpoint of individual players or entities in the ecosystem disclosed herein. This includes platforms like a search platform 720, a social media platform 714, sales platforms like Amazon.com, merchant servers 126, the purchasing service 117, the code management server 702, communication platforms 716 or any combination of these platforms. Each of these platforms may play a separate role in enabling the ecosystem disclosed herein and thus each can be separately covered in a patent claim reciting just the operations from the standpoint of the respective platform.

In another aspect, such as sales online via Amazon.com, or via a Google search or social media commerce purchase, the data can identify that the product sold has an object 106 associated with the sale and that the first buyer 101 will or can choose to have the purchase data stored for them or received as an object 106 in a wallet. Or, the first buyer 101 can be notified that the first product 102 has a graphical object 106 printed on a tag, or a box or some other location so that the user knows how to share the product with a friend.

One aspect of this disclosure includes listening to discussions between people through one or more of a device, the first buyer device 114 and/or the second buyer device 120. If through automatic speech recognition it is determined that there is a discussion about the first product 102, then the code management server 702 can provide a text or reminder to the first buyer 101 or the second buyer 122 that indicates that the product can be purchased easily by the second buyer 122 by scanning the object 106 located under the lamp or on the tag of the shoes or via an NFC tag in the tag of the shirt, etc. Such notices or reminders can also be triggered to be provided to a social media feed or other communication avenues.

The data about which products are available for use of an object 106 can thus be promulgated through any selling platform whether virtual or physical thus enabling friends to share products more easily that they like and receive a benefit for being a product champion which currently does not exist. The payment processes or advertising processes can be adjusted to provide a graphical object on an ad or on a checkout screen identifying that the product is available for a friend code or an object 106 that enables the buyer to receive a benefit when a second buyer 122 purchases the product through the object 106. The concepts disclosed herein can then be integrated into many sales of products that lend themselves to being shared with friends who might also want to purchase the same or similar product.

The code management server 702 (or the purchasing service 117) can provide a purchaser dashboard. The user can have their experience tracked and the user can get aggregated data and gamification experiences can be provided in a user dashboard. The user who has multiple products and who might be an influencer might want to see an overall picture of how their various products are doing, which ones have led to one or more generations of purchases, and so forth. The user can see all of their data across multiple products and can see aggregations of benefits or offers from merchants for example if a friend buys a lamp in the next two weeks, what the additional benefit will be to the first buyer 101. Thus, there can be a merchant dashboard and a user dashboard as well that is provided or offered by the code management server 702.

In yet another example, some people who are buyers have much more influence than others. One person who buys a lamp may have a very low likelihood of sharing or having a friend buy another lamp from the first lamp. The code management server 702 can obtain or use personal data about the first buyer 101 to determine whether to provide the first product 102 with the object 106. In other words, the merchant may have a batch of products without objects 106 but then for certain buyers (mostly online), where the buyer is identified as an influencer, then the first product 102 can be chosen from a group of object-connected products or can be made with the object for that first buyer 101. The data about the user might be income, past history, social media followers, social media history, pervious object-based purchases by friends, personal request from the buyer, and so forth. In this way, since it is more complicated to sell the first buyer 101 with the object 106, this approach can only sell products with objects 106 when there are certain characteristics of the user that may be of interest. The creation or sale of the first product 102 can be triggered based on one or more characteristics of the user. For example, the system receives a request to buy a product from the first buyer 101 and determines that the first buyer 101 meets a certain criterion associated with a likelihood of their friends also buying their own product from the first product 102, then selling the first product 102 with an associated object 106 and recording the association in the system. Thus, products can be sold to various people with only those who meet the criterion getting objects registered in the code management server 702 or purchasing service 117 for more beneficial buyers.

FIG. 7B illustrates a method 750 related to the code management ecosystem 700 described above. The method 750 can include establishing, by a code management ecosystem 700, a plurality of different code management models associated with how to store first data that connects a first buyer 101 to a first product 102 on a product by product basis for use in enabling a second buyer 122 to buy a second product 128 based on the data (752), offering a respective code management model to a merchant based on a type of product or service offered by the merchant (754), coordinating a merchant sales system with the code management ecosystem 700 (756), generating graphical codes for use in the sale of products by the merchant (758), providing the graphical codes to the merchant in connection with the sale of products (760), storing the first data that connects the first buyer 101 of the first product 102, the first data being associated with a graphical code (762), receiving second data that a second buyer 122 has interacted with the graphical code to buy a second product 128 (764), enabling a purchase of the second product 128 (766) and providing, based on the purchase of the second product 128, a benefit to the first buyer 101 (768).

The merchant depending on their type can simply sign up for the use of the particular API that is needed to enable the code management ecosystem 700 to assist them in joining the ecosystem described herein.

FIG. 7C illustrates another example method 770 for operating the code management ecosystem 700. The method 770 includes providing a code management service in which multiple different business models are capable of each having graphical codes generated for a plurality of products in which each graphical code can e associated with a single product and a single buyer (772), enabling individual merchants access to an associated business model via the code management ecosystem 700 (774), registering user payment accounts at the code management ecosystem 700 to yield registered user payment accounts (776), managing, at the code management ecosystem 700, the generation and distribution of graphical codes such that a first graphical code is associated with a first product and associated with a first buyer of the first product (778) and managing the granting of a benefit to the first buyer of the first product when a second buyer buys a second product based on an interaction with the first graphical code associated with the first product (780).

FIG. 7D illustrates a method 782 related to the integration of a social media platform 714 and the code management server 702. Social media commerce is known as the process of merchants providing a product catalogue to a social media platform 714 like Instagram and Facebook and then enabling advertisements on the social media platform 714 where users can purchase products while staying on the social media platform 714. In other words, users don't transition to the merchant server 126 to purchase products. This way, the user can purchase a product and continue to scan through a news feed, for example.

The new structure that relates to this disclosure with respect to social media is that when a purchase is made by a user on a social media platform of a product, the social media platform 714 or the code management server 702 can store data about the association of the first buyer 101 and the first product 102 purchased on the social media platform 714. The first buyer 101 in that case can be given the option to do a personal posting on their stories, news feed, messaging or any other communication channel or type of posting on the social media platform 714. The posting can be about how they purchased this lamp, or this pair of shoes and they love them. Right now, social influencers make money based on how many followers they have. The more followers, the more money they make when they make a posting about a product. However, under this approach, if the social influencer has purchased the product (and in some cases even if they have not), the posting has the stored data about the posting person who is the first buyer 101. Then, every other person that purchases the product from that posting causes a separate benefit to be provided to the first buyer 101 who made the posting. In this regard, users may click on an item in the posting or a buy button associated with the posting and be able to make social media commerce purchase by remaining on the social media platform 714 to complete the purchase, and the social media platform 714 and/or the code management server 702 can cause the benefit to be provided to the social influencer and first buyer 101 for each individual sale.

The method 782 can include receiving data that a first buyer 101 has purchased a first buyer 101 on a social media platform 714 (784), storing data associating the first buyer 101 with the first product 102 (786), posting a personal post from the first buyer 101 featuring the first product 102 (788), receiving a purchase of a second product 128 from a second buyer 122 who interacted with the personal post from the first buyer 101 (790), and granting a benefit to the first buyer 101 based on the second buyer buying the second product 128 based on an iteration with the personal post featuring the first product 102 (792).

This approach can easily integrate into existing social media commerce processes while enhancing the incentives of individuals who perhaps are not formal social media influencers to purchase products on social media platforms 714 and share their experience because they may be able to benefit from individual sales rather than being paid to have a million followers. The disclosed approach encourages the billions of regular social media users to purchase products using Facebook Shops or Instagram Checkout and then share their purchases without the need of having huge followings or arranging or contracting with merchants for payments per post based on how many followers they have. Users just need to register a payment account to obtain benefits for second buyers 122 purchasing second products 128 off of the first buyer 101 personal post.

From the merchant server 126 standpoint, the merchant server 126 can provide a product catalogue to a social media platform 714 and receive data regarding the first purchase of the first product 102 by the first buyer 101. The merchant server 126 or merchant can be registered with the code management server 702. The merchant server 126 through the advertising process on the social media platform 714 may provide a suggestion or opportunity for the first buyer 101 to register their payment account on the code management server 702 to take advantage of the ability to benefit from later purchases through their influence. The first buyer 101 then posts a personal posting on the social media platform 714 or sends a communication to the second buyer 122 who purchases the second product 128. The merchant receives the order for the second product 128 from the second buyer 122 and enables or through the user of the code management server 702 offers the benefit to the first buyer 101 as a reward for promoting the product or being a salesman or promotor of the merchant products. The first buyer 101 can redeem the benefit by using the registered payment account 136 at the merchant server 126 or point-of-sale 108 where a discount or other benefit can be provided.

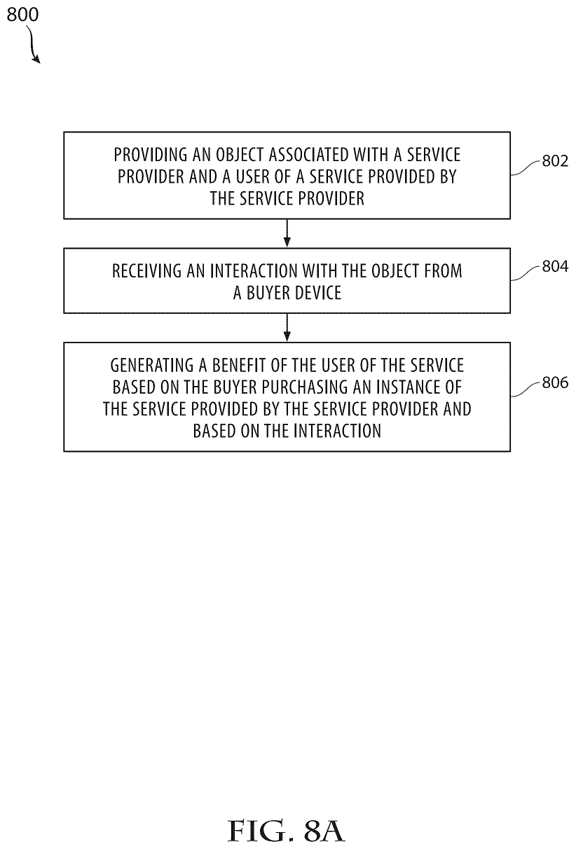

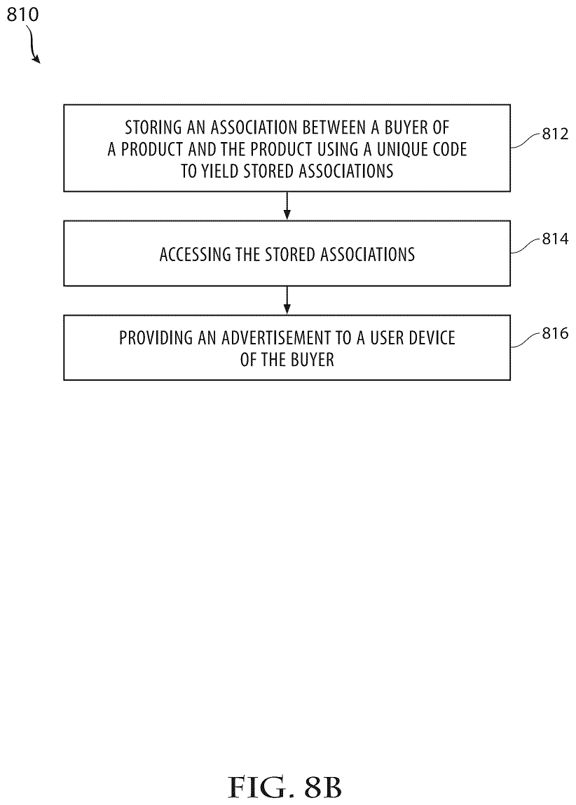

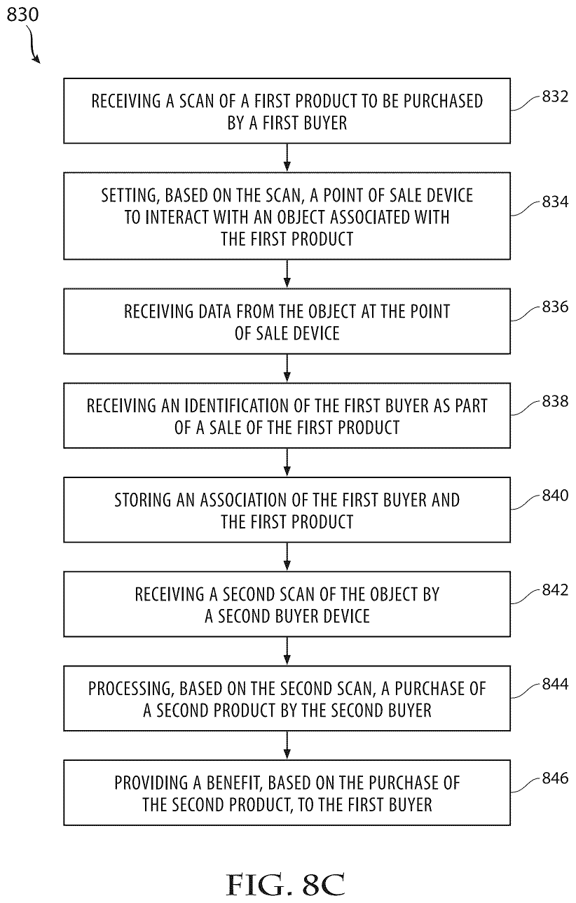

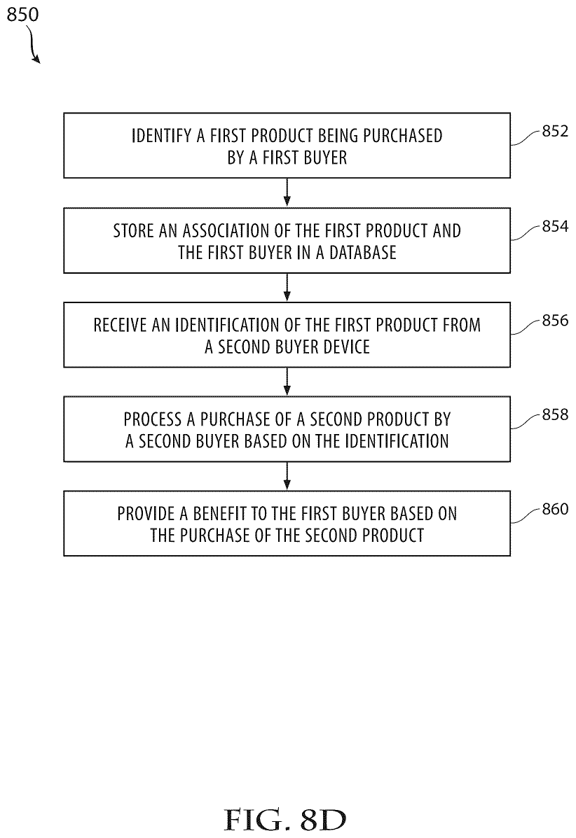

FIG. 8A illustrates another aspect of this disclosure related to referrals. In this example, the first buyer 101 is one who is not specifically purchasing a product but perhaps uses a product or service of a merchant. For example, a handyman, or a dentist or doctor might desire to take advantage of this disclosed system but they don't necessarily have product that an object 106 can be attached to. This disclosure includes the idea of enabling a website or application of a service provider to have a referral object included that is clickable. The first buyer 101 in this case uses the services of a dentist and desires to refer the dentist to the second buyer 122. The first buyer 101 can go to the dentist website and click on the referral object. What happens in that case is that an object 106 is generated such as a graphical code that includes information about the service provider (dentist) and the referring person (the first buyer 101). The object 106 can be delivered to a virtual wallet 502 of the first buyer 101 for storage. Then, when the first buyer 101 desires to refer the dentist to their friends, the second buyer 122 who is the friend only needs to scan the referral object in the virtual wallet 502. Then, the first buyer 101 can receive a benefit such as a free cleaning for the referral or some other benefit.

The code management ecosystem 700 can manage the process for the service provider as one of the potential business models.

FIG. 8A illustrates this approach. A method 800 can include providing an object associated with a service provider and a user of a service provided by the service provider (802), receiving an interaction with the object from a buyer device (804), generating a benefit of the user of the service based on the buyer purchasing an instance of the service provided by the service provider and based on the interaction (806). The object can be a graphical object presented on an application or website of the service provider that user of the service can interact with to receive in a virtual wallet 502 or otherwise a graphical object which can then be scanned by a buyer of the service (e.g., a friend of the user of the services of a dentist or builder). The user of the service can also receive in another case an NFC tag that they can use to share referrals of the service to family and friends.

Another aspect of this disclosure relates to advertisements and notices sent to people registered in the purchasing service 117 or the code management server 702. For example, benefits provided to the first buyer 101 may have a timed component. The first buyer 101 may can get a benefit for a year if a second buyer 122 purchases a second product 128. The first buyer 101 may get a notice that the first product 102 is on sale thus if they share with a friend, the first buyer 101 can be an extra benefit which is available for two weeks. The benefits may go up or down and the first buyer 101 can get notices to be aware of the deals and their benefit status. For example, a notice might be: “You can get an extra 5% if you share with a friend now-we are trying to move our backpack and camping supply inventory this weekend”.

In another aspect, the benefit as noted above may change to a different product. If the first buyer 101 is no longer available, the purchasing service 117 or the code management server 702 can simply adjust what the second product 128 is. The second buyer 122 may be brought to a checkout page when they use their phone to scan the object 106 with a next generation device or an updated product or even a different product depending on the desires of the merchant.

Advertisements to users can become much more tailor using the business data gathered through the disclosed principles. For example, an advertising service may provide ads based on one or more of a location of the first buyer device 114, data in the product wallet 520, a location of the second buyer device 120, a location of the first product 102 or the second product 128 and so forth. An ad could be individual such as: “You bought a lamp, now a couch is on sale from the merchant this weekend that will match that lamp”. There is business intelligence available which can help determine targeted advertising for the first buyer 101 or the second buyer 122. Recall notices can be provided to individuals on recalled products.

FIG. 8B illustrates a method 810 of advertising using the business intelligence data associated with the disclosed ecosystem. The method 810 includes storing an association between a buyer of a product and the product using a unique code to yield stored associations (812), accessing the stored associations (814), and providing an advertisement or a message to a user device of the buyer (816). The advertising can include instructions or data about a sale of the product to encourage the buyer to share or encourage a friend or other person to scan an object 106 configured on the product using a second buyer device 120 to purchase a second product 128. The advertisement may be a message about the product such as warranty information, or information that there is a new version of the product or a software upgrade.

Further, a second buyer 122, who might be connected through the first buyer 101 via a social media platform 714, can receive an advertisement to go to the first buyer 101 and buy the product by scanning the object 106 on the bottom of the lamp. A network might receive data about what the second buyer 122 was talking about to a friend, identify that they are interested in the first product 102, and transmit to the second buyer device 120 an advertisement to go buy the product by scanning the object 106 on the first buyer's backpack or shoes, etc. The advertisement can say that the first buyer 101 gets a benefit if you buy it from them. The message can notify the second buyer 122 that they don't need to go to a store to preview the product, they can just go to their friend. Such advertising or messages can also be sent to both the first buyer 101 and the (potential) second buyer 122. One benefit of this approach is that it can help bring people together around the products they love.

In general, the brick and mortar store has been pushed out into the world and whatever product one might be interested in could be found perhaps at a friend's house and easily bought with a benefit provided to your friend. In another aspect, users could approve of the system sharing their information about the products they have purchased to people who do not know them but who also want to buy their own copy of the product. Such people can be confirmed as safe through a number of approaches such as credit history or other safety mechanisms. But a social media platform 714 could be used to introduce people to each other who share the same interests. The first buyer 101 in this scenario would be motivated to meet new potential second buyers 122 because they get benefits of the second buyer 122 purchases a second product 128 from them.

Amazon search results could change where not only could one buy the product immediately, but Amazon could also let the buyer know that their friend John has these shoes if the first buyer 101 wants to go see them. The first buyer 101 could message John right from the checkout page and go see the product before buying. Then, the second buyer 122 could just buy the shoes direction from the object 106 configured on the product of the first buyer 101. There could be a coordination between the fact that the second buyer 122 searched on Amazon or any merchant and that the second buyer 122 bought the product from their friend who was the first buyer 101. For example, a discount code could be entered and the second buyer 122 could indicate via interacting with a visual object 106 that they are going to buy from the object 106 configured on John's shoes. The discount could then apply without needing to do any other interaction. There could be a tie in with the fact that the second buyer 122 started their search online or in an application and were then directed to the friend (the first buyer 101) with the product so that the second buyer 122 can see the product and then easily buy a second product 128.

In some aspects, the principles disclosed herein can apply to clothes. People may see a shirt, dress, pants or shows on a friend and desire to have the same clothing. To enable a second buyer 122 to buy the same item of clothing from a first buyer 101, the clothing can have an NFC tag sewn into a sleeve, or a pocket, or on a hip of some pants or the knee. A small cavity can be created in the clothing where the NFC tag can be inserted. A logo can be sewn over the cavity to inform the second buyer 122 where to use their phone to scan for the data from the NFC tag. Of course, a visual object 106 can be used as well. In some cases, the first buyer 101 could order the clothing online and choose the location of the object 106. They may desire different locations and when the clothing is made, the object 106 can be placed where they choose.

When buying online, the first buyer 101 can be associated with the object 106 and that data can be stored in the database 118 in order for a second buyer 122 to scan the object 106 and choose their size, color or other characteristics and purchase the clothing.

At a point-of-sale 108, when the clerk or user scans a UPC symbol 104 for the first product 102, the purchase process can adjust. For example, when using Apple Pay, the clerk brings the purchasing process to a state where a point-of-sale device 112 to be ready to receive payment from a mobile phone. The first buyer 101 then brings the first buyer device 114 to the point-of-sale device 112 to pass the payment token to the system. Here, the clerk could bring the purchasing process to a state where the NFC tag on the clothing is scanned or brought close to the point-of-sale device 112 to receive the code or data on the NFC tag which can then be connected to the first buyer 101 in the database 118. A point-of-sale scanner 110 can be used where the object 106 is visual. Thus, the existing devices at many points of sale 108 locations can be reprogrammed to make the connection between the first buyer 101 and the first product 102.

FIG. 8C illustrates a method 830 of selling a product. The method 830 can include receiving a scan of a first product 102 to be purchased by a first buyer 101 (832), setting, based on the scan, a point-of-sale device 112 to interact with an object 106 associated with the first product 102 (834), receiving data from the object 106 at the point-of-sale device 112 (836), receiving an identification of the first buyer 101 as part of a sale of the first product 102 (838) and storing an association of the first buyer 101 and the first product 102 (840). The object 106 can be an NFC tag or a visual code like a QR code 507. The method of FIG. 8C can work for clothing but also is not limited to the first product 102 being clothing.

The method can further include receiving a second scan of the object 106 by a second buyer device 120 (842), processing, based on the second scan, a purchase of a second product 128 by the second buyer 122 (844) and providing a benefit, based on the purchase of the second product 128, to the first buyer 101 (846).

Receiving the identification of the first buyer 101 can occur through a modification of existing payment processes like Apple Pay or Google Pay in which when payment is provided at the point-of-sale or online, data about the person and/or their payment account (if they are registered with the purchasing service 117) can be obtained and associated with the object. The approach turns every first buyer 101 into a salesperson or evangelist for the product.

In some aspects, an article of clothing can be claimed. The article of clothing can be made with an object 106 configured thereon that represents or stores a unique number or code for that particular article of clothing such that in connection with a sale of the article of clothing, the unique number or code is associated with the first buyer 101 of the article of clothing. The association is stored in a database 118 such that as the first buyer 101 is wearing or showing the article of clothing to a friend or other person, the other person can become a second buyer 122 by scanning the object 106 to obtain the data contained within the object 106 which can cause the second buyer 122 to land on a checkout page of a merchant server 126 and tailor the article of clothing to their own needs (size, color, shape, other accessories, etc.) and purchase a second article of clothing. The first buyer 101 then receives a benefit when the second buyer 122 buys the second article of clothing. The object 106 can be an NFC tag configured in a compartment on a sleeve of a shirt or sweatshirt or suit, or a compartment n a belt or dress. The location of the object 106 can also be selected by the first buyer 101. When the second buyer 122 also buys an article of clothing, they can choose the location of the object for their clothing. The object 106 of the second buyer 122 that is configured on the second clothing will also identify the family history in the database 118. A third buyer, in other words, that buys a third article of clothing from the object 106 on the second article of clothing, might trigger a benefit not only to the second buyer 122 but also to the first buyer 101 depending on what the structure is arranged by the merchant.

Some merchants may want to leverage a family tree of purchases to provided multi-level benefits or multi-level social media interactions based on tracking the family history of the purchases.

FIG. 8D illustrates another method 850 according to an aspect of this disclosure. An apparatus can be configured to perform the method 850. The apparatus can be configured to identify a first product being purchased by a first buyer (852); store an association of the first product and the first buyer in a database (854); receive an identification of the first product from a second buyer device (856); process a purchase of a second product by a second buyer based on the identification (858); and provide a benefit to the first buyer based on the purchase of the second product (860). The association of the first product and the first buyer can be performed via use of a graphical object associated with the first product.

In some aspects, the graphical object is transmitted to a first buyer device for storage and later scanning. The method 850 can further include the apparatus being configured to record on a blockchain network data confirming the association of the first product and the first buyer.

In some aspects, the method 850 can further include the apparatus being configured to print, at a point-of-sale, a physical object showing a graphical object that associates the first buyer and the first product. In some aspects, the identification of the first product from the second buyer device occurs via the second buyer device scanning a graphical object on the first product by a camera on the second buyer device.

In some aspects, the method 850 can further include the apparatus being configured to access a purchasing service based on the second buyer has scanning the graphical object onto the second buyer device, wherein a purchasing service retrieves the association of the first product, the first buyer and the graphical object in the database to identify the second product and to identify the first buyer to provide the benefit to the first buyer.

In some aspects, the identification of the first product from the second buyer device occurs via one or more of receiving a scan of the graphical object physically from the first product, receiving a scan of the graphical object from a display of a first buyer device, receiving a communication at the second buyer device from the first buyer device, or receiving a scan of the graphical object from a social media posting of the first buyer.

In some aspects, wherein the communication comprises a message, a voicemail or email.

In some aspects, a system or apparatus is disclosed the system can include a processor; and a computer-readable memory storing instructions which, when executed by the processor, cause the processor to be configured to: identify a first product being purchased by a first buyer; store an association of the first product and the first buyer in a database; receive an identification of the first product from a second buyer device; process a purchase of a second product by a second buyer based on the identification; and provide a benefit to the first buyer based on the purchase of the second product.

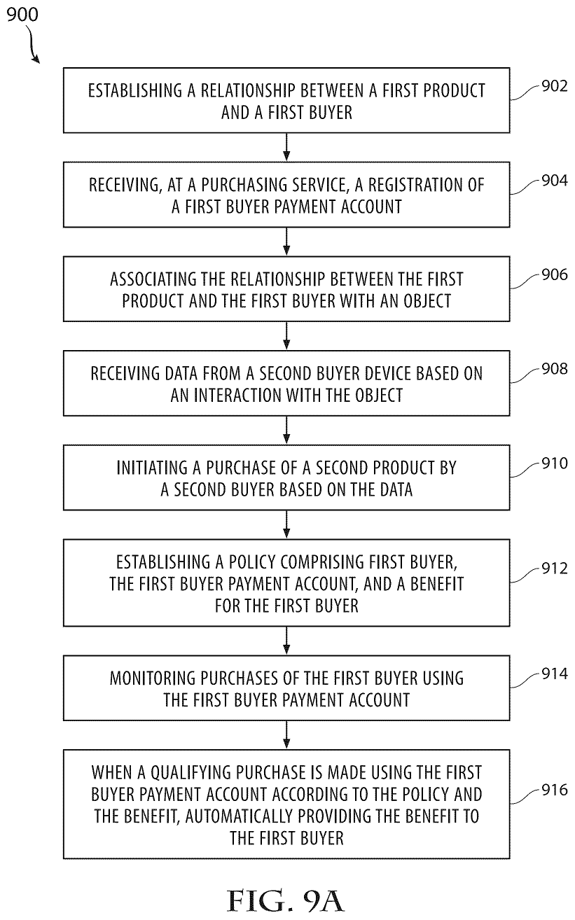

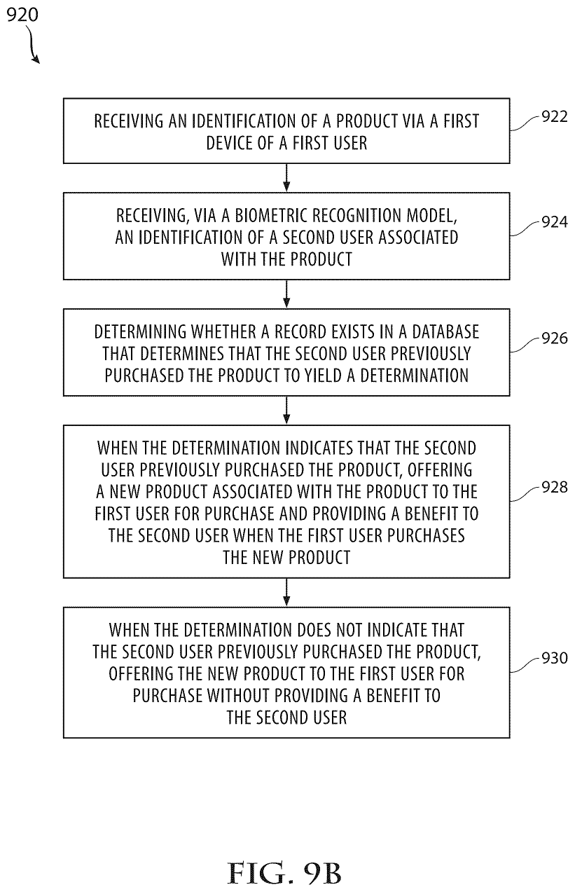

FIG. 9A illustrates a method according to an aspect of this disclosure. The method 900 can include one or more of the following steps in any order: establishing a relationship between a first product and a first buyer (902), receiving, at a purchasing service, a registration of a first buyer payment account 121 (904), associating the relationship between the first product and the first buyer with an object (906), receiving data from a second buyer device based on an interaction with the object (908), initiating a purchase of a second product 128 by a second buyer 122 based on the data (910), establishing a policy 134 comprising first buyer, the first buyer payment account 121, and a benefit for the first buyer 101 (912), monitoring purchases of the first buyer using the first buyer payment account 121 (914), and, when a qualifying purchase is made using the first buyer payment account 121 according to the policy 134 and the benefit, automatically providing the benefit to the first buyer 101 (916).

In one example, the policy 134 might indicate that when the first buyer 101 makes another purchase at the merchant from which they bought the first product 102, the first buyer 101 gets a discount 506 or some other benefit. The approach disclosed herein combines the ability of the second buyer 122 to easily buy a second product 128 from the merchant based on an interaction with the object 106 and to establish automatically the policy 134 and the monitoring of the purchases of the first buyer 101 using the first buyer payment account 121 for a qualifying purchase (i.e., such as a purchase from the same merchant) to then automatically pay a rebate, or cause a price reduction for the second transaction at the merchant by the first buyer 101, or any other benefit.

The monitoring can occur with an association or connection to credit card and debit card companies or other companies that manage payments. The policy 134 can be used to monitor the purchases using the first buyer payment account 121 such that the right purchase at the right merchant can trigger the automatic implementation of the benefit however it is designed. In one example, the benefit might be for a specific product that is purchased at the merchant or another merchant. When that product is purchased, then the benefit is granted (such as a discount or a feature being activated on the product, etc.). The purchasing service 117 or other service can continuously monitor the purchasing activity so as not to miss a qualifying purchase according to the policy 134.

FIG. 9B illustrates another aspect of the idea. Here, the focus is on facial recognition of the first buyer as mentioned above. The present disclosure relates to an improved method of providing a benefit to a person who bought a product when a friend also buys the same product for themself.

There is a challenge in selling products where one can use an artificial intelligence model to analyze an image and can identify a product in that image. Current technology, such as through Amazon, enables a person to purchase that product through Amazon.com as the person can be brought to a one-click purchasing state. There are some unexplored advantages that could be obtained in this process.

The present disclosure addresses weaknesses or unexplored benefits when a user purchases a product that is identified outside of the merchant store and “in the wild.” The unexplored benefit is how can a system be configured to grant a benefit to the first buyer of the product? For example, Joe buys a pair of shoes at the store and wears them to school. Amy sees the shoes and likes them and wants a pair for herself. She can scan the shoes (take a picture with her phone) and an AI model can analyze the image and identify the pair of shoes. This process is problematic. There is no mechanism to tie that purchase to Joe as the context or means by which she makes the purchase. Amy can then interact with a user interface to make some decisions regarding the shoes such as size, color, etc. and can proceed to purchase the shoes and have them delivered to her home.

What is missing is the ability of Joe to get any benefit for being the one to prompt Amy to want to buy the shoes. He is the catalyst for that purchase but gets no benefit. This is a problem rooted in computer technology in that the current payment infrastructure (i.e., credit card payments, Apple Pay, Google Pay, Samsung Pay, Paypal, etc.), payment systems do not provide any mechanism to enable Joe to get a benefit.

However, the present disclosure accomplishes a simplified mechanism and infrastructure to enable Joe to get some kind of benefit. The benefit might be a discount at the merchant or a discount from a manufacturer of the shoes. It may be a coupon or credits, points, miles, or any other benefit. What happens is that when Joe purchases the pair of shoes, in some mechanism, a database record is established which identifies that Joe has purchased the pair of shoes. The data in the database may be general as to the kind of shoes, the color, the size, or any characteristics of the pair of shoes. Joe's identity may come through an application, or may come from a special API that provides Joe's identity in connection with the purchase to a server (with the merchant or third party) based on an electronic payment such as Apple Pay, Google Pay, credit card payment, and so forth. In general, at the time of sale, Joe is associated with that pair of shoes in a database.

With that database set up, as Joe walks around with the shoes, as noted above, Amy can take a picture of the shoes and the AI model can identify the shoes. But that alone does not connect those shoes with Joe. After Amy identifies the shoes, she can also take a picture of Joe's face or can scan his face with her phone or his phone. An AI model can analyze that picture and through that image, can identify Joe. Now the system has both an identification of the shoes and an identification of Joe. An API call or a query can be provided to the server operating the database of people who purchased the products. When a confirmation occurs that Joe had purchased that set of shoes or a similar set of shoes, then the system can not only process the sale of a pair of shoes to Amy but can also provide a discount or benefit to Joe as well to pay him for sharing the shoes. This approach simplifies the process where the point-of-sale connection between Joe and the pair of shoes is more automatic and does not require a separate code or unique individual image for each product.

The approach, for example, could work with a company like Amazon where they have records of all the purchases of its users. Thus, if Amy is using an Amazon application or website, scans or identifies the shoes and then through an image of Joe, identifies Joe, then Amazon can present a graphical user interface in a “one click purchasing scenario” where it states that Amy can purchase the shoes (in her size) and can confirm that she is buying them based on Joe and that Joe will receive a 10% discount on his next Amazon purchase, or a 10% discount on his next pair of shoes from the merchant that sold the first pair of shoes.

Where merchants are not all under the same umbrella company like Amazon, a service organization could store product purchase data for users from various merchants and an application could be used to query that database and manage the process across disparate and unrelated merchants. An API could be set up for each merchant to use to provide data to the database and to receive information regarding discounts to offer to specific users. For example, an application could capture (Via an AI model) an identification of a pair of shoes on a person and then identify the person who is wearing the shoes. An API call to a service at Amazon.com or another service could be made by the application to determine if that person owns or previously purchased those shoes. If yes, the API could return a confirmation that yes the person did buy the shoes. Then, if the Amy also buys a pair of those shoes, then a benefit can be presented to Joe because the transaction arose based on a connection with Joe to the shoes. The solution is rooted in computer technology and is grounded in a weakness in current sales systems where any known connection between a user and the products they purchase is not leveraged for additional value. The current electrical systems that process payments do not provide this kind of service to enable the first buyer to get a benefit when a second buyer buys the same (or similar or related) product.

Amy could also identify the product from a UPC symbol or any graphical object such as a QR (quick read) code that can be used to identify the product. However, to simplify the process, identifying Joe is preferably done via a facial scan (or other biometric or password or passcode procedure of identification) but could also be done through a user interaction in which Amy, for example, could scan the shoes and then input into a data input field or in any unimodal or multimodal interface information to identify Joe. Autocomplete or suggestions for Amy could be provided (i.e., to narrow down searches for her) based on her social media village (her social media friends), the identification of the shoes (which could be dynamically compared to a database of her friends for which friends bought those kinds of shoes). In this manner, the system can easily get a confirmation of Joe as the first buyer of the shoes so that can get the discount.

In another aspect, a user could scan for a product through AI or a UPC symbol or even simply searching for jeans or the product on a service like Amazon. Then, the user Amy could pull up via an application or App Clip or other means the name of their friend Joe who bought the jeans and a confirmation email or text could be sent to Joe to confirm that they purchased the product before and are the connection to this current purchase by Amy. Thus, the connection could be made dynamically. AI in this case could be used to confirm that an image was taken with Joe's face and with the product as well. Thus, if a confirmation could exist that the two items (Joe and the product) are in the same image, then a separate database of purchasers and products may not need to be created. Fraud could be an issue in this case and so other fraud-detection approaches could be added such as a confirmation that Joe made a purchase at a store that sells the type of product in the picture.

As noted in the referenced patent application incorporated above, the benefit can be redeemed through a process run by a company called “Giftya” (see giftya.com) and those processes of setting up a policy connected to Joe's existing payment account (i.e., Visa, Mastercard, Debit, etc.). The policy can identify the benefit (10% discount, $5 off a pair of Shoes, etc.) and/or the merchant (Target) or a manufacturer (i.e., Nike) and when Joe uses his existing payment account to make a purchase according to the policy, a monitoring service or monitoring engine can capture that qualifying purchase and cause the benefit (i.e., a payment credit) to be applied to that purchase or provided to his payment account and so forth.

Therefore, the system that implements these principles can coordinate with existing payment rails and/or benefit structures to provide a payment credit or benefit to Joe for sharing his shoes with Amy. The approach can cause individuals like Joe to be more likely to share products they like with their friends.

In some cases, a buyer (Joe) might authorize the use of his purchasing history for the limited use or accessibility by the merchant, or a service, such that queries can be made against a merchant database of purchases by individual people. Then, a service entity can enable users to access via a browser, an App Clip, or a downloaded application the camera to take images of products and people and to combine that two pieces of information, facial data and/or product data and either use an internal database or an external third party database to query product/purchaser records to see if a benefit should be provided to Joe (the first buyer) when Amy (the second buyer) buys a product based on a personal interaction with the first buyer. No entity or network infrastructure currently exists that enables this functionality and possible capability.

In some aspects, an application or app clip or website accessed via a browser can manage the user interactions to take one image using the camera of a mobile device. Data from the image can include one or more of facial data, any biometric data such as a fingerprint, product data, or a combination of both. A user may confirm that the proper product is highlighted and/or the right face has been recognized. The application may use data or an AI model on the mobile phone or on a remote server to identify a product and/or a person. The application may guide the user to take two pictures—one of the product (such as pair of shoes or a lamp) and then a photo of the user or the owner of the product. The application can again either use an AI model to identify the product and/or the person or may send the image to a remote AI model that is more powerful to identify the product and the user from one or more pictures.

‘The application, once the product and the person are identified, can enable the person taking the picture to purchase their own product (their own pair of shoes or lamp, etc.). The user interface can have graphical information identifying the first buyer as getting a benefit for being the means or the catalyst for the second buyer to buy the product. The second buyer can purchase their own copy or version of the product (which might include them also choosing a proper size, color, shape, or other related parameters associated with what they want to buy that is related to the product) and confirm that a benefit should be provided to the first buyer.

The process may also include the first buyer on their mobile phone getting a notification of the benefit or a confirmation that they did in fact purchase the product (or were given the product as a gift in some cases and thus are associated with the product) and that they are the proper person to receive a benefit.

Embodiments of this invention can be claimed from the standpoint of an application on a mobile device, a remote or network-based server, an AI model configured on any device or a combination of devices that perform different operations such as presenting a graphical user interface and managing the user input and data input (i.e., from the camera of a mobile device) and another device operating a powerful AI model that can be used to identify products and/or people from one or more images.

In another aspect, Amy may scan or take an image of the shoes and have them identified for her to make the purchase. As her identity would be known because she is scanning from her phone, a database can be accessed which includes data about her social media circles, friends, family, etc. That database may determine which of her friends (which can include Joe) has purchased these shoes and ask her to simply confirm that she is with Joe. Joe's phone location can also be used to determine proximity. An application or service can infer based on one or more of the database, Joe's phone location as a friend of hers, and/or other data, that she is with Joe and that the shoes she is looking at are Joe's shoes. In that case, she may simply look at her checkout flow on her phone and with that data accessed, the checkout flow may include a box to check that asks-did you buy these because of Joe? The connection is inferred but then confirmed through a simple checkout flow with Amy. In this simplified process, Joe only needs to buy the shoes from a company that can connect him directly with those shoes and include that connection in a database that can be accessed directly, or included to a service that identifies people's social media circles (like Facebook) so that when the identification from Amy occurs of the product, one or more databases can be accessed to identify to a certain level of probability who Amy is with and who had purchased the product previously. Then, the new purchase by Amy can proceed with a benefit being provided to Joe as the mechanism by which Amy made the purchase herself.

In FIG. 9B, a method 920 can be performed by a server, computing device, mobile device, point-of-sale device, or any combination of these components and/or any computing component disclosed herein. The method 920 can include receiving an identification of a product via a first device of a first user (922). Receiving an identification of the product can occur from a scan via the first device of a visual object attached to or associated with the product or an artificial intelligence model analyzing an image of the product.

Method 920 can further include receiving, via a biometric recognition model, an identification of a second user associated with the product (924). The biometric recognition model can include one of a facial recognition model and a fingerprint recognition model. Other models such as eye recognition can be used as well.

Method 920 can further include determining whether a record exists in a database that determines that the second user previously purchased the product to yield a determination (926). The database stores data identifying that the second user purchased the product at a time the second user purchased the product. In some aspects, the database stores data identifying that the second user purchased the product by, when the product is purchased by the second user, a scan of a visual object on the product and an identification of the second user is stored in the database. In some cases, the visual object can include one of a QR code or a UPC code.

Method 920 can further include, when the determination indicates that the second user previously purchased the product, then: offering a new product associated with the product to the first user for purchase and providing a benefit to the second user when the first user purchases the new product (928). In some aspects, the benefit to the second user can include a credit redeemable by the second user by using an existing, open-loop, payment card of the second user at a merchant that sold the product to the second user. In other aspects, the benefit to the second user is redeemable via an establishment of a policy associated with an existing, open-loop payment card of the second user, wherein the policy defines one or more of an amount of a redemption credit, a manufacturer, a type of product, a merchant, a time frame, and product information and that defines how the second user redeems the redemption credit by making a purchase using their existing, open-loop payment card in connection with making a second purchase after making a first purchase of the product. The redemption credit can be offered by one or more of a manufacturer of the product or a retail merchant who sells the product.

Method 920 can further include, when the determination does not indicate that the second user previously purchased the product, then: offering the new product to the first user for purchase without providing a benefit to the second user (930).

The method 920 can further include transmitting an electronic notice of a device of the second user notifying the second user of the benefit and how to redeem the benefit.

A system can include at least one processor; and a computer-readable storage device storing instructions which, when executed by the at least one processor, cause the system to be configured to: receive an identification of a product via a first device of a first user; receive, via a biometric recognition model, an identification of a second user associated with the product; determine whether a record exists in a database that determines that the second user previously purchased the product to yield a determination. The system, when the determination indicates that the second user previously purchased the product, can then: offer a new product associated with the product to the first user for purchase; provide a benefit to the second user when the first user purchases the new product. When the determination does not indicate that the second user previously purchased the product, then the system can offer the new product to the first user for purchase without providing a benefit to the second user.

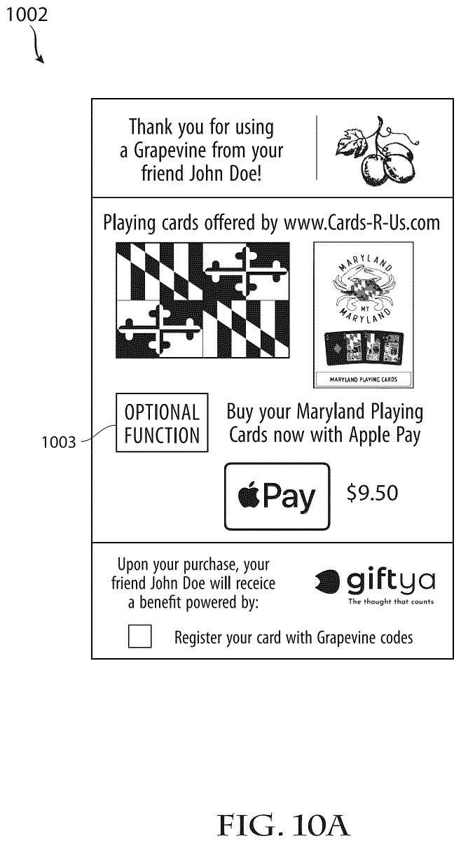

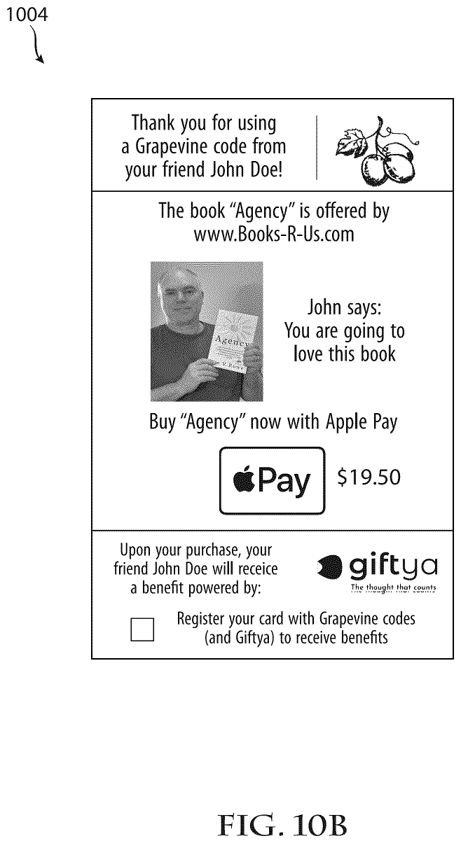

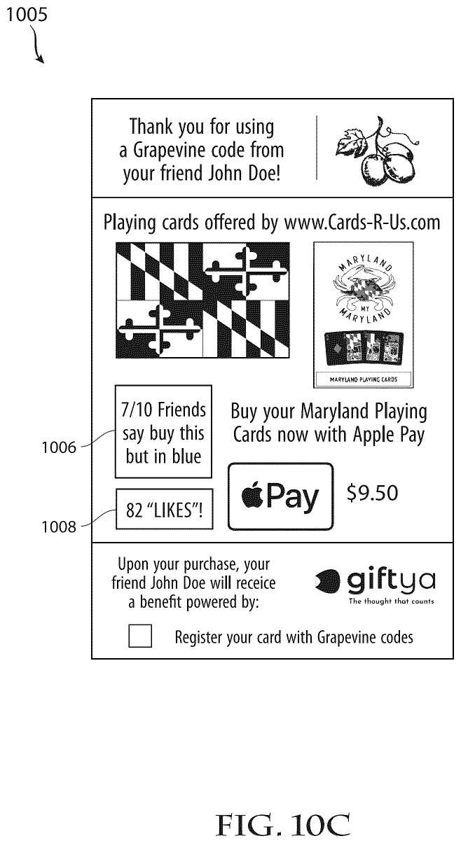

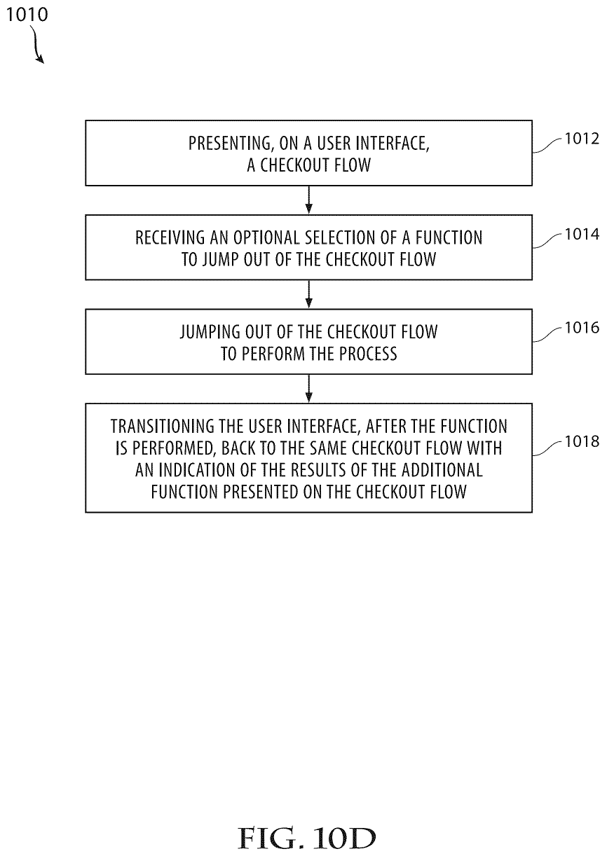

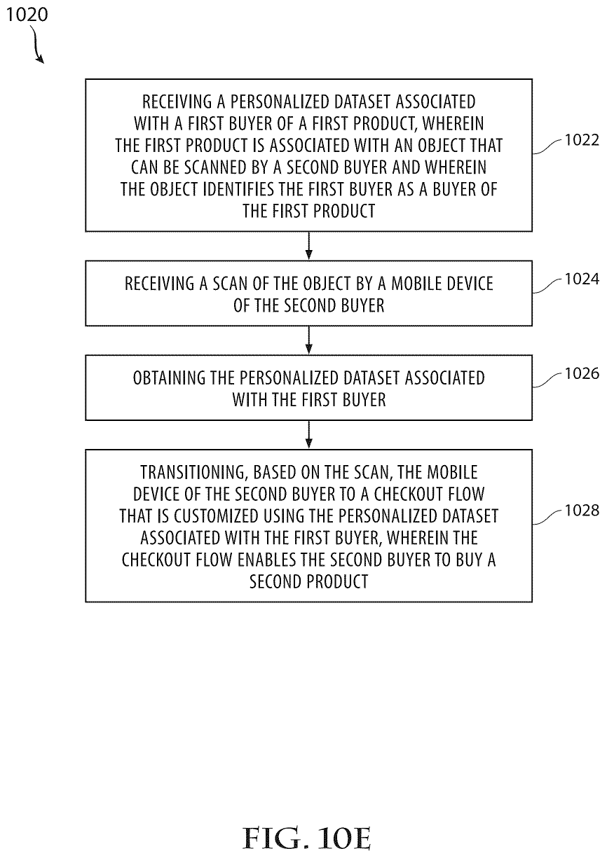

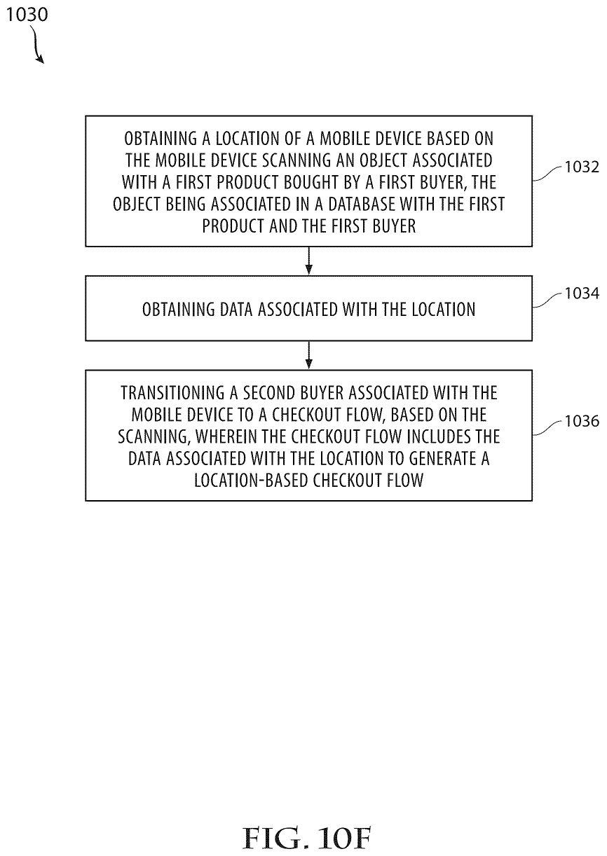

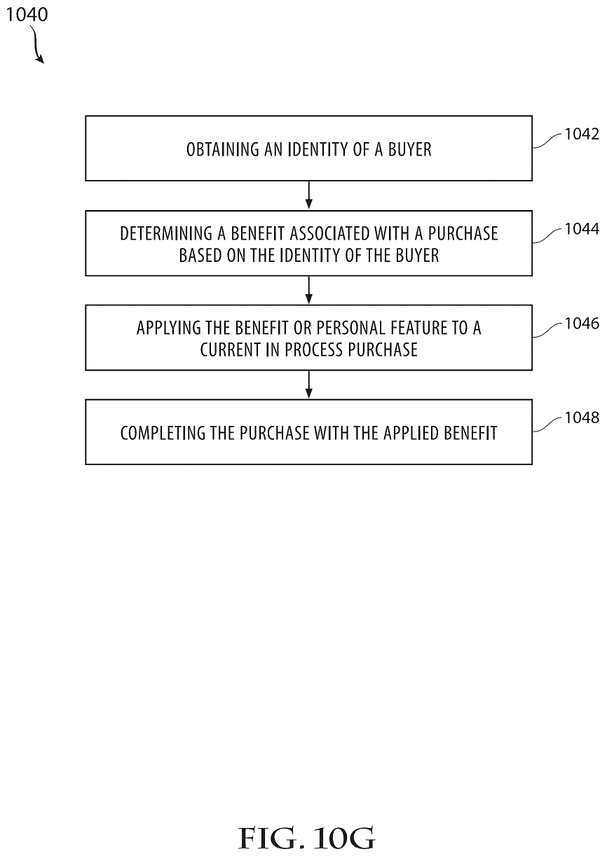

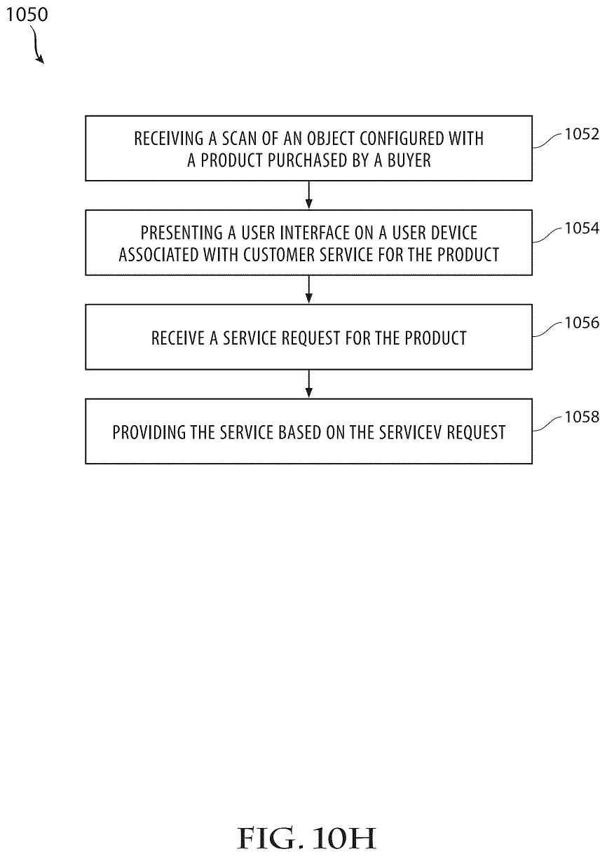

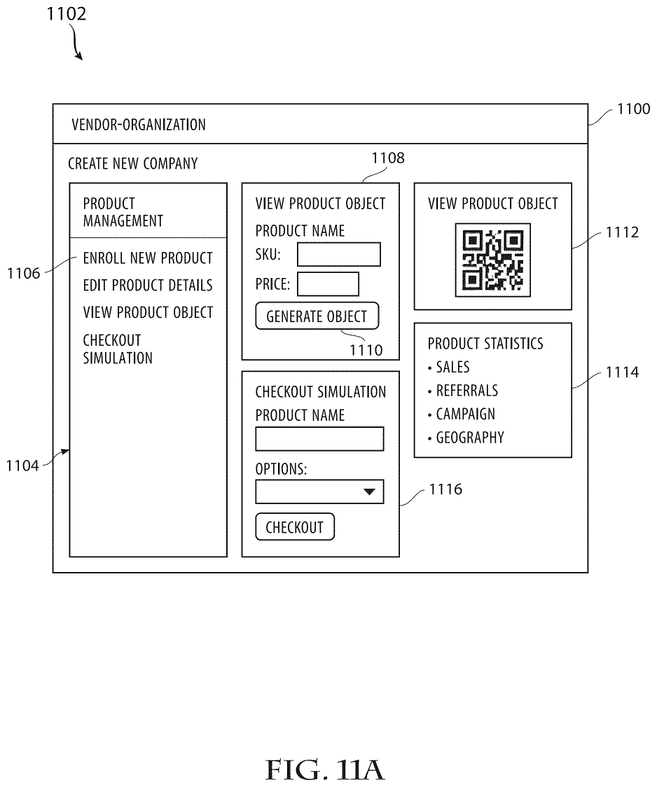

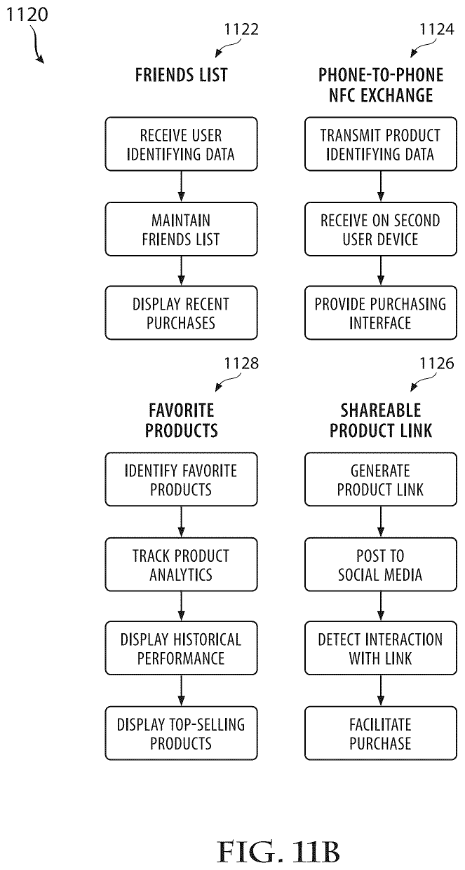

FIG. 10A shows a checkout flow or checkout page 1002 which is generated according to a certain process. As disclosed in the incorporated application, a first buyer buys a product that is associated with or physically includes an object like a QR (quick reference) code or a near-field communication (NFC) chip or tag. The data in the object is connected to or associated with the first buyer buying the first product. Assume the first product is a deck of cards featuring the state flag of Maryland. The first buyer is John Doe. At a point-of-sale or from a purchase online, the QR code (which can be unique for the specific first product or deck of cards) is scanned or identified and associated with John Doe as the first buyer. On the deck of cards is a QR code that, when later scanned by a friend John Doe using a mobile device like an iPhone, causes John Doe to be transitioned into a checkout page from the merchant who sold John Doe the first product. The checkout page can be customized. Note that the name John Doe is integrated into the checkout page 102 that is shown on the mobile device of John Doe.

The object on the deck of cards that is scanned can access a program flow on a network server that not only directs the user directly into a checkout flow, but can configure a personalized checkout flow for the second buyer of a second product (a second deck of Maryland cards). For example, the object can send the mobile device to a network server operating a service that provides the functionality disclosed herein. The network server can access data about John Doe, data about the product, obtain a universal resource locater (URL) provided by the merchant, construct or insert data such as the name John Doe, or provide data values to the merchant, and then redirect the flow to the merchant checkout flow as shown in FIG. 1A with a configured checkout that features the product, the name of John Doe as the known friend from whom John Doe is purchasing the product, an ability to pay using payment mechanisms like Apple Pay or any other mechanism, as well as an option to register a credit or debit card with the service to be able to participate as well.

An optional function 1003 is shown as a selectable object. The optional function configured within the checkout flow enables a system to offer jump-out options for other functionality. For example, the user may desire to get some feedback from friends before buying the set of cards, or the style of shirt or the color of the coat. Here, the optional function could be to survey on social media the purchase before completing it. In this scenario, if the user desires to get some feedback before the purchase, they can interact with the optional function 1003 which can cause a posting to be made on social media configured to obtain feedback on the purchase. A posting could say, for example, should I buy this shirt, which of these two shirts should I buy, etc. The optional function 1003, can be configured based on the product. If there are different colors for the product, the optional function 1003 can cause a user interface to be presented in which the user could configure the survey on social media so that opinions of friends can be obtained and other options (different sizes, different colors, etc.) can be offered as part of the survey. The user may not know which color of shirt to buy. After configuring the posting, the user may be able to select post to all, or they may have in a user profile certain friend groups that help with clothing decisions, interior design decisions, and so forth. The posting can then go out, the user may be able to transition out of the checkout flow, and back to normal usage of their mobile device.

After their friends have provided their feedback, the user may get a notice, text or some other notification that the results of the survey are in. In one example, the user may get a text or email indicating that a sufficient number of friends have provided input. A link can be configured in the text that enables the user to transition directly back into the checkout flow.

The optional function 1003 may, when selected, include a number of optional operations which the buyer can implement. One may be an offer to buy the actual product they just scanned rather than a new product to be shipped to the buyer. In this case, the system may implement a process of seeking approval from the first buyer of a price for the product. Once a price is agreed upon, the checkout flow can be updated to reflect the price, and the fact that the second buyer is actually buying the very product in front of them. Any licensing or registration needs can be handled by the system as well for vehicle, boat, firearm, or other purchases that might require government notification of a transfer of ownership. For example, registration or license forms can be presented to the seller and/or the buyer for electronic signature and approval for proper transfer of ownership.

FIG. 10B shows a checkout flow 104 which includes a further customization of a checkout flow for a second buyer. Assume John Doe bought a first product, a book called “Agency”. After purchasing the book, and based on what type of product is purchased, there may be an opportunity to further personalize the checkout page for the second buyer who scans an object on the book Agency which is associated with the first buyer John Doe. After buying the book and returning home, John Doe may receive a message, communication, calendar invite, or some type of notice from an application or website associated with a network service that suggests that he takes a picture of himself with the book (the first product) and if desired can provide a comment like “You are going to love this book”. Receiving such personalized data can occur at the time of sale, after reading the book, after using the product, location-based with respect to a location of the first buyer or the first product (which can be identified by the first buyer scanning the object), and so forth. There are a number of ways and timing that personalized data around the first product can be obtained.

The first buyer can provide the first data to a network service that stores that data in connection with the object configured on the first product. Then, upon the second buyer scanning the object, the data can be accessed from memory or a profile associated with the first buyer and a checkout flow can be constructed which can include one or more of the personal data items. FIG. 10B shows a picture of John Doe with the book and a comment for the second buyer. The personal data could even be obtained at the time the second buyer buys the book. For example, if John is telling Dan about the book and Dan wants one for himself, John can use his mobile device to take a picture of the two of them with the book and transmit the picture to the network service. This can be done by Dan opening up an application associated with the service or texting or emailing the picture with an identification of the product. The network service could also perform an object scan of the image to identify the object of interest. For example, if Dan has ten items with objects configured on them, and one of them is the book Agency, then as the photo was received by the network service, the service can identify that the Agency book is in the image and then associate the image with that purchase. The point here is that when Dan buys the book himself, the checkout flow like as is shown in FIG. 10B can then be populated with an image of him and John and the book for an even more personalized checkout experience.

In one example, the way of connecting a personalized picture, video, sound or other object with the particular QR code on the product or on an NFC chip configured with a product can vary. For example, the first buyer may select from a wallet or application from a group of products that they have purchased and that have codes associated with the products. The products may include a book, a backpack and a lamp in the wallet or application. The user may be hiking with the backpack and want to record a picture of the user on a mountain peak with the product. The user may have an option (like a selectable object or button) to take a picture associated with the product which can transition the mobile device to an application or a functionality of opening the camera application, to enable the person to take one or more pictures, and then save or send those pictures to a network service for storage. Later, when the second buyer scans the QR code or object on the first product, the second buyer can be transitioned to a customized checkout flow with the personalized picture of the first buyer with the first product so that the second buyer is likely to convert and buy a second product based on a more comfortable and personalized checkout flow.

In another aspect related to social media input, the checkout flow could also include a selectable object which enables the user to essentially pause the checkout flow while the user gets feedback from friends on social media. The user could be presented with a user interface that allows them to post a question about the product on their social media feed: “Should I buy this shirt?”. Or, the user could select from a subgroup that they ask for input on the type of product. Users can set up groups for clothing purchases, interior decorating purchases, car purchases, etc. The system could coordinate with a social media network like Instagram or Facebook or TikTok and present the request for likes or feedback from a group of friends. The feedback can be set for a period of time by the user or a set period of time. The checkout flow can essentially be placed on “hold” until the feedback or a certain level of feedback is received. Say the threshold is 60% respond from the group. Then, with the data about “likes” or other feedback received, the user could be placed back in the checkout flow with the feedback incorporated into the flow—in which data like 70% of your group like the purchase. The posting to the group could be configured like a survey or limited to a like or dislike option, for example, and could depend or be configured based on the product. A summary or aggregation of the likes or feedback can be incorporated into the updated checkout flow. The updated checkout flow can be presented anywhere the user is interacting. For example, the system could integrate with the social media network such that when a user selects the option (the bell) on Facebook to see what kinds of new notifications or feedback has been received on their postings, one option could be a notice that the feedback on their purchase request has been received. The user could click on the object and be placed back in the checkout flow, with the feedback incorporated therein. The checkout flow would be presented to the user and then they can buy the product. They get the positive feedback (i.e., from “likes”) similar to what users experience on social media, but it is directly found within a checkout flow.

Further, if the user has a social network that responds quickly to a feedback request about a product configured or presented in the checkout flow, then the user could stay within eh checkout flow, wait perhaps a short period of time, be presented with the feedback (perhaps dynamically with hearts graphically presented or likes being added up) and then complete the purchase. Social media images or videos could be presented briefly or persistently in the checkout flow as well. A social media member may record “get this!” and that brief video, audio, text, or other input could be presented as part of the checkout flow. Thus, the user could wait for a period of time while live user feedback is presented while they are still on the checkout flow user interface. Then the user could make the purchase at any time or after the feedback is received or aggregated. The user interface could be the user interface that such social media feedback is presented in thus enabling the suer to receive that social media feedback directly in the checkout flow. The approach will make the checkout more personal than previous checkout flows.

FIG. 10C illustrates an example of a user-feedback configured checkout flow. Here, the user feedback 1006 is provided as part of the checkout flow 1005. In this example, 7/10 friends say buy this but in blue. The checkout flow can be accessed from a text, from social media (such as accessible from the bell on Facebook indicating that there is feedback available for the user), or other means.

FIG. 10D illustrates a process 1010 that involves presenting the user with a checkout flow (1012), receiving an optional selection of a function to jump out of the checkout flow (1014), jumping out of the checkout flow to perform the process (get feedback, post on social media, perform a survey, do more research on the product, etc.) (1016), and then transitioning the user interface, after the function is performed, back to the same checkout flow with an indication of the results of the additional function presented on the checkout flow (1018).

Note that this approach gives the user a more personalized checkout flow. Users can jump in and out of a checkout flow over time and it is not just a one-time configuration. The checkout flow may be presented numerous times for users and their experience with the actual checkout flow is more personalized and transitions even from device to device (such as when a user transitions from a mobile device to a desktop device, and then accesses Facebook and retrieves the updated checkout flow from the desktop device). The user feedback may just aggregate the number of like to report, for example, “82 likes!” 1008. Having the user feedback (similar to having “likes” on a social media post) makes the purchase more enjoyable for the user and confirms that they are making a good purchase, while at the same time connecting them more with their friends.

The interactions in FIGS. 10A-10D, such as being able to jump out of a checkout flow, are independent of whether the buyer is the first buyer or the second buyer. These concepts are general checkout flow concepts which may or may not be integrated in with the concepts of a second buyer purchasing a products that inures to the benefit of a first buyer.

FIG. 10E illustrates a method 1020 which can be carried out by one or more components such as a mobile device, a network service, a merchant server and so forth. The method 1020 can include one or more of (in any order), receiving a personalized dataset associated with a first buyer of a first product, wherein the first product is associated with an object that can be scanned by a second buyer and wherein the object identifies the first buyer as a buyer of the first product (1022), receiving a scan of the object by a mobile device of the second buyer (1024), obtaining the personalized dataset associated with the first buyer (1026) and transitioning, based on the scan, the mobile device of the second buyer to a checkout flow that is customized using the personalized dataset associated with the first buyer, wherein the checkout flow enables the second buyer to buy a second product (1028).

The object can include a quick response code or an NFC tag. The personalized dataset can include one or more of an image, a video, a logo, a word or phrase or a sound.

FIG. 10F illustrates another personalization example process 1030. The process 1030 can include one or more step, in any order, of obtaining a location of a mobile device based on the mobile device scanning an object associated with a first product bought by a first buyer, the object being associated in a database with the first product and the first buyer (1032) and obtaining data associated with the location (1034). For example, if the mobile device is used to scan an object on the first product and the mobile device is in the mountains, then a mountain picture can be obtained which may or may not include the first product in the picture. The process 1030 can further include transitioning a second buyer associated with the mobile device to a checkout flow, based on the scanning, wherein the checkout flow includes the data associated with the location to generate a location-based checkout flow (1036). The second buyer can then buy a second product (like another lamp or book or backpack) from the location-based checkout flow. The personalization of the checkout flow can make the experience more personal for the user and thus can lead to more conversions.

The data associated with the location can include other data such as weather conditions. For example, if it is snowing at the location, then a picture of mountains during a snowstorm might be chosen.

Artificial intelligence could also be used with one or more of the location and other input data such as data about the product to generate an artificial intelligence image or overall checkout flow as well. The first buyer or the second buyer might have some input regarding how an artificial intelligence image or video or sound generator might generate a checkout flow for the second buyer. For example, the theme might be a cartoon, or mountains, or speed, or product-based. Then, dynamically, the network system can generate images, video, sound and/or any other characteristic or aspect of the checkout flow by obtaining a stored image, the result of a social media survey or a survey in general, presenting text, creating a collage of images, or generating via AI an AI-generated image or other data to make the checkout experience more in line with the user's desires or which might make the checkout more enjoyable. Color schemes, patterns schemes, fonts, payment types (Apple Pay, Google Pay, etc.) can all be characteristics of the checkout flow that can be dynamically adjusted for an individual user.

The checkout flow can follow the user and be jumped into and out of based on the user's desire. If the user wants to do some research, they can jump out of the checkout flow and research the product via a selection 106. The user may want some feedback or may want to read some product reviews which can be accessible as a function by selection object 103 shown in FIG. 10A.

Using these concepts, the following could occur. A famous Internet influencer may desire to purchase a product and want their 100K followers to “like” if they should buy the product. The influencer could also then buy the product, have an object associated with the product as disclosed herein and in the related application. Then, the influencer could offer one of their (paid) premium followers to be able to buy the product using the object to connect that purchase of the second buyer follower to the first buyer influencer. This would connect the second buyer to the first buyer in a “family tree” of purchases that flow from the influencer purchase. The process creates a whole new marketplace concept where it is not just products that are being purchased, but products that are connected to a particular first buyer through the objects disclosed herein and which enhances or changes the value of each individual product depending on where it is in the family tree. The system that manages the functions disclosed herein can tell the story of each product and how it was purchased based on a human connection with the product or a similar product. Often, such as in historically significant products or events, this information greatly enhances the value of the product because it was connected to a famous person. The approach disclosed herein can cause such change in value and interest in a particular product based on the system tracking the connections between humans as products are sold.

Security and privacy can be an issue with respect to the disclosed concepts. For example, if a person loses a book or a shirt that has a scannable object, an unknown person may scan the object and obtain the name of the first buyer if the first buyer is immediately presented in a checkout flow as shown in the figures. Thus, in some cases, the first buyer might be able to control access to their information. For example, when the second buyer scans the object, an authorization could be provided to the first device of the first buyer identifying generally that a second buyer wants to buy the second product or it might identify the identity of the second buy as well. Then, the first buyer can authorize the second purchase of the second product which can include authorization of identifying the first buyer in a checkout flow to which the second buyer can then be transitioned to.

In some cases, the first buyer may get a batch of potential purchases from a group of second buyers of one or more second products and can authorize a batch for processing. In this case, a second buyer may scan the product and not immediately be transitioned to a checkout flow but might be notified that “first buyer authorization” is in process and that when they are authorized, they will be presented with the chance to buy.

In yet another aspect, a contract to provide services from a network service provider might be at a product (manufacturing) level or at a merchant level. If it is as a merchant level, then the structure might be that the second buyer is transitioned to the same merchant. In some cases, comparative pricing might be provided to help the second buyer know that they are getting a good deal. (The cost of acquisition would be low in this case, which savings could be provided to the second buyer). In another case, a contract can be established with a manufacturer of a product which means that when the second buyer scans the object, the transition can be to a number of different merchants that offer the product. In this case, the second buyer could be presented (like they are upon an Amazon.com search) with a number of different ways (i.e., different merchants or other different ways) to buy the product. The second buyer can then choose based on price or availability or any other factor. The benefit to the first buyer can then be provided either for the merchant that was chosen to sell the second product or through some other agreement with the manufacturer to enable the first buyer to get a benefit.

For example, the first buyer buys the first product at the first merchant. The network service has an agreement with the first product manufacturer to provide the services disclosed herein. The second buyer determines to buy the second product, based on the scan of the object on the first product, from a second merchant. How does the first buyer get a benefit? One way is that the manufacturer may have many different products and if the first buyer buys one of the manufacturer's products at any merchant, a discount or rebate can be provided. The manufacturer can provide a coupon or encourage the first buyer to go to a particular merchant and make a purchase to obtain the benefit. Or a cash or credit account could be established for the first buyer that the manufacturer could provide money directly to.

In some aspects, the first buyer benefit can be an aggregation of multiple benefits. If the benefit for the first buyer is a $5 discount on their next purchase, the first buyer may have 10 friends that bought the same shirt as a second product off a scan of a NFC chip on the first shirt. The benefit can represent a dynamically changing “policy” (as that term is used in the Giftya patents) as the first buyer shares their product with friends. The benefit for example, might aggregate to $50 after the first buyer shares the item 10 times and earns $5 for each purchase of the product by second buyers. Then, when the first buyer goes to the merchant or to any merchant but buys the same product from the manufacturer (depending on how it is set up), then the first buyer may get a $50 discount for the next purchase.

The benefits may also vary in type and can be aggregated by type. For example, after multiple shares of the product with friends that result in purchases, the first buyer may have a total of a 8% discount on a purchase and a rebate of $10, each type of benefit being an aggregation of discount points and/or rebate value from second buyers.

Furthermore, as has been noted above, the benefit structure for the first buyer can be shared with others registered with the service. For example, the first buyer may share a $30 discount or price reduction at a restaurant with a friend through the use of an application user interface in which the first buyer can choose from their benefit(s) and transfer them to another person. They can be received and redeemed via the Giftya—type method in which a policy is established with the friend's credit card such that they simply use their credit card at the proper merchant or to buy the particular product and they get the benefit/discount/rebate, etc.

In some aspects, the first buyer may be able to control how their information is presented in checkout flows from a second buyer or can coordinate second buyers to be authorized second buyers based on the second buyer being part of a contacts list or a friend in social media. This can prevent unknown second buyers from scanning a code or object and buying the product from a person they do not know. The first buyer could also choose a setting in a user profile that does not identify them in the checkout flow or that may request a confirmation via text or email before enabling the second buyer to buy the product and to authorize via any technique the use of their name, likeness, or any other personal information in the checkout flow of the second buyer. Thus, if the first buyer and the second buyer are for example at a park talking about the high tech stroller that the first buyer bought, the second buyer could scan the object with the second buyer device, the first buyer could get a text/notification with a request to simply authorize the sharing of the first buyer information and thus in real time the second buyer can receive a personalized checkout flow that features the first buyer's picture for example.

Furthermore, these settings could also be set by the merchant or the manufacturer of the product. For example, the merchant/manufacturer could control how the checkout flow works such that the first buyer is not identified in the process but just secretly gets the benefit.

It could be a setting in your system where anyone who scans the object gets your information or there can be a privacy setting where only people in your contacts list can get your data. A notice can be provided before a second buyer is able to make a purchase. When a second buyer scans an object, they may get a generic interface to purchase a product with no identification of the first buyer. In some cases, a notification could be sent to the first buyer to authorize the identification to the second buyer and upon authorization, the second buyer can get at the time or later an identification of the first buyer. In other words, the second buyer may quickly buy the product, without knowing who the first buyer is and then later get a notice or thank you from the first buyer when the first buyer authorizes themselves to be identified.

If the first buyer devices and the second buyer devices are close to each other, then the system may consider that the two people are next to each other and know each other and thus may just identify the first buyer to the second buyer. Other information such as audio data received from one or more device may identify that the people are talking each other. The system can use such information to manage the second buyer experience and the exposure of the first buyer information to the second buyer. Again, this can be tailored by settings in a user profile for the first buyer.

In another aspect, the experience of the first buyer can be modified in one or more ways based on their being registered with a service and/or based on their experience with sharing products. For example, if John is registered and has had ten friends buy products from the product that he bought, then he can be identified at the point-of-sale (any number of ways, such as through Apple Pay or providing an email or phone number) and he might be able to get a discount for being registered, for a second buyer making a purchase, for how many times friends have bought products from him, and so forth. The point-of-sale (or online) experience can be tailored to the particular user. The clerk at the POS may be given a script to read saying “welcome John! We are giving you a 10% discount for your great work in helping to share our products.” The analysis can be based on products (independent of a merchant), or may be merchant based or based in general on their experience with the service independent of the merchant or the products. At the sale, the system may identify the user and then implement a personalized experience including one or more of, pricing on one or more products, benefits, refunds, checkout flow experience, images, videos, sounds, etc. For example, this process can give a user at a physical point-of-sale a special different experience that might make them want to come back. As each person will be a “salesman” for the products at different rates and intensity, the approach disclosed herein enables encouragement to buyers to share the products because they get rewarded at the point-of-sale for their efforts. The interest can be similar to the experience on social media which people seek to repeat. Having a positive personalized experience at a point-of-sale, which becomes possible using the concepts disclosed herein, can enhance the desire of a buyer to buy again and to use the objects disclosed herein to share products. The entire process of buying products and sharing products with friends can be enhanced and encouraged.

The live polling process could be used at a point-of-sale or previous. For example, while a user is shopping, they may take pictures of a few products and send the comparison off to their live polling or social media network for feedback. Then, the results may be provided at the point-of-sale to encourage them to buy one or the other.

In another aspect, the payment process can be adjusted from what it currently is to accommodate the features or capabilities of this new system. There are technical issues with the current way it works. For example, with Apple Pay, after the amount of a purchase is identified, the clerk at a point-of-sale initiates the payment process and the user uses their iPhone to generate a one-time use token that is passed for that payment. However, in the scenario disclosed herein, the identity of the person can cause changes or a reduction in the charges made on a purchase or some other benefit. Thus, the process can be adjusted where the NFC component at the point-of-sale can first retrieve from the mobile device the identity of the person, a database check can occur to see what benefits that person might receive, the point-of-sale might first receive the identity of the user, then apply whatever benefit is justified to the purchase based on second buyer purchases, history of the first buyer being a salesman for the product or company, and then can have the single-use token as part of the payment process. The adjustment might cause the process to be slightly longer than normal relative to how long the user needs to hold their mobile device next to the NFC component. Furthermore, this approach can enable a personalized experience at the point-of-sale. For example, on a display screen, a photo of the user, a video, or some personalized content can be provided based on the user identity. The user may be able to interact with a point-of-sale component to answer a question or provide some input or as part of a gamification approach. Currently, the problem with a point-of-sale is that it has no enjoyment and no personalized component to it for individual users. By making the point-of-sale (whether for the first buyer or the second buyer), the experience can trigger the brain's reward center and which can make the experience better and cause users to want to come back. Imagine a brick and mortar store where people love the actual point-of-sale experience and desire to come back to keep buying products. The approach disclosed herein enables a personalized experience. The experience can be presented on one or more of a point-of-sale device or display, a user's mobile device, or may encompass a combination of the two devices. The approach increases customer brand/company loyalty and the customer can become a model for the product.

Note that the enhancement of the point-of-sale experience to be personal can be independent of the broader disclosure herein of providing the first buyer with a benefit for sharing or encouraging a friend (the second buyer) to buy their own product.

Furthermore, the interaction can be related to social media data such as when a product is purchased, the buyer may get data about how many of their friends loved the product, the system can notify their friends that the buyer has just bought the product and they can “like” the purchase. The experience might even be in real time where the user is at the point-of-sale, their name is identified as well as the product (or products) and a quick notice can be sent to a friend group on social media for votes on whether they should complete the purchase. Friends could even be presented for example with two colors of a sweater and vote and the user could be live at a point-of-sale and receive or see the votes (on any device) and then purchase the more popular sweater. A user interface can be configured such that the potential buyer can see the graphical of the two products to choose from and hit “send to friends for a vote” object on any device. A countdown could occur (say 10 seconds for friends to respond) and the results of the voting could be presented on any device where the user could interact with an object to “buy this one”.

FIG. 10G illustrates a method 1040 for some of these features. The method 1040 can include obtaining an identity of a buyer (1042). This can occur as noted above by a buyer providing a phone number, starting a payment process using a mobile device like in Apple/Google/Samsung Pay, or otherwise. The system can then access whether a benefit associated with the purchase can be provided based on the identity of the buyer (1044). In some aspects, the user may be enabled to reach out to their social media network for feedback on the purchase (which of these shirts should I buy?; what color pants look good?) and get instant feedback from the network. Then, the method 402 can include applying the benefit (a discount for being a solid salesman of the product, or sharing it on social media, or making purchases at the merchant) or personal feature (how many likes on the blue shirt, or a picture of a friend with the product, or other personalized feature or object) to the current in process purchase (1046) which can be at a point-of-sale, and completing the purchase with the applied benefit (1048) which can include the personalized feature so that the checkout procedure whether online or at a point-of-sale is more personalized with picture, social media interactions associated with one or more products and the buyer, and so forth.

Another aspect of this disclosure is provided in FIG. 10H and it relates generally to customer service on a product. A method 1050 is provided which can relate to customer service. Having the scannable object configured on a product purchased by a first buyer can not only enable a second buyer to buy their own version of the product but can easily help with service issues. For example, products like LEGO's sell with many parts. On occasion, a part is missing and the user needs to order a replacement part. The user can scan the scannable object on a box or part. Since the object links the first buyer to the product, much information is immediately obtained. In one example, when the first buyer scans the object, the system knows it is not a (potential) second buyer but the first buyer. A customized user interface for the first buyer can be presented in response to the scan. The user may want to order a part or receive service associated with the product. The user interface can be configured for the type of service likely needed. The method can include receiving a scan of an object configured with the product purchased by the buyer (1052). The scan identifies that it is the buyer that is scanning the object and not a second buyer (who, if they scanned the object, would get a different user interface directed towards a purchase and not service).

The method includes presenting a user interface on a user device associated with customer service for the product (1054). For example, the user interface may state “Hi John, do you need to order a part?”. Since the system identifies the user from the scan, there is no need to enter in user information, address, etc. The user is already at that point logged into the user account for that company. The process simplifies for the user the ability to order a part, obtain service, schedule an appointment, etc. for the product. The method includes receiving a service request for the product (1056) and then providing the service based on the service request (1058).

Another aspect could be where the second buyer could scan a product and place it in a “wish list”. Then, the second buyer could buy the product later or could wait until authorizations are in place from the first buyer. Then, the second buyer may be able to confirm that the first buyer is their friend.

In another aspect, this could be used for a market order or a limit order. In some cases, a buyer could place a “market order” for a product at a certain price. Then, the system could monitor the prices of products and then when the price hits the stored price, then the sale is consummated. In this case, a buyer can have a wish list and a product pricing that is placed. Then, if a manufacturer or merchant places that product at the strike price, then the system may implement or proceed with the sale of the product to the buyer. This can be for the second buyer or the first buyer as mentioned here. This could turn the product market into the stock market. The system here could know then that one thousand people would buy a certain YETI cooler at $70 and then could coordinate or share that general data with the manufacturer such that when the volume makes it work, then one thousand coolers are sold at the strike price that makes it worth it because of volume. The system disclosed herein could manage all of the flow of information between the number of users willing to buy a certain product at a certain price and coordinating that data with merchants and manufacturers. Users could be given notice that the price is getting close to their limit order and do they want to go ahead and buy, which could include knowledge of the supply of the product.

Further, the market orders for products could also drive manufacturing where the system could coordinate with manufacturers regarding the number and/or trend of certain product market orders which could cause a manufacturer to go ahead and make a batch of products for the strike price. Further, users may also be given feedback on if they adjust their price at a certain amount, then it will be fulfilled. The consumer can be given more influence over the pricing and manufacturers of the product.

Another aspect of this disclosure relates to a shopping cart. Some shopping carts are being developed with self-checkout features like scales to weigh product, a user interface to enable a user to scan the bar code associated with a product and both add the product (with its weight) to the physical shopping cart and add the product to a virtual shopping cart. The user can then manage the overall costs themselves rather than at a point-of-sale where people might be watching them. They can checkout and pay for everything without a physical point-of-sale but while being in a brick and mortar store.

The principles disclosed herein can be incorporated into a shopping cart. For example, the point-of-sale components described herein can be integrated into a shopping cart such that it includes, for example, an NFC component that can be used to interact with a user mobile device for payment, for initiation of a shopping experience, and/or to obtain the identity of the buyer. For example, at the beginning, the user may use the NFC protocol to identify themselves which can be confirmed through interactions like Apple Pay (two clicks and a facial recognition, for example, or other biometrics or PIN codes). The experience at this point can be even more personal in that the shopping cart can include a wireless communication component and access a server and gather user profile data for that user. The pricing and user experience on a graphical user interface of the shopping cart can be tailored for that user. For example, if the user has an active history of sharing products with friends, then the pricing may be reduced and the user interface may say: We are giving you 10% off because your friend Mary bought one of these shirts from the QR code on your blue shirt you bought last August.

Social media data can be accessed via the server as well. For example, if you scan a product that has been purchased and “liked” by some people in your social media circle, the user interface can respond with data like: “10 of your friends bought the same or similar shoes in the last year”. If there is a QR scannable code as described herein, the user may scan a bar code, which can indicate that there is a QR code that can be scanned to connect the user with that product and that second buyers can use to buy the product as well. The shopping cart can instruct the user to scan the QR code or NFC tag or whatever the object is using a NFC component or a visual scanning component and a confirmation can be provided that the product is registered for that user. The user could pay at the end using Apple Pay or any other payment process.

Thus, note that in this case the NFC component, for example, could be multipurposed. It can be used to initially identify the user, it can be used to scan NFC tags on a product to connect that product uniquely with the user, and it could be used to receive payment through Apple/Google/Samsung Pay. The system adjusts which mode the device is in based on the overall shopping experience. Users are already used to these kinds of technologies and thus this new idea will be easy to implement. A scanning device can also be used in different contexts such as scanning a QR code for a discount, to identify the user, to scan a code on a product to connect that product with the user, and/or for other reasons. Again, this can be placed in different modes to make the proper reading. The shopping cart can include the basic computing components such as a battery, a touch sensitive display, a computer processor, a communication component (cellular/Bluetooth, etc.), computer memory, program modules, a multimodal interaction component, the ability to process speech, a biometrics component, and so forth.

The interface can thus include the specific types of options for that product, such as to buy it again, or to go through a parts list, or to request some type of service. For security, in some cases, before the service interface is presented, the system may do a facial/biometrics/fingerprint recognition like in Apple Pay before presenting the interface to ensure that the proper user is making the service request.

In another aspect, where the second buyer is specifically buying the product from the first buyer, which is referenced in the incorporated application, the second buyer may not want to buy a new product but to literally take possession of the first buyer's product. In this case, the system can present an option on the checkout page 1002 where a negotiation can take place in which the system managers user interfaces on the mobile devices of the first buyer and the second buyer. The optional function 1003 in FIG. 10A might be to buy that very same first product. If the second buyer chooses that option, then the system can present to the user an offer from the second buyer (which could be placed in a field of a user interface obtained when the function of buying the actual object is chosen from object 1003's functions), and a negotiation can take place where the first buyer adjusts the price and present a counter offer. If the users are simply standing next to each other, the first buyer can simply set the agreed-upon price on their mobile device, and the second buyer can then receive a text or an updated checkout flow with the approved price (the first buyer may confirm the price like they confirm a purchase on Apple Pay with two clicks and a facial recognition). The ease of the approach is that it all takes place essentially on the context of the second buyer checkout flow which is easy to manage and contemplate for the second buyer. The use of the checkout flow here is updated to be much more flexible to enable the second buyer to offer to buy the very product that had the object that was scanned.

Yet another aspect of the optional function 1003 can relate to enabling the second buyer to view material prepared by the first buyer about the product. For example, through an application, social media network, or via the web, the first buyer could take pictures and video associated with the product and easily connect that content to the product by scanning the object on the product. For example, a backpack having the object contained thereon could be used in photos, stories, videos of hikes and the first buyer could take the content, and the application, camera, etc. could include an option to associate or transfer that content to a storage location associated with the object. The first buyer could compile or make a video or configure the personal content and review the content such that when the selectable object 1003 is chosen after the second buyer scans the object on the product, that personal content is presented. It could be a demonstration about how to use the content, it could be a Youtube video or a social media posting on the product. In general, the first buyer can tailor the experience of the second buyer when they scan the object on the product. The process could include receiving personal content from the first user, receiving data from the first buyer scanning the object on the product and storing the content in connection with the first product based on the scan. Then, when a second buyer scans the object, the personal content is delivered or transmitted to the second buyer device either directly or in a selectable manner from a menu, or is selectable from a checkout flow.

Further, the seller of the product could also present content based on a second buyer scanning the object. The experience or user interface seen when the second buyer scans the object can include one or more of a menu of options, content from the seller of the product or a merchant that sells the product or the manufacturer, personal content from the first buyer, a checkout flow to buy the product, or any combination of these options. The content presented could also be dependent or chosen based on factors such as the second buyer location, a time of day or time of year, a season (during Christmas time, a different content is presented), and so forth. An advertisement could also be presented which is tailored an accessory product or any product. The advertisement could feature the product with the scanned code with an accessory product (which could be added to selected to be purchased as well in the checkout flow).

The principles disclosed herein can also be incorporated into other existing payment flows, such as Apple Pay, Google Pay, Samsung Pay, or PayPal. In many cases, these new generation payment flows have a design of being more like a “single click” experience for the user. However, given the simplicity of these flows (which may require different interactions than a simple click on a button), one could integrate into the flow some kind of interaction (single click, biometric identification, multimodal interaction, or other forms of interaction) to confirm that the user's name should be provided to a database in connection with a product or service being purchased via the current payment flow. When the user approves, a database record is established which includes one or more of the user name, an identification of the product in general (such as a Yeti water bottle version X), an identification of the specific product purchased (Yeti water bottle number 1,234,123, identified from a code such as a QR code), and/or metadata such as date, time, store location, promotional associated with the purchase, etc.

The following are some examples of how a connection of a user to a product at the time of purchase can occur. Apple Pay has become ubiquitous in society and is used as a simplified way of making payments online, at a point-of-sale, and in applications. The focus has been on security and the simplified user experience for making payments. For example, at a point-of-sale in a brick and mortar store, a user may double-click a side button on an iPhone and then have their face recognized to place the iPhone in a state of being able to connect via a wireless link to a point-of-sale device and transmit a one-time use token for a payment for an item. Usually, a clerk at the store completes via a cash register or other device the purchase data and causes a signal to be sent to the point-of-sale device to be activated to exchange the necessary data to cause the iPhone to generate the token and transmit it to the point-of-sale device. Back-end processing can include confirming with Apple Servers that the user is authorized and proper for making the payment. The token may go to the merchant or a payment processor for making the payment using the credit card or payment card of the user.

What is needed in the art is a new mechanism of authorizing other applications or transactions as part of an Apple Pay (or other payment mechanism) payment flow. For example, a buyer may be at a point-of-sale to buy a Yeti thermos that has a unique QR code configured on the bottom. The QR code may be used like a UPC symbol to identify the product for purchase at the point-of-sale. However, when the user, say her name is Mary, buys the Yeti Thermos, the QR code could be stored in a database that identifies Mary as the buyer of that particular Yeti thermos. Then, when a friend of Mary's, named John, sees the Yeti thermos and wants one for himself, he can simply scan the QR code. A database can be accessed to confirm that Mary is the owner of this Yeti and is therefore the means by which John is able to buy his own. John can have his Yeti delivered him and Mary can get a benefit such as a 10% discount on her next purchase, or any other benefit. The overall ecosystem can be called a “benefit process” or “benefit system” which typically involves three transactions. The first is Mary purchasing the product. The second is John purchasing his own version of the product, and the third transaction is Mary making another purchase to redeem the benefit granted based on John's purchase through an interaction with Mary or the product that Mary purchased.

However, there needs to be a simple mechanism where Mary can provide her name to the merchant so that the database record connecting Mary, to the Yeti and the unique QR code. This is where a modification of Apple Pay will come into play. Normally, the cash register or similar system of a merchant is used to list the product or products being purchased and identify the total amount for the sale. When that is complete a signal is sent from the cash register to a POS device for interacting with the iPhone to actually make the purchase. The user double clicks the side button and has their face recognized either before connecting wirelessly to the POS device or in another aspect the POS device transmits a signal that “wakes up” the iPhone and automatically places it in a state of being able to make a purchase or confirm the purchase with two clicks and a facial recognition. Or the user confirms the purchase before connecting with the POS device and the payment data, upon connection, is automatically sent with no more user interaction.

The new approach will be to transmit data regarding the product and/or the QR code to the POS device. The signal basically indicates to the POS that the merchant for this transaction is going to request the name of the buyer and/or some identification information. The POS device can adjust the user interface as part of the Apple Pay transaction as follows.

The POS may access a database to determine if Mary is already registered with a service for managing the purchase by John and the benefit provided to Mary. If Mary is not registered, the user interface may present information on the display of the iPhone saying “Mary, the Yeti thermos is eligible for purchase by your friends via the QR code on the bottom. You will get a benefit for each Yeti thermos your friends buy. Please confirm registration for this program as you authorize this purchase.” Whether through a separate approval (i.e., a separate two clicks and a facial recognition, approval via a text or email, or other mechanism), Mary can be registered with the service to enable the process.

For example, if the user has not double-clicked and done facial recognition before the wireless connection is made to the POS, the POS, when connected, can automatically launch Apple Pay and present the above information indicating that the approval of this purchase will include an approval to register for the QR code program such that benefits can be provided. Then one approval is only needed. As an alternative, after the payment is approved in the normal way, the user interface can present the information about the program to the user and they can confirm again and separately that they want to register and store their purchase of the Yeti thermos in the database. The second confirmation to use their name can be the same or different than the first confirmation for the purchase.

If the user is already registered, which can include approvals of providing their name to the merchant for the Yet thermos being included in the QR code program, then a notice in connection with the purchase may simply state that “The Yeti thermos you just bought is included in the QR code program. Please share it with your friends!”.

Then, Apple Pay can provide via an API or some other communication channel the basic information to the merchant or to a separate service provider that simply stores the data about Mary and the identification of the Yeti thermos.

Then, when John sees Mary and decides he wants a Yeti thermos as well, he simply scans the QR code which accesses the database to identify Mary. John can then simply be placed in a payment flow to buy his Yeti. The payment flow may or may not include information such as “Your friend Mary will get a 10% discount on her next purchase”. Then, the service provider stores or creates a “policy” that indicates that the next time Mary makes a purchase at the merchant, she gets a 10% discount. The policy can connect Mary, with the benefit, and her credit card or debit card or other payment mechanism such that all she needs to do is shop using her existing payment mechanism and the service provider tracks or detects those transactions and automatically applies the benefit.

The service provider here could be Apple as they operate Apple Pay or they could communicate with the service provider or merchant through an API or other communication channel. The benefit here is that the information provided to the merchant or the service provider is typically only the user name or other identifying information. Only one time would the user's credit card be shared with the service provider for being able to process the benefit on a later transaction.

In another aspect, Apple Pay, because they only use a one-time use token for making a specific payment, can notify the user's bank or credit card company that the user has authorized the sharing of their credit card number to the service provider to enable them to redeem the benefit. Here, the bank could then use two-factor authentication such as by sending a text or email to their customer confirming that they are to share the credit card data to the service provider. This way, privacy and security are properly handled and the person gets registered with the service provider and is easily thereafter able to have other products that they purchase connected to them in the service provider database.

The approach may include registering the user the first time with the service via a second mode of communication such as a text or an email where the user confirms that the service can store their credit card number for purposes of enabling the registered user to receive or redeem benefits when a person buys a product from the product they purchased.

The process may be similar for web-based or application-based purchases. Whether on the web or in an application, when a user purchases a product that will be part of the benefit program, whether before, during or after a payment, the user can be presented with a confirmation that the service provider will store their name as having purchased the product. For example, when a user clicks on “Apple Pay” to make the payment, the website or application may determine that the product is to be part of the benefit program, the user may be presented with a selectable object to “confirm that the Yeti thermos will be stored in our database for use in the benefit program.” Then the regular payment process can proceed. Or, the user may be presented with the data regarding the product purchased but also may be told that by confirming the payment they will confirm or authorize the storage at the service provider of the product connected to their name and thus entered into the benefit program.

If the user via Apple Pay has confirmed the purchase with two clicks and a facial recognition, before connecting to the POS device, the normal process is that once the POS device connection is made with an iPhone, the user provides no additional data and the payment data (token) is automatically transferred to the POS device for further processing. In this case, however, if there is a product to be purchased that is to be connected to the user as the purchaser, then since the user has already provided the confirmation and biometrics to confirm their identity, the system can safely present a notification or request on the user interface saying “confirm your connection to the Yeti water bottle and the QR code on the bottom”. The user may click on an object, or click on the physical button or perhaps have another biometric confirmation, but at that point, the identity is already confirm and just any kind of input to confirm that the system can register the person's name in connection with the Yeti water bottle (or any product). Thus, the approach in general as described herein inserts an additional confirmation to provide the user's name in connection with the purchase of the product to set the person up for receiving a benefit of a later purchase of that same product occurs through the first product purchased by the user. The flow of Apple Pay whether in-app, online or at a POS can be adjusted similarly to insert in a confirmation of connecting the user to that very product.

Other confirmations can also be provided in an Apple Pay, Google Pay, Samsung Pay, PayPal pay or any other payment flow as well. The only variations might be dependent upon the different specific details of a respective payment flow.

When no QR code is used to identify the product for the second purchaser, the system can utilize a scan of the product by a camera to identify the product, an application, facial recognition, text, user input, or other mechanism can be used to identify the first purchaser. The system can ping the database of names/products to confirm that the first purchaser did indeed purchase the product identified from the picture (through an AI model) and can then proceed to process both the purchase of a product for the second purchaser and the benefit provided to the first purchaser.

In some cases, as noted above, the interaction with the POS device in a payment flow can also cause information to be provided back to a merchant device which can include a printer that prints at the point-of-sale a QR code or other code that can be placed on the product for later scanning by the second buyer. A processing service or entity that stores the data regarding the product and the user can generate the QR code and send it back to the POS device or a merchant device based on the approval from the user of the connection. Thus, through the flow of, for example, Apple Pay, a user can authorize or confirm the connection of the user and the product in a database and have a sticker printed for later scanning by a second buyer.

Referring now to FIG. 11A, in some embodiments a vendor-organization 1100 may interact with the purchasing service through a browser-based web portal 1102. Web portal 1102 provides a set of vendor-facing tools that allow the vendor-organization 1100 to onboard products, generate purchase objects for those products, test the corresponding consumer checkout flow, and review performance statistics for products that participate in the referral program described herein. In the illustrated example, web portal 1102 presents a page for creating or managing a company account, and organizes controls for that account into multiple functional panels.

A product management panel 1104 may be displayed along one side of web portal 1102. Product management panel 1104 can list various operations that may be performed for products associated with vendor-organization 1100. For example, product management panel 1104 may include an object to enroll new product 1106, such as a button or hyperlink labeled “Enroll New Product.” Selection of object 1106 may cause portal 1102 to present an interface for entering product metadata (e.g., product name, SKU, base price, category, and campaign eligibility flags) and, upon confirmation, to create a corresponding product record within the purchasing service. Product management panel 1104 can further include controls to edit existing product details, to invoke a view of a product object as described below, and to launch a checkout simulation for a selected product. In this way, a single panel provides the vendor with a consolidated navigation area for day-to-day product operations.

In some implementations, selecting a product in product management panel 1104 causes web portal 1102 to present a view product object panel 1108. View product object panel 1108 can display product-specific information such as the product name, a SKU identifier, and a current price or price range, and can allow the vendor to adjust one or more of those fields. View product object panel 1108 may further include a button to generate object 1110. When the vendor activates button 1110, the system may generate or refresh a machine-readable purchasing object associated with the selected product. The purchasing object can encode, for example, a product identifier, a vendor-organization identifier, campaign attributes, and any other data needed to recognize a later scan or interaction as a second-buyer purchase eligible for benefits. In some cases the purchasing object is embodied as a QR code, NFC payload, URL, or other token that can be stored digitally or printed.

An option to view product object 1112 may also be provided within view product object panel 1108, or in another region of portal 1102, and may be selected to render the currently generated object in a human-viewable format. For example, upon selection of option 1112 the portal can display a QR code corresponding to the purchasing object, which can then be downloaded, copied into marketing materials, or printed on product packaging for scanning by buyer devices. In some embodiments, option 1112 can toggle between different representations of the same purchasing object (e.g., a QR code, an NFC configuration summary, or a shortened URL), allowing the vendor-organization 1100 to deploy the product object across multiple channels while maintaining a single underlying reference used by the purchasing service for analytics and reward attribution.

Web portal 1102 may further include a checkout simulation panel 1116 configured to emulate the consumer experience associated with the purchasing object for the selected product. Checkout simulation panel 1116 can allow the vendor user to select a particular product, campaign configuration, or option set (for example, size or color variants, bundled accessories, or geographic shipping options) and to initiate a simulated scan of the product object. The system may then render, within panel 1116 or in a preview window, the same purchase interface that would be presented to a first buyer or second buyer device when interacting with the object in the field. This enables the vendor-organization 1100 to verify that prices, discounts, referral messaging, benefit amounts, tax and shipping calculations, and campaign badges appear as expected before deploying the product object broadly.

In addition, web portal 1102 may expose a product statistics panel 1114 that summarizes performance data for the selected product or for a group of products. Product statistics panel 1114 can present, for example, metrics relating to “Sales,” “Referrals,” “Campaign,” and “Geography.” A sales portion of panel 1114 may indicate total second-buyer purchase volume, average order value, and conversion rates from scans or link clicks. A referrals portion may break down purchases by referring first buyers, friends-list segments, or share channels (e.g., in-person scan, NFC phone-to-phone exchange, social-media links). A campaign portion may show how different promotional campaigns affected performance of the product over time, such as uplift during a “product of the week” promotion or during a particular holiday campaign. A geography portion may depict where scans and purchases are occurring, for example by city, postal code, or region, allowing the vendor-organization 1100 to identify markets in which the product and associated referral program are performing strongly or weakly. In some implementations, the metrics in product statistics panel 1114 are derived from the same unified transaction and referral event model used by the purchasing system to grant benefits to first buyers and to track streaks and other social features described elsewhere herein.

Collectively, the panels of web portal 1102 provide a vendor-facing interface through which vendor-organization 1100 can onboard products into the purchasing service, generate and manage the product-level objects that drive the referral program, test a consumer checkout flow associated with those objects, and monitor ongoing performance of products and campaigns. Although FIG. 11A illustrates a particular arrangement of product management panel 1104, view product object panel 1108, checkout simulation panel 1116, and product statistics panel 1114, other layouts and additional controls may be used while remaining within the scope of the techniques described herein.

In one example campaign, a new store may want to sell t-shirts for their business, such as a tanning salon. The t-shirts sold to first buyers may have a physical object like an NFC chip or QR code that can be used by second buyers. The first buyer may get a free tan or one or more benefits offered by the business for each t-shirt (or membership, or one-time tan, or any other offering) sold in connection with a second user device interacting with the physical object or with the first buyer device application that lists the business t-shirt as one of their products in the system. The business could then have a set of patrons out in the marketplace with their shirts—and can advertise through the app, or through other communications like social media postings, texts or emails that another campaign is running for a period of time where any buyer of a business product (t-shirt, tanning registration, etc.) can get a benefit when the buyer sells a product to another buyer. The benefits are automatically provided to the buyer according to the “policy” or campaign structure, which can be configured via a business portal.

The business portal can provide information about all the people in the community that have business products configured to be able to be used to sell additional products or services and the system can aid the business in configuring a new campaign with benefits, advertising, communication framework, timing, geographic scope, and so forth. For example, there may be a thousand t-shirts sold that the system can determine are still in the state where the business is and two-hundred t-shirts in a different state hundreds of miles away. The campaign may include enrolling or offering the benefits of the campaign only to buyers who have products that are in a certain geographic area or a certain distance away. For example, a business portal could enable the business to select a campaign for products that are within 50 miles of the business. This could cause the system, when a second buyer uses a second device to purchase a product off of the first device, to first determine the location of the second device, or the product, and then determine whether the campaign benefit is offered or whether the standard benefit (like a $4 rebate to the first buyer account) is provided.

Referring now to FIG. 11B, a group of process flows 1120 illustrates several example social and analytic processes that may be implemented by the purchasing service. In the illustrated embodiment, the group of process flows 1120 includes a friends list flow 1122, a phone-to-phone near-field communication (NFC) exchange flow 1124, a shareable product link flow 1126, and a favorite products flow 1128. Although shown together for ease of explanation, each flow may be implemented independently, and any subset of the flows may be combined in a given system.

In the friends list flow 1122, the system initially receives user identifying data for a user of the purchasing service. The user identifying data can include, for example, an email address, phone number, username, social-media handle, or other identifier that uniquely distinguishes the user within the service or across integrated platforms. The system may further receive contact information or friend identifiers supplied by the user, imported from a device address book, or inferred from referral interactions. Using the user identifying data, the system maintains a friends list for the user. Maintaining the friends list can include creating and updating a data structure that associates the user with a set of friend accounts, handling incoming and outgoing friend requests, synchronizing friend relationships across devices, and pruning stale entries. Based on the maintained friends list, the system can display recent purchases associated with one or more friends to the user. For instance, a mobile application may present a feed indicating products that friends have recently purchased through scanning product objects, following shareable links, or using the local-sale mode, along with associated benefit amounts or reviews. In some implementations, the displayed recent purchases are filtered by privacy settings, by geographic relevance, or by product category, and may be used as input to recommendation algorithms or to highlight referral opportunities for the user.

In the phone-to-phone NFC exchange flow 1124, a first user device associated with a first buyer may act as a conduit for sharing a product object with a second user device associated with a second buyer. In one step, the first user device transmits product identifying data via an NFC interface. The product identifying data can represent, for example, a token or payload corresponding to a product object that the first buyer previously scanned, purchased, or favorited, and may encode product identifiers, vendor identifiers, campaign identifiers, and referrer information for the first buyer. A second step occurs when the product identifying data is received on the second user device. The second device may have an application or operating-system service configured to recognize such payloads and to forward them to the purchasing service. In response to receiving the product identifying data, the system provides a purchasing interface on the second user device. The purchasing interface may be the same or similar checkout flow that would have been presented had the second buyer scanned a physical QR code or activated a shareable link, and can include product details, price, discounts, referral messaging indicating that the first buyer recommended the product, and controls to complete a purchase. Completion of a purchase via this interface may be treated as a second-buyer transaction that credits benefits to the first buyer.

In the shareable product link flow 1126, the system allows a user to distribute product recommendations through external channels such as social-media platforms, messaging applications, or email. In one step, the system generates a product link that is associated with a product and a particular referrer (e.g., a first buyer). The generated product link may be a URL or other token that, when followed, directs a device to the purchasing service and encodes sufficient information to identify the product and the referrer. In a subsequent step, the product link may be posted to social media or otherwise shared. For example, the purchasing application may integrate with a social-media application programming interface (API) and, upon user confirmation, create a post, story, or direct message containing the product link and optional accompanying text or imagery. After posting, the system can detect interaction with the link, such as a click, tap, or other activation event from a second buyer device. Detection may occur when the second buyer's browser or application resolves the URL to the purchasing service, at which point the service recognizes the embedded referrer and product identifiers. In response to detecting the interaction, the system facilitates a purchase for the second buyer by presenting a purchase interface for the referenced product, optionally pre-populated with discounts or campaign benefits associated with the link. If the second buyer completes the purchase, the transaction may be recorded as a referral attributed to the original user who generated the link.

In the favorite products flow 1128, the system uses user preference information to drive analytics and discovery. In a first step, the system identifies favorite products for a given user. Identification may be based on explicit user input—such as tapping a “favorite” or “save” control in the application—or inferred from behavior such as repeat purchases, frequent referrals, or high engagement with certain product objects or links. Once a set of favorite products is established, the system tracks product analytics for those products at a finer level of detail. Tracked analytics can include, for example, the number of scans or link activations, conversion rates from scan to purchase, time between recommendation and purchase, amounts of benefits earned, performance across different campaigns, and breakdowns by geography or device type. Using the tracked analytics, the system can display historical performance of the favorite products to the user, such as charts or tables showing referral income over time, conversion trends, or comparison among products. In some embodiments, the system further displays top-selling products, either within the user's own activity (e.g., products for which the user has generated the most second-buyer purchases) or across a broader segment such as the user's friends list or geographic region. This information can encourage users to continue promoting high-performing products, to discover new products that are popular among peers, and to adjust sharing strategies based on observed performance.

While FIG. 11B depicts particular sequences and labels for flows 1122, 1124, 1126, and 1128, the illustrated steps may be reordered, combined, or augmented with additional steps, and similar processing may be implemented using other messaging or transport technologies in lieu of NFC or social-media links while remaining within the scope of the present disclosure.

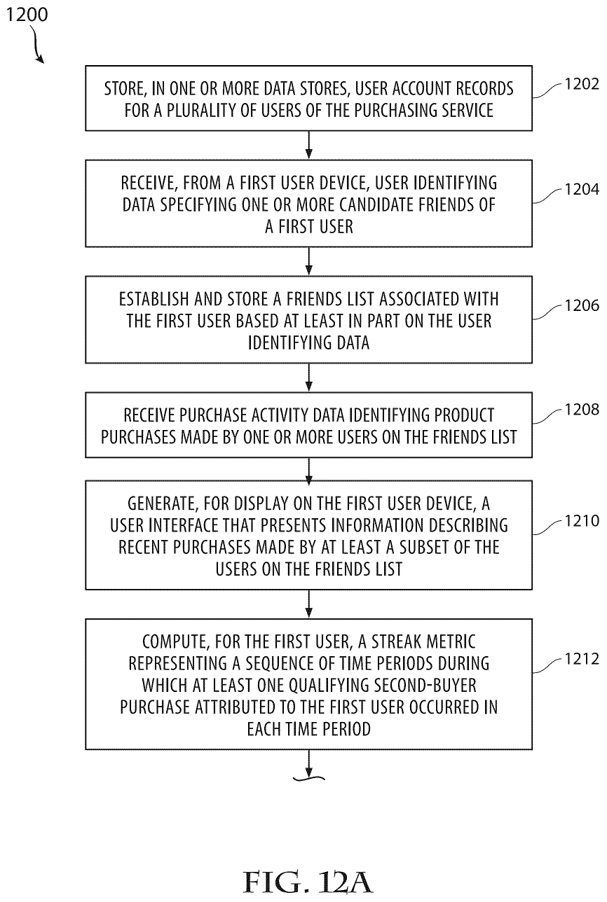

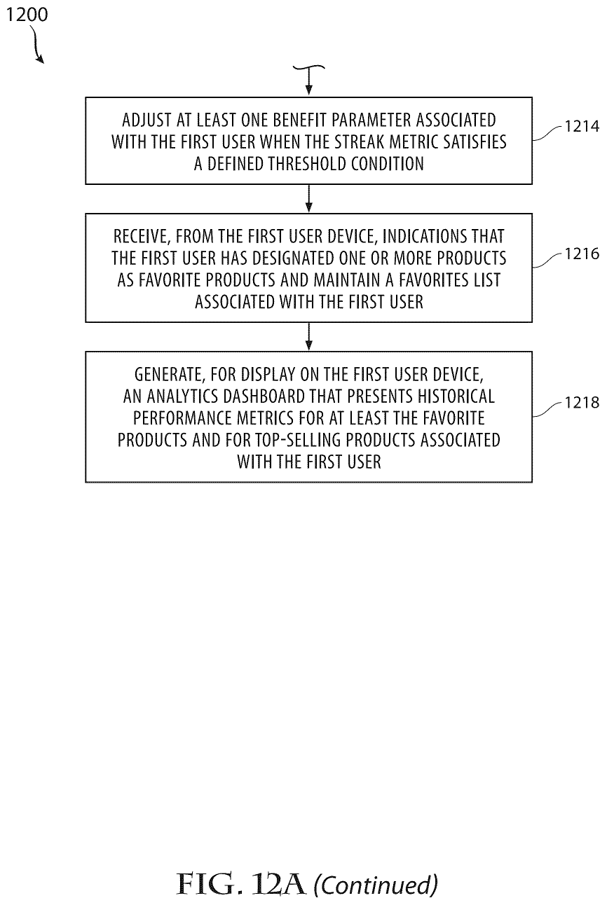

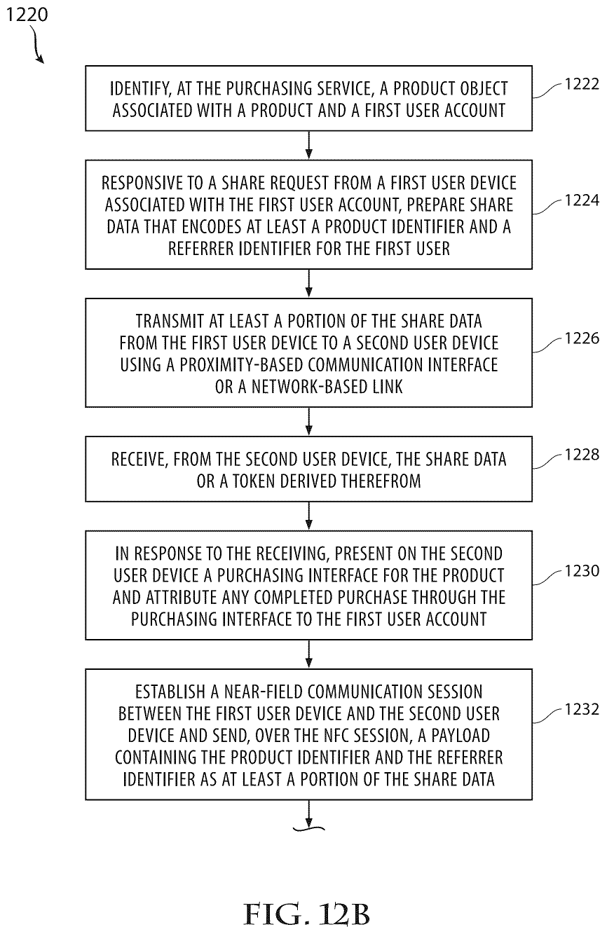

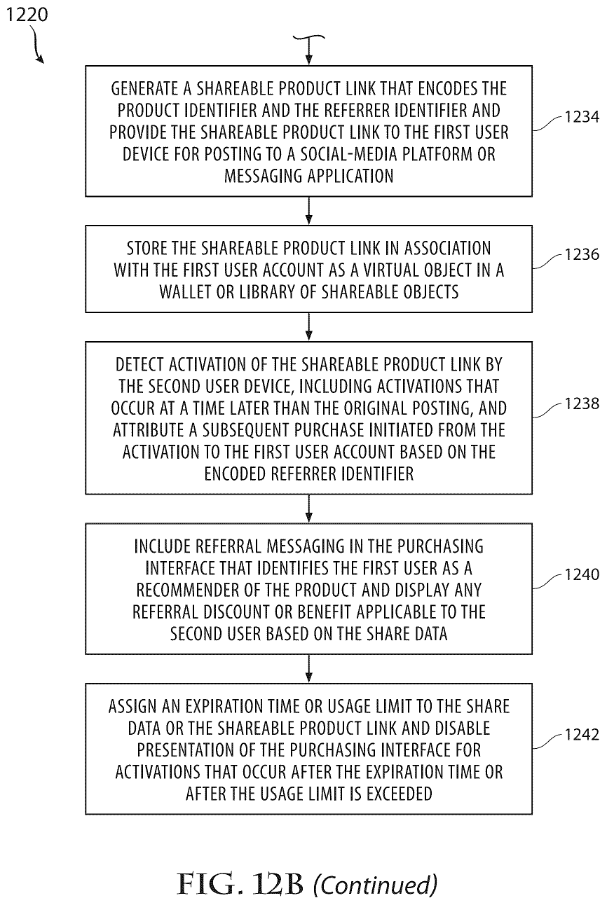

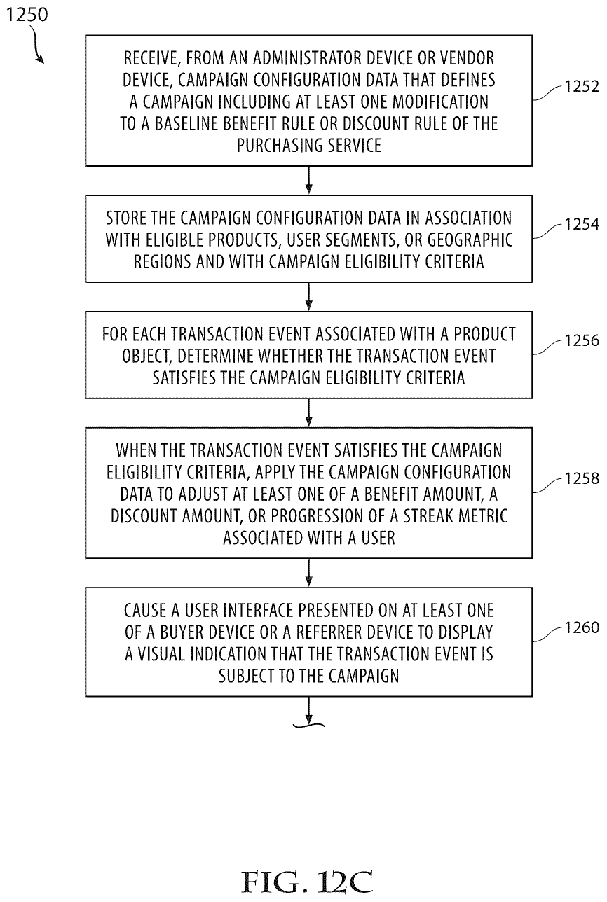

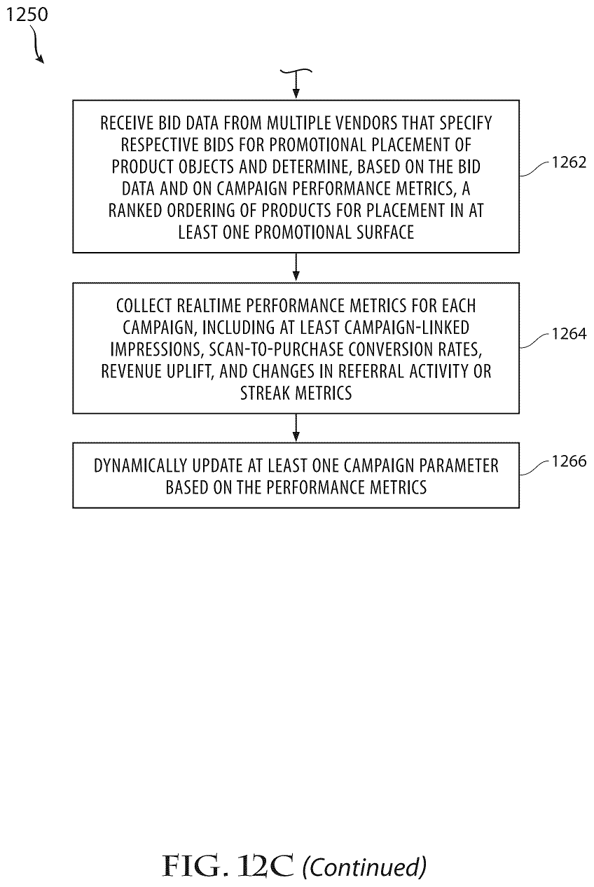

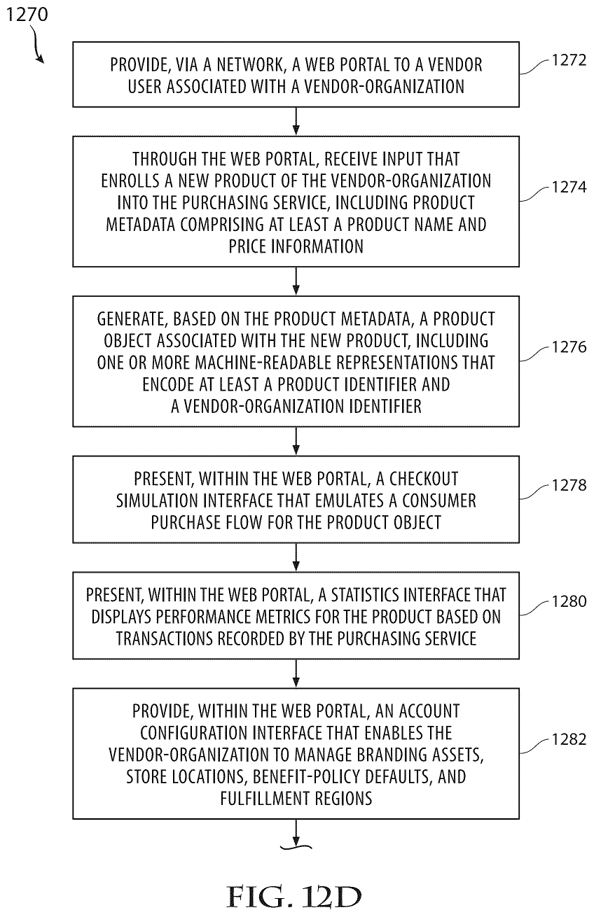

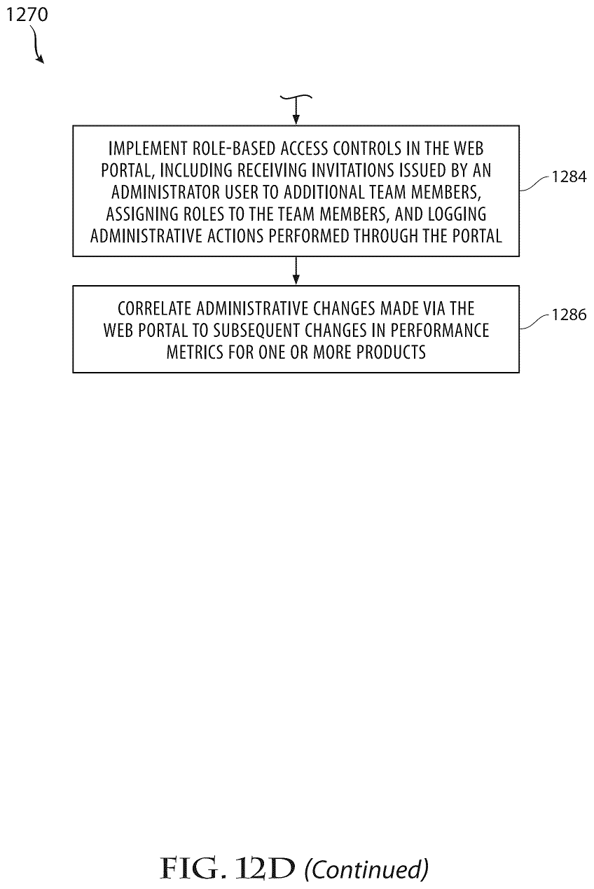

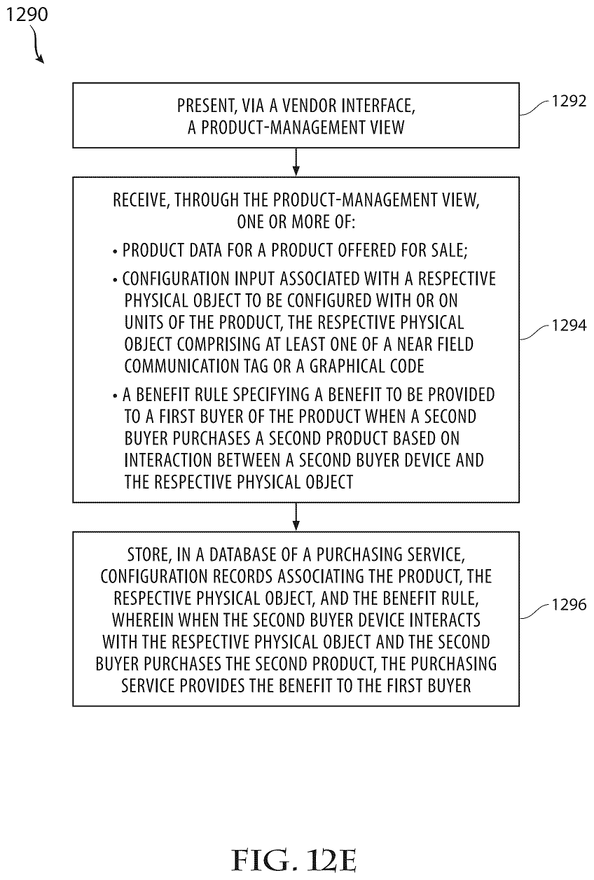

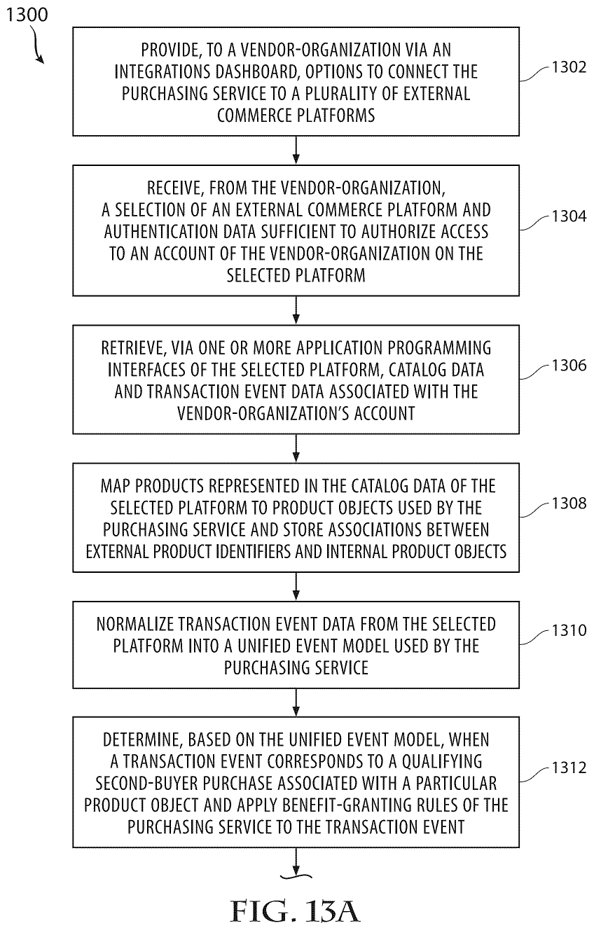

FIG. 12A provides an example method 1200 that can be implemented by a system such as computing device 1400. The system can also include a computing system 1500, a processor 1504, connection 1502 a system memory 1508, such ROM 1510 and/or RAM 1512 as well as any other computer components, network components, user interfaces, applications and so forth. The example method 1200 relates to a purchasing service that can include a social referral platform that maintains, for each registered user (a “first buyer”), a dynamically updated social graph or friends list. The social graph may be built from explicit friend selections, imported contact lists, or repeated referral interactions, and may drive interfaces that show recent purchases made by friends, recommended products based on friends'activity, and attribution of second-buyer purchases back to specific first buyers. The system can be configured to track streak metrics representing consecutive time periods in which one or more second-buyer purchases occur, and can unlock enhanced rewards, tiers, or promotional status when a user's streak satisfies defined thresholds. Users may designate “favorite” products and view analytics and dashboards highlighting favorite products and top-selling products for that user, including historical referral counts, conversion rates, and cumulative rewards. The example method 1200 can encompass any one or more steps in any order of the steps discussed in connection with FIG. 12A.

Any of the methods disclosed herein can be implemented or run by a system configured to perform the disclosed operations. The system can include a computing system 1500, a processor 1504, connection 1502 a system memory 1508, such ROM 1510 and/or RAM 1512 as well as any other computer components, network components, user interfaces, applications or subcomponents thereof. Any method that is disclosed can be claimed as a system or computer-readable medium storing instructions which, when executed by one or more processor, can configure the system or one or more processor to perform the disclosed method.

Referring now to FIG. 12A, an example method 1200 illustrates operations that may be performed by a purchasing service to manage social referral relationships among users. Method 1200 may be implemented, for example, by one or more server systems of the purchasing service in cooperation with mobile devices, web browsers, and data stores as described elsewhere herein.

At block 1202, a system is configured to store, in one or more data stores, user account records for a plurality of users of the purchasing service. Each user account record can include identifiers such as an email address, phone number, username, or social-media handle, as well as profile information, permission settings, and links to one or more devices associated with the user. The user account records may further store accumulated benefits, historical purchases, social-graph attributes, and other data used by the referral features.

At block 1204, a system is configured to receive, from a first user device, user identifying data specifying one or more candidate friends of a first user. The user identifying data may be provided explicitly, for example when the first user enters an email address or handle of a friend, or may be imported in bulk from a contact list on the first user device. The system can compare the user identifying data to identifiers in the stored user account records to determine which candidate friends already have accounts with the purchasing service and to propose potential connections.

At block 1206, a system is configured to, based at least in part on the user identifying data, establish and store a friends list associated with the first user. Establishing the friends list can include creating a data structure that associates an identifier of the first user with identifiers of other user accounts determined to correspond to the candidate friends. The system can maintain and update the friends list over time as new matches are discovered, as friend invitations are sent or accepted, and as friends are added or removed based on user actions or inferred relationships.

At block 1208, a system is configured to receive purchase activity data identifying product purchases made by one or more users on the friends list. Purchase activity data may be generated when users complete transactions through the purchasing service, for example by scanning a product object, activating a shareable link, or interacting with a local-sale mode. For each transaction, the purchase activity data can include at least a product identifier, a timestamp, and a buyer identifier that matches a user on the friends list of the first user. The system filters or annotates the transaction stream to identify those purchases that are relevant to the first user's social graph.

At block 1210, a system is configured to generate, for display on the first user device, a user interface that presents information describing recent purchases made by at least a subset of the users on the friends list. The user interface can present a feed or list that shows product names, images, purchase times, and optional commentary or reviews from friends, subject to privacy settings. In some implementations, the system orders the recent purchases based on recency or relevance, and allows the first user to select an entry to view additional details or to initiate a purchase flow for the corresponding product.

In some implementations, method 1200 further includes block 1212, where a system is configured to compute, for the first user, a streak metric representing a sequence of time periods during which at least one qualifying second-buyer purchase attributed to the first user occurred in each time period. The streak metric may be expressed, for example, as a count of consecutive days or weeks with at least one referred purchase and can be updated as new qualifying events occur or fail to occur.

At block 1214, the system may be configured to adjust at least one benefit parameter associated with the first user when the streak metric satisfies a defined threshold condition. Adjusting the benefit parameter can include increasing a reward rate for subsequent referred purchases, unlocking a higher status tier with enhanced privileges, or applying promotional bonuses such as additional discounts or special campaign eligibility for the first user. The adjusted benefit parameters are stored with the first user's account and applied automatically in later benefit calculations.

In some implementations, threshold conditions for streak-based adjustments include achieving at least N consecutive time periods (e.g., N days or N weeks) with at least one qualifying referred purchase per period, achieving at least M total referred purchases within a rolling window, or maintaining a streak above a threshold value for a minimum duration. The purchasing service can define grace rules that preserve a streak when a qualifying event is missed by less than a threshold interval, can allow a limited number of “streak freezes” within a defined time range, and can define reset rules that partially reduce (rather than fully reset) a streak when the threshold is not met. Benefit adjustments tied to streak thresholds can include tier assignments, reward multipliers, eligibility for specific campaigns, or access to premium placement opportunities for products shared by the user.

In some aspects, method 1200 additionally includes block 1216, where a system is configured to receive, from the first user device, indications that the first user has designated one or more products as favorite products and to maintain a favorites list associated with the first user. The indications may be received, for example, when the first user selects a “favorite” control in a product detail view or activity feed. The favorites list may be used to tailor recommendations and to focus analytics on products that the first user is particularly interested in promoting or tracking.

At block 1218, a system is configured to generate, for display on the first user device, an analytics dashboard that presents historical performance metrics for at least the favorite products and for top-selling products associated with the first user. The metrics can include referral counts, scan-to-purchase conversion rates, cumulative rewards earned, and time-series plots of referral activity. In some implementations, the dashboard highlights top-selling products for the first user, such as products that have generated the highest number of second-buyer purchases or the greatest reward amounts, so that the first user can understand and optimize their referral activity.

In some aspects, a system can be configured to manage social referral relationships for a purchasing service. The system can include one or more processors and memories storing instructions that, when executed, cause the system to store user account records for multiple users; receive user-identifying data from a first user device; establish and maintain a friends list for the first user; monitor purchase activity of users on the friends list; and generate user interfaces on the first user device that present recent purchases by those friends. The instructions can further cause the system to compute and update a streak metric for the first user based on qualifying referred purchases, adjust benefit parameters such as reward rates or status tiers when the streak metric satisfies defined thresholds, maintain a list of products designated as favorites by the first user, and present analytics dashboards that display historical performance metrics and top-selling products associated with the first user.

FIG. 12B, an example method 1220 causes a system to be configured to provide referral and sharing mechanisms. Beyond scanning a code on a physical product, a first buyer device and a second buyer device may engage in a phone-to-phone near-field communication (NFC) exchange in which the first buyer device emulates or transmits a digital object associated with a product the first buyer previously purchased. The second buyer device can receive the object and transition directly into a purchase flow for the corresponding product. The purchasing service may also generate shareable URLs or product links encoded with product and referrer identifiers for posting on external channels such as social-media platforms or messaging applications. These links can be treated as virtual objects that may be saved in a wallet or library and later redeemed; when a delayed purchase occurs through such a link, credit is still attributed to the originating first buyer.

Referring now to FIG. 12B, an example method 1220 illustrates operations that may be performed by a purchasing service to enable sharing of product objects between users. Method 1220 may be implemented, for example, by one or more server systems of the purchasing service in cooperation with first and second user devices and associated communication interfaces. The example method 1220 can encompass any one or more steps in any order of the steps discussed in connection with FIG. 12B.

At block 1222, a system is configured to identify, at the purchasing service, a product object associated with a product and a first user account. The product object may have been created when the first user purchased the product, scanned a code on the product, favorited the product, or otherwise interacted with the purchasing service. The product object can encode, or reference, a product identifier, a vendor identifier, campaign attributes, and an association with the first user account so that later sharing and attribution operations can be performed.

At block 1224, a system is configured to, responsive to a share request from a first user device associated with the first user account, prepare share data that encodes at least a product identifier and a referrer identifier for the first user. The share request may be initiated when the first user selects a “share,” “recommend,” or similar control in a user interface that displays the product object. Preparing the share data can include constructing a payload or token that points to the product object and that includes an identifier of the first user account for referral attribution when another user acts on the shared data.

At block 1226, a system is configured to transmit at least a portion of the share data from the first user device to a second user device using a proximity-based communication interface or a network-based link. For example, the first user device and the second user device may establish a near-field communication (NFC) session for phone-to-phone transfer of the payload, or the purchasing service may generate a shareable link incorporating the share data that the first user posts or sends via a social-media platform, messaging service, or email.

At block 1228, a system is configured to receive, from the second user device, the share data or a token derived therefrom. The second user device may forward the payload to the purchasing service when a dedicated application interprets an NFC message, resolves a URL, or processes a deep link. The purchasing service validates the received data, determines that it corresponds to the identified product object, and associates the interaction with a session or account of a second user.

At block 1230, a system is configured to, in response to the receiving, present on the second user device a purchasing interface for the product and attribute any completed purchase through the purchasing interface to the first user account. The purchasing interface can display product details, pricing, and any applicable benefits, and allows the second user to complete a purchase using supported payment methods. When the second user completes the purchase, the system records the transaction as a second-buyer purchase linked both to the product object and to the referrer identifier for the first user so that reward amounts or other benefits may be credited to the first user account.

In some implementations, method 1220 further includes block 1232, where a system is configured to establish a near-field communication session between the first user device and the second user device and to send, over the NFC session, a payload containing the product identifier and the referrer identifier as at least a portion of the share data. In this mode, the first user device effectively emulates the product object, and the second user device behaves as though it had scanned a physical code or tag associated with the product.

In other implementations, method 1220 additionally includes block 1234, where a system is configured to generate a shareable product link that encodes the product identifier and the referrer identifier and to provide the shareable product link to the first user device for posting to a social-media platform or messaging application. At block 1236, a system is configured to store the shareable product link in association with the first user account as a virtual object in a wallet or library of shareable objects. The first user can revisit the wallet, select a stored link, and share it again without regenerating the underlying product object.

In some implementations, shareable product links and other share data are tokenized using cryptographically signed or otherwise verifiable identifiers that encode a product identifier, a referrer identifier, and one or more control parameters such as an expiration time, maximum number of redemptions, channel restrictions, or geographic restrictions. The purchasing service can maintain a revocation list or status flag for each tokenized link so that links can be invalidated (for example, when a campaign ends, inventory becomes unavailable, or a vendor withdraws an offer). The wallet or library of shareable objects can display link status information (active, expired, revoked, or redemption-limited) and can support re-sharing of an active link while preserving attribution to the originating first user.

At block 1238, a system is configured to detect activation of the shareable product link by the second user device, including activations that occur at a time later than the original posting, and to attribute a subsequent purchase initiated from the activation to the first user account based on the encoded referrer identifier. This allows delayed conversions through persistent links to still generate referral credit for the originating user.

In some embodiments, method 1220 further includes block 1240, where a system is configured to include referral messaging in the purchasing interface that identifies the first user as a recommender of the product and to display any referral discount or benefit applicable to the second user based on the share data. Such messaging can increase transparency and encourage participation in the referral program.

Additionally, method 1220 may include block 1242, where a system is configured to assign an expiration time or usage limit to the share data or the shareable product link and to disable presentation of the purchasing interface for activations that occur after the expiration time or after the usage limit is exceeded. These constraints can be used to implement time-limited or single-use promotions while still providing the social sharing functionality described herein.

In some aspects, a system can be configured to enable sharing of product objects between users of the purchasing service. The system can include one or more processors and memories storing instructions that, when executed, cause the system to identify a product object associated with a product and a first user account; receive a share request from a first user device; and prepare share data that encodes at least a product identifier and a referrer identifier for the first user. The instructions can further cause the system to transmit at least a portion of the share data from the first user device to a second user device using proximity-based communication such as NFC and/or network-based links such as shareable URLs, to receive the share data or a token derived therefrom from the second user device, and to present a purchasing interface for the product on the second user device. The system can attribute any completed purchase through the purchasing interface to the first user account, optionally store shareable product links as virtual objects in a wallet for later reuse, include referral messaging and benefits in the purchasing interface, and enforce expiration times or usage limits associated with the share data.

FIG. 12C illustrates an example method 1250 related to a purchasing service that can orchestrate promotional campaigns and sponsored placement around these referral objects. Campaigns may define time-limited modifications to baseline benefit and discount parameters, such as increased rewards to first buyers, enhanced discounts to second buyers, or boosted streak progression for eligible transactions. Campaigns may target particular products, categories, or user segments and may be surfaced via user-interface treatments such as badges, countdown timers, banners, or “product of the week” placements that incentivize early purchasing and sharing of featured products. Vendors or the service operator may bid for premium placement within campaign interfaces, define bundled or down-sell offers, or specify category-level priority rules that determine which products are highlighted when multiple qualifying products compete for attention. Real-time analytics measuring campaign performance, conversion funnels, and geographic response patterns may feed back into dynamic adjustment of campaign parameters.

Referring now to FIG. 12C, an example method 1250 illustrates operations that may be performed by a purchasing service to configure and manage promotional campaigns that modify baseline benefit and discount behavior. Method 1250 may be implemented, for example, by one or more server systems of the purchasing service in cooperation with vendor portals, administrator tools, and consumer-facing applications. The example method 1250 can encompass any one or more steps in any order of the steps discussed in connection with FIG. 12C.

In block 1252, the system is configured to receive, from an administrator device or vendor device, campaign configuration data that defines a campaign including at least one modification to a baseline benefit rule or discount rule of the purchasing service. The campaign configuration data can specify, for example, an identifier for the campaign, start and end dates, one or more products or product categories to which the campaign applies, a reward multiplier for referred transactions, a discount percentage for buyers, or rules for how the campaign interacts with existing loyalty or streak programs. In some implementations, the configuration data is entered through a vendor or operator web portal that presents fields and controls for defining different types of campaigns, such as “product of the week,” seasonal promotions, or limited-time bonus streaks.

In block 1254, the system is configured to store the campaign configuration data in association with one or more eligible products, user segments, or geographic regions. Storing the configuration can include writing records to a campaign data store that link a campaign identifier to specific product identifiers, product categories, user groups (for example, new users, high-value users, or users in a particular tier), and geographic attributes such as countries, cities, or postal codes. The system may also record eligibility criteria such as a time window and platform constraints (for example, in-store scans only, or online checkouts only). In some embodiments, the eligibility criteria explicitly include at least one of a time window, a geographic location of a buyer device, a product category for the product being purchased, or a characteristic of a user segment to which the buyer belongs.

In block 1256, the system is configured to, for each transaction event associated with a product object, determine whether the transaction event satisfies eligibility criteria of at least one campaign. A transaction event may be generated when a buyer scans a QR code, receives a phone-to-phone NFC payload, or activates a shareable product link and completes a purchase. The system can examine attributes of the transaction event, such as the product identifier, the timestamp, the buyer's location (for example, determined via a device location service, shipping address, or merchant location), and the buyer's account segment or status. The system compares these attributes against stored campaign records to identify any campaigns whose criteria are satisfied for the transaction event. If multiple campaigns are eligible, the system may apply priority or stacking rules to determine which campaign or combination of campaigns to apply.

In block 1258, the system is configured to, when the transaction event satisfies the eligibility criteria of at least one campaign, apply the campaign configuration data to adjust at least one benefit amount, discount amount, or streak progression parameter associated with the transaction event. Applying the configuration can include increasing a base reward rate that is credited to a first buyer who referred the transaction, increasing a discount provided to the second buyer, or both. For example, a campaign may specify that referred purchases for a particular product earn double rewards for a limited period or that new buyers receive an additional percentage discount when purchasing through a shared link. In some embodiments, applying the campaign configuration further comprises accelerating a streak metric associated with the first buyer by counting the transaction event as multiple time periods of activity or by preventing a break in the streak metric if the event occurs within the campaign window. The adjusted benefits and discounts are recorded with the transaction and reflected in the balances and status levels stored for the relevant user accounts.

In block 1260, the system is configured to cause a user interface associated with at least one of a first buyer device or a second buyer device to display a visual indication that the transaction event is subject to the campaign. The visual indication can be used both at the time of purchase and in subsequent history views. For example, during a checkout flow, the system may display a badge or banner indicating that a “product of the week” promotion is active, highlight the extra discount or bonus rewards being applied, and render a countdown timer showing the remaining time in the campaign. On a first buyer dashboard, referred transactions that qualified for a campaign may be tagged or highlighted to show the impact of campaign-driven activity. In some implementations, the visual indication is tailored to the campaign type, such as a specific icon for time-limited promotions versus a different marking for campaigns targeted to a particular geographic region.

In block 1262, the system is configured to receive bid data from a plurality of vendors requesting promotional placement within a campaign interface, to rank products based on the bid data and at least one performance metric, and to display a ranked listing of products within a campaign-specific region of a user interface. For instance, vendors may submit bids for placement in a “featured products” strip shown to users during an active campaign, and the system can combine the bid amounts with factors such as historical conversion rate or user engagement to determine a placement order. The ranked listing may be shown on the home screen of a consumer application, in a dedicated campaign tab, or in a vendor-facing campaign management view that previews how products will appear to consumers.

In some implementations, sponsored placement within a campaign interface is allocated using an auction mechanism. For example, the purchasing service can execute a first-price, second-price, or hybrid auction among eligible products based on bid values received from vendors, where eligibility can be constrained by campaign targeting criteria, inventory availability, geography, time-of-day, or user-segment membership. The purchasing service can additionally enforce budget pacing rules, impression caps, and frequency caps so that a given user account is not presented with more than a threshold number of sponsored placements within a defined time window. Sponsored placements can be visually distinguished from organic placements via a label (e.g., “sponsored” or “promoted”) and can be logged as impression events, click/tap events, and downstream conversion events for subsequent campaign analytics and optimization.

In block 1264, the system is configured to collect real-time performance metrics for each campaign, including, for example, impressions of campaign-linked placements, scan-to-purchase conversion rates, revenue uplift relative to a baseline period, and changes in referral activity or streak metrics. As transactions occur, the system updates aggregated statistics for the campaign and may compute derived measures such as cost per acquisition, average order value under the campaign, or incremental rewards paid. These metrics can be exposed through vendor or operator dashboards to allow continuous monitoring of how campaigns affect purchasing behavior and referral dynamics.

In block 1266, the system is configured to dynamically update at least one campaign parameter based on the performance metrics. For example, if a campaign underperforms relative to a target conversion rate, the system may increase the discount for buyers or raise the reward multiplier for referrers within a configured range. Conversely, if a campaign significantly exceeds expectations, the system may taper benefits or adjust placement rankings to manage budget constraints. Dynamic adjustments can be applied automatically according to rules defined in the campaign configuration or can be surfaced as suggestions to human operators through the campaign management interface. Updated parameters are written back to the campaign data store so that subsequent eligibility determinations and benefit calculations reflect the new configuration.

In some implementations, the purchasing service computes a placement score for each eligible product that combines a bid component with one or more quality or relevance components, such as historical conversion rate, predicted conversion probability for a particular user segment, prior engagement rate, expected margin, or budget consumption rate. The purchasing service can apply tie-breaking rules when placement scores are equal or within a threshold range, including rotating products, prioritizing items with remaining budget, prioritizing items with higher inventory, or prioritizing newly launched products for exploration. Placement scores, auction outcomes, and applied tie-breaking rules can be stored in association with campaign records to provide auditability and to support vendor-facing previews of campaign placement behavior in the campaign management interface.

In some aspects, a system can be configured to implement campaigns as described in connection with method 1250. The system can include one or more processors and memories storing instructions that, when executed, cause the system to receive and store campaign configuration data, associate campaigns with eligible products, user segments, and geographic regions, and evaluate incoming transaction events against campaign eligibility criteria. The instructions can further cause the system to adjust benefit amounts, discount amounts, and streak progression metrics when eligible events occur; to render visual indications of campaign participation in consumer and referrer user interfaces; to process bid data and determine ranked promotional placement for products; and to gather and analyze real-time performance metrics for each campaign. Based on the performance metrics, the system can dynamically modify campaign parameters to improve effectiveness or maintain budget guardrails, thereby providing a flexible and data-driven promotional framework integrated into the purchasing and referral service.

FIG. 12D illustrates an example method 1270 related to a comprehensive vendor application or web portal allows merchants and brands (“vendor-organizations”) to manage their participation in the ecosystem. A vendor user may belong to multiple vendor-organizations and can switch among them via an organization overview interface. For each organization, a product dashboard enables enrollment of new products, editing of product metadata, and generation or export of associated objects (e.g., QR codes, NFC identifiers, or purely digital objects). A checkout-simulation tool can emulate the second-buyer purchase experience for a given product, allowing vendors to preview and tune product landing pages and purchase flows. Vendor-facing analytics can present product-level and organization-wide statistics such as total second-buyer sales, referral counts, top-performing products, campaign-driven conversions, and geographic distributions of activity. A vendor account dashboard may further support management of branding assets, store locations, benefit-policy defaults, fulfillment regions, and team permissions with role-based access control and audit logging.

Referring now to FIG. 12D, an example method 1270 illustrates operations that may be performed by a purchasing service to provide a vendor-facing portal for onboarding products, previewing checkout flows, and monitoring product performance. Method 1270 may be implemented, for example, by one or more server systems of the purchasing service in cooperation with vendor user devices and associated data stores. The example method 1270 can encompass any one or more steps in any order of the steps discussed in connection with FIG. 12D.

At block 1272, the system is configured to provide, via a network, a web portal to a vendor user associated with a vendor-organization. The web portal can be accessed, for instance, through a browser or dedicated application and can present a dashboard view for the vendor-organization that exposes navigation elements, panels, and controls for managing products, campaigns, integrations, and analytics. In some implementations, the system maintains, for the vendor user, associations with multiple vendor-organizations and enables the vendor user to select which organization to manage; the portal can then adjust the displayed data and available actions based on the currently selected organization.

At block 1274, the system is configured to, through the web portal, receive input that enrolls a new product of the vendor-organization into the purchasing service, including product metadata comprising at least a product name and price information. The web portal may present a product-enrollment form in which the vendor user provides additional attributes such as a SKU or identifier, category information, descriptive text, media assets, and optional campaign or eligibility flags. Upon submission, the system validates the provided data, creates or updates corresponding product records in a product catalog data store, and associates the new product with the vendor-organization.

At block 1276, the system is configured to generate, based on the product metadata, a product object associated with the new product. Generating the product object can include assigning a product-object identifier and constructing one or more machine-readable representations that encode at least a product identifier and a vendor-organization identifier. For example, the system may create a QR code image, a URL, and/or an NFC payload that all resolve to the same logical product object in the purchasing service. The web portal may provide controls to download or export these representations so that the vendor can place them on product packaging, in-store signage, digital advertisements, or other marketing materials.

At block 1278, the system is configured to present, within the web portal, a checkout simulation interface that emulates a consumer purchase flow for the product object. When the vendor user selects a preview or simulation option for the product, the system can render, inside the portal, the same or substantially similar sequence of screens that would be shown to a first buyer or second buyer device when interacting with the product object in the field. The simulated checkout flow may include product details, base pricing, applicable discounts, referral messaging, tax and shipping calculations, and payment entry or selection screens. This allows the vendor user to verify that the product object is correctly configured and that the consumer experience is aligned with branding and pricing expectations prior to deployment.

At block 1280, the system is configured to present, within the web portal, a statistics interface that displays performance metrics for the product based on transactions recorded by the purchasing service. As second-buyer purchases and other interactions with the product object occur, the system aggregates metrics such as total sales volume, number of scans or link activations, conversion rates, referral counts, and revenue attributable to specific campaigns. The statistics interface can display these metrics in tables, charts, and summary cards, and may allow filtering by time range, geography, channel (for example, in-store versus online), or campaign. In some instances, the statistics interface also highlights top-performing products for the vendor-organization and presents trend information to help identify growth or decline.

In some implementations, method 1270 further includes block 1282, where the system is configured to provide, within the web portal, an account configuration interface that enables the vendor-organization to manage branding assets, store locations, benefit-policy defaults, and fulfillment regions used by the purchasing service. Through this interface, the vendor user can upload logos and color schemes to be applied in consumer-facing flows, define physical or virtual store locations, specify default reward rates or discount structures for product objects, and constrain where referrals and purchases are recognized based on geographic rules.

At block 1284, the system is configured to implement role-based access controls in the web portal, including receiving invitations issued by an administrator user to additional team members, assigning roles to the team members, and logging administrative actions performed through the portal. For example, roles may include administrator, marketer, analyst, and operator, each with different permissions to enroll products, configure campaigns, change benefit policies, or view sensitive reports. The system records which user performed which action and when, thereby providing an audit trail for compliance and debugging.

In some embodiments, method 1270 additionally includes block 1286, where the system is configured to correlate administrative changes made via the web portal to subsequent changes in performance metrics for one or more products. When the vendor-organization modifies, for instance, pricing, campaign parameters, or product descriptions through the portal, the system can tag these changes and later analyze how metrics such as conversion rate, average order value, or referral volume evolve after the changes. The statistics interface may surface these correlations, helping vendors understand the impact of their configuration decisions and refine their strategies accordingly.

In some aspects, a system can be configured to operate the vendor portal as described in connection with method 1270. The system can include one or more processors and memories storing instructions that, when executed, cause the system to provide network-accessible portal interfaces to vendor users, receive and validate product-enrollment inputs, generate and manage product objects and associated machine-readable codes, and render checkout simulation flows that mirror consumer experiences. The instructions can further cause the system to compute and present product performance metrics, expose account configuration tools for branding and policy management, enforce role-based access controls and maintain audit logs, and analyze relationships between administrative changes and downstream performance. Together, these capabilities enable vendor-organizations to onboard and manage products, preview referral-enabled purchase flows, and optimize participation in the purchasing and referral ecosystem through a unified web-based interface.

FIG. 12E illustrates an example method 1290 in connection with a vendor configuration portal that enables vendors to configure products, benefits, campaigns and so forth in connection with the basic transactions disclosed herein. The example method 1290 illustrates operations that can be performed by a vendor portal of the purchasing service to configure products and associated referral objects. The example method 1290 can encompass any one or more steps in any order of the steps discussed in connection with FIG. 12E.

At block 1292, the system is configured to present, via a vendor interface, a product-management view. The product-management view can be rendered in a web portal or vendor application associated with a vendor-organization and can list one or more products that are enrolled, or eligible to be enrolled, in the purchasing service. The view may include controls for performing one or more of: selecting a product, creating a new product entry, and navigating to configuration panels for objects and benefit rules tied to the product. In some aspects, the product-management view may also expose options for enabling additional behaviors, such as recording data on a blockchain network when a product is purchased, defining sharing channels through which objects or images of objects will be distributed to first buyers, and launching a preview flow that simulates how a second buyer will see a purchasing interface after interacting with an object. Within the same view, the vendor interface can present indicators of current configuration status (for example, whether an object type has been selected, whether benefit rules are defined, or whether blockchain recording is enabled), and may provide inline help or template configurations for common product types.

At block 1294, the system is configured to receive, through the product-management view, one or more of: product data for a product offered for sale; configuration input associated with a respective object to be configured with or on units of the product; and a benefit rule specifying a benefit to be provided to a first buyer of the product when a second buyer purchases a second product based on interaction between a second buyer device and the respective object. The product data can include product name, SKU, descriptive text, pricing and discount information, images, and variant information such as size or color. The configuration input can specify the type of object to be used, such as a near field communication (NFC) tag, a radio-frequency computer chip, a printed graphical code (for example, a QR code or other type of code), or a digital graphical object that will be displayed on a user interface, including on a mobile application, a website, or a social-media platform. The vendor interface can further receive parameters indicating whether the object is to be generated or provisioned at manufacturing time or at a point-of-sale, and can capture workflow settings that cause the graphical code to be printed on a receipt, label, or packaging when the product is purchased.

The configuration input can also specify sharing channels by which the object or an image of the object may be presented to second buyers, including printing on the product or packaging, displaying on a first buyer's device, embedding in a text message, voicemail, or email sent from the first buyer, or embedding in a social-media posting by the first buyer; template content or formatting parameters for such communications can also be entered and stored. In addition, the vendor can provide configuration settings that tell the purchasing service how to interpret interactions with the object (for example, optical scanning of the graphical code versus reading stored data from an NFC tag), define benefit parameters such as money, discounts, coupons, gifts, registrations, or access to venues, and specify whether recorded associations between products and first buyers are to be confirmed on a blockchain network.

At block 1296, the system is configured to store, in a database of the purchasing service, configuration records associating the product, the respective object, and the benefit rule, such that when a second buyer device interacts with the respective object and the second buyer purchases the second product, the purchasing service provides the benefit to the first buyer. The configuration records can capture a product identifier, object-type and object-format parameters, benefit-rule logic, sharing-channel selections, communication templates, and protocol parameters that specify how scans or tag reads are to be interpreted to identify the product and associated first buyer.

Where the object is a physical tag or code that will be attached to individual units, the system can store, for a group of products, records that associate each respective unit with a unique physical-object identifier and, optionally, export data such as programming instructions for an NFC chip or printing instructions for a rendered version of the graphical code. These records enable the purchasing system, when a second buyer device later interacts with a particular object, to identify the corresponding unit and first buyer, process a sale of a second product associated with that unit, and automatically provide the configured benefit to the first buyer. The stored configuration can further include network-access information associated with each physical-object identifier, so that a second buyer device that scans or taps the object is directed to a network-based purchasing service to complete checkout. In some aspects, the system may also store analytics and attribution parameters that allow later generation of reports summarizing second-buyer sales and benefits provided to first buyers based on interactions with multiple objects, and may accept, via the vendor interface, updated configuration parameters in response to these analytics.

In another aspect, the example method 1290 can be applied in a batch-configuration context in which the product-management view presents a batch-configuration view for a group of products rather than a single product. In such an embodiment, the system can receive input indicating that each unit in a group of products is to be made with a respective physical object that is unique to that unit and configured with or on the unit, and can store records that associate each unit with its respective physical object identifier. These batch configuration records can be used by the purchasing system to implement downstream operations including identifying a first buyer for each unit when it is purchased, associating the unit's physical-object identifier with that first buyer, receiving data from second buyer devices that interact with the physical objects, resolving the corresponding unit and first buyer from the stored records, processing second-buyer purchases, and automatically providing benefits to the appropriate first buyers. Additional configuration received and stored can specify how first buyers are identified at purchase time, how benefit parameters vary across units or campaigns, and how object-scan data from second buyer devices are to be interpreted, allowing the same configuration workflow to support both unit-unique and product-level objects.

In yet another aspect, the operations of the example method 1290 are not limited to physical objects. The product-management view can support configuration of objects that include digital graphical elements for display in applications, social-media platforms, benefit-management accounts, or websites. The vendor interface can receive input specifying, for a given product, whether objects are to be configured on or with the physical product, rendered as shareable digital buttons or widgets, or deployed in both physical and digital channels, and can store routing rules indicating whether a second buyer who activates a shareable digital object is to complete checkout within a social-media platform or be redirected to an external purchasing service. The configuration records stored can further encode eligibility parameters controlling when first buyers are permitted to embed shareable digital objects in their own social-media postings, such as minimum purchase counts, registration status with the purchasing service, or opt-in settings, and may include campaign-specific link data so that multiple distinct shareable digital objects can be created for a same product with separate attribution for each campaign or marketing channel.

In some aspects, the operations depicted in FIG. 12E may be implemented by a system comprising one or more processors and one or more memories storing instructions that, when executed, cause the system to perform any of the methods described above. For example, the instructions can cause the system to generate the vendor interface and product-management and batch-configuration views, receive and validate the various configuration inputs, write configuration and unit-level records into one or more databases, and, during subsequent runtime operation, apply the stored configuration when second buyer devices interact with configured objects so that benefits are correctly provided to first buyers in accordance with the defined rules and parameters.

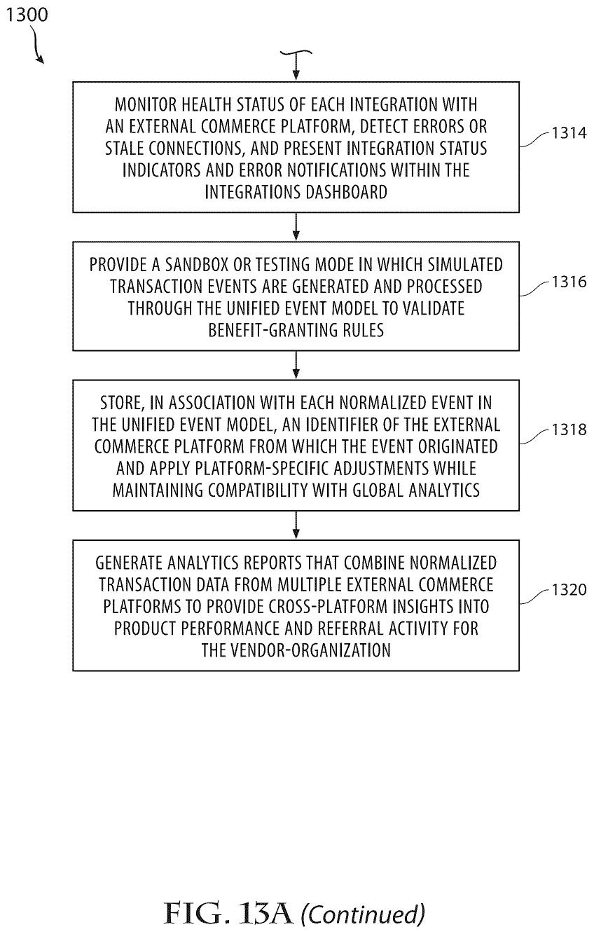

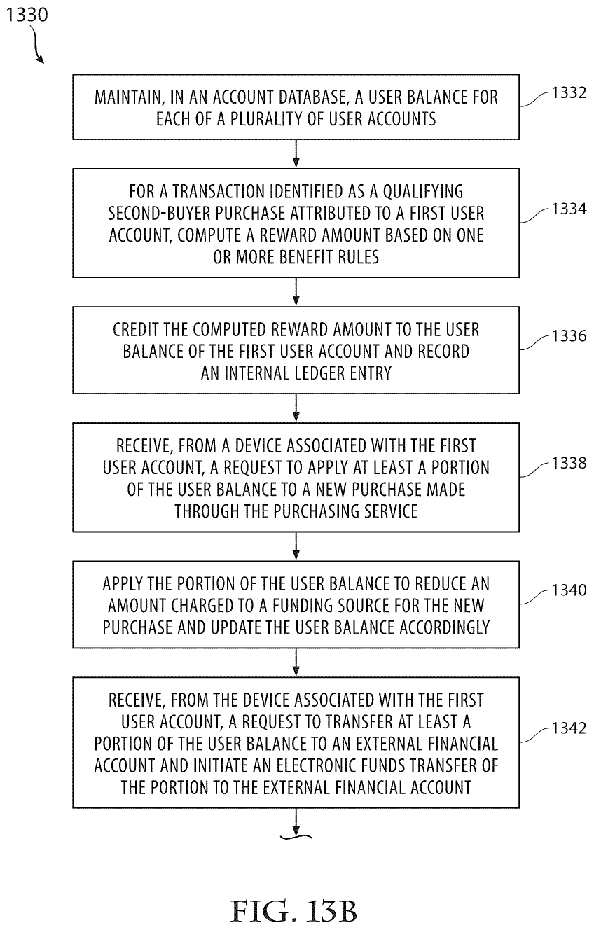

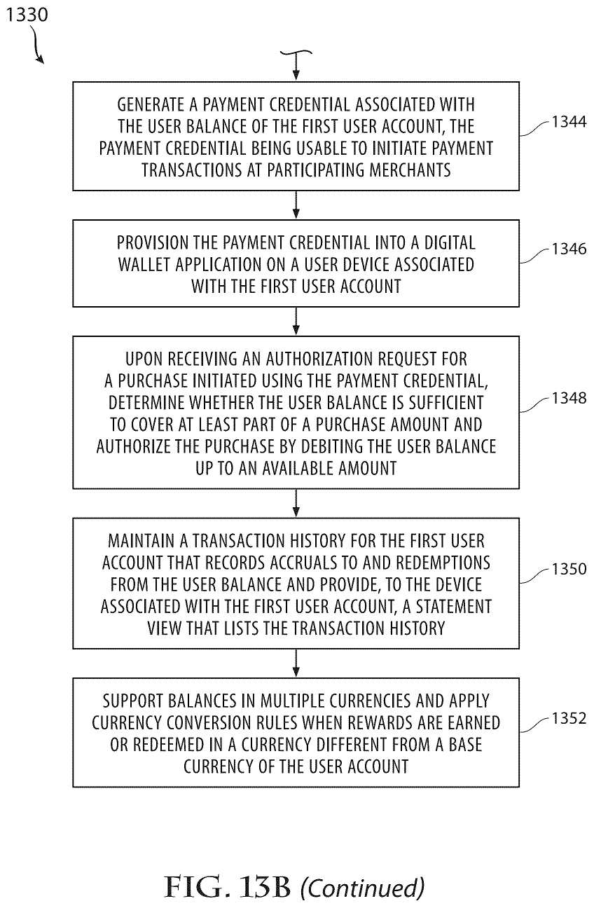

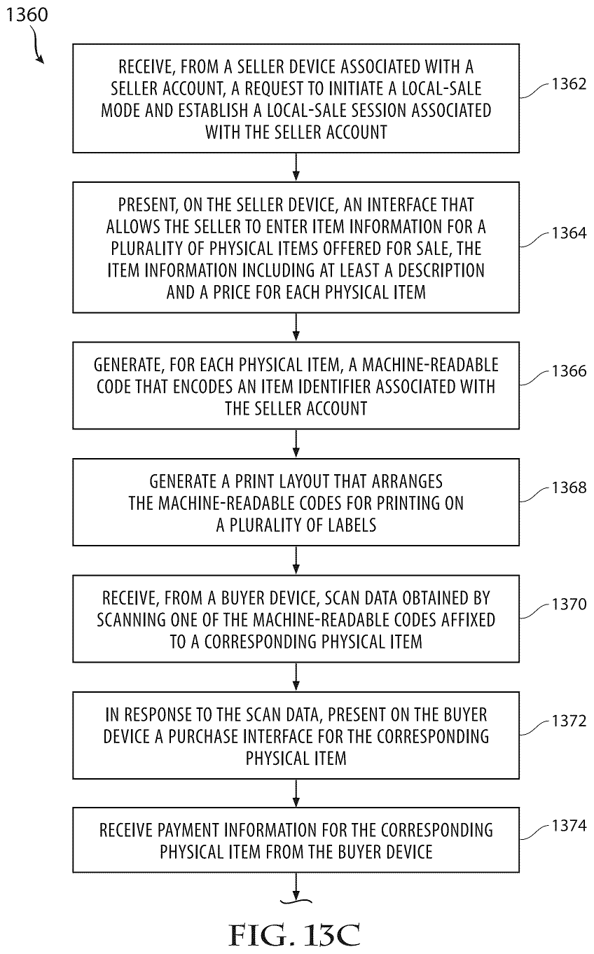

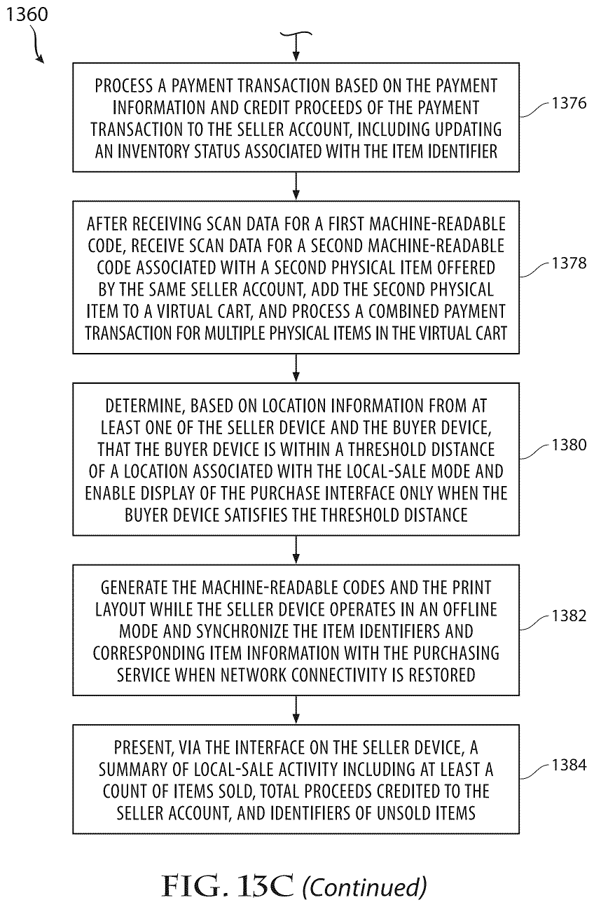

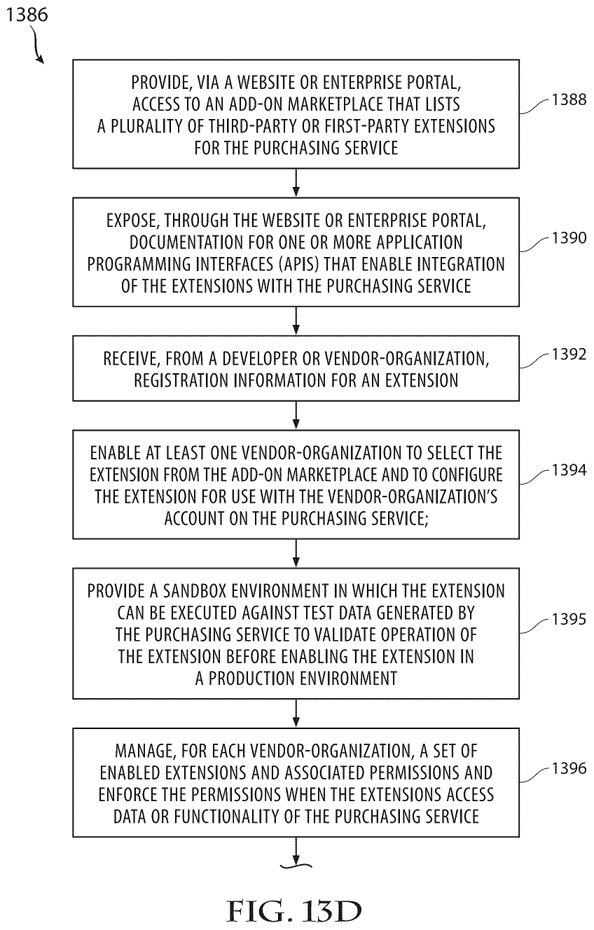

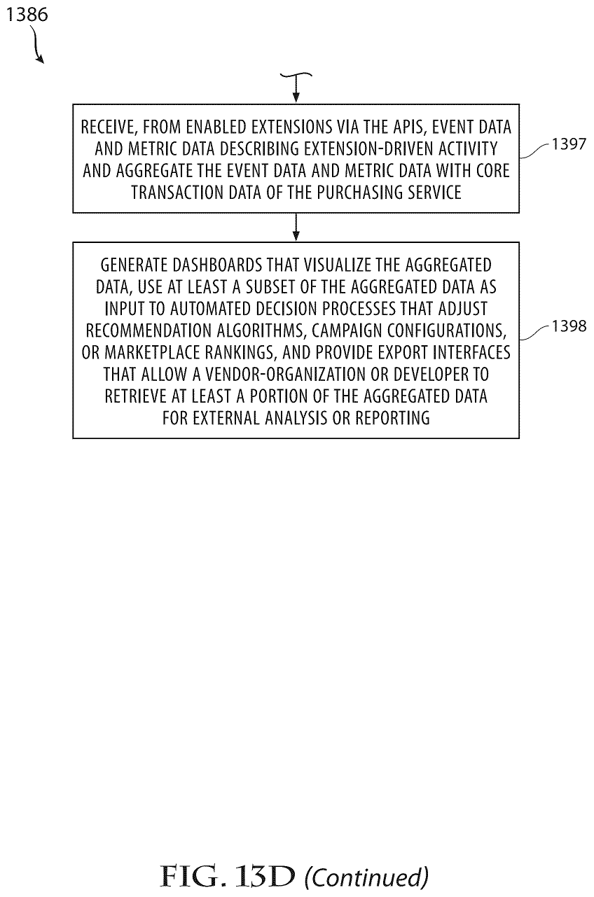

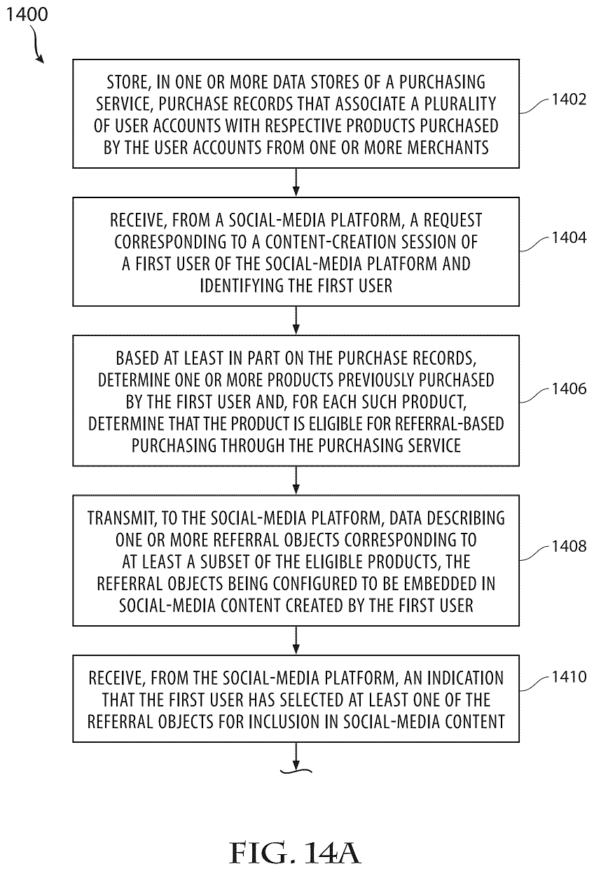

FIG. 13A relates to an example method 1300 related to a vendor application the includes an integrations dashboard for connecting vendor-organizations to third-party payment and commerce platforms such as Stripe, Square, Shopify, and other processors or storefronts. Through this dashboard the purchasing service can guide vendors through authorization flows, retrieve catalog and account metadata, configure mapping between products and external SKUs, and receive normalized transaction events from multiple providers. The purchasing service can then determine when an external transaction corresponds to a qualifying second-buyer purchase associated with a particular object and can apply benefit-granting rules accordingly. Integration status views, error alerts, sandbox testing environments, and multi-platform event normalization logic can be provided to ensure that referral tracking and benefit payouts operate consistently across heterogeneous commerce systems.

Referring now to FIG. 13A, an example method 1300 illustrates operations that may be performed by a purchasing service to integrate with external commerce platforms using an integrations dashboard and a unified event model. Method 1300 may be implemented, for example, by one or more server systems of the purchasing service in cooperation with vendor user devices and third-party commerce systems. The example method 1300 can encompass any one or more steps in any order of the steps discussed in connection with FIG. 13A.

At block 1302, the system is configured to provide, to a vendor-organization via an integrations dashboard, options to connect the purchasing service to a plurality of external commerce platforms. The integrations dashboard can present a list of available platforms, such as different payment processors, point-of-sale systems, or hosted storefronts, and can display information about each platform, including basic descriptions, required permissions, and current connection status. In some implementations, the dashboard also exposes controls to initiate new connections, manage existing connections, and view documentation or setup guides for each platform.

At block 1304, the system is configured to receive, from the vendor-organization, a selection of an external commerce platform and authentication data sufficient to authorize access to an account of the vendor-organization on the selected platform. The authentication data may be obtained, for example, via an OAuth flow, API keys, or other credential mechanisms supported by the platform. The system validates the authentication data and, upon successful authorization, stores connection information linking the vendor-organization's account on the purchasing service with the corresponding account on the external commerce platform.

At block 1306, the system is configured to retrieve, via one or more application programming interfaces of the selected platform, catalog data and transaction event data associated with the vendor-organization's account. Catalog data may include product identifiers, titles, descriptions, pricing, and other metadata defined in the external platform, while transaction event data may include order records, line items, timestamps, payment statuses, and customer identifiers. The system may perform initial bulk synchronization and subsequent incremental updates based on change feeds, webhooks, or scheduled polling.

At block 1308, the system is configured to map products represented in the catalog data from the external commerce platform to product objects of the purchasing service. Mapping can include matching SKUs or product identifiers from the external platform to existing product objects or, when no match exists, creating new product objects within the purchasing service and associating them with the external identifiers. The mapping is stored so that later transaction events from the external platform can be resolved to the correct product objects used for referral tracking and benefits computation.

At block 1310, the system is configured to normalize transaction event data from the selected platform into a unified event model used by the purchasing service. Different external commerce platforms may represent orders and events using heterogeneous schemas, field names, and event types. Normalizing the data can include transforming each raw transaction event into a standardized structure that captures, for example, the product object identifier, the transaction time, the transaction amount, the currency, and any relevant customer or order attributes. In some implementations, the system supports concurrent connections to multiple external commerce platforms and transforms heterogeneous event formats from these multiple platforms into the common unified event model.

At block 1312, the system is configured to determine, based on the unified event model, when a transaction event corresponds to a qualifying second-buyer purchase associated with a particular product object and to apply benefit-granting rules of the purchasing service to the transaction event. Determining qualification may include correlating the transaction event with a prior interaction with a product object, such as a scan of a code, a phone-to-phone NFC exchange, or activation of a shareable link that occurred for the same buyer or session. When a correlation is established, the system identifies the corresponding first buyer or referrer and computes any applicable rewards, discounts, or streak updates based on configured benefit rules. The computed benefits are recorded and ascribed to the appropriate user accounts.

At block 1314, the system is configured to monitor health status of each integration with an external commerce platform, detect errors or stale connections, and present integration status indicators and error notifications within the integrations dashboard. Monitoring can include verifying that scheduled synchronizations are occurring within expected time windows, checking for authentication failures, tracking API error responses, and observing webhook delivery failures. When an issue is detected, the dashboard may highlight the affected integration, display diagnostic information, and prompt the vendor-organization to reauthorize or adjust configuration settings.

At block 1316, the system is configured to provide a sandbox or testing mode in which simulated transaction events are generated and processed through the unified event model to validate benefit-granting rules before those rules are applied to live transaction events from an external commerce platform. In this mode, the vendor-organization or the service operator can generate sample orders, apply hypothetical referral interactions, and observe how the system would map, normalize, and evaluate such events. The sandbox can help verify that mapping, eligibility, and benefit calculations are correct prior to enabling full production synchronization.

At block 1318, the system is configured to store, in association with each normalized event in the unified event model, an identifier of the external commerce platform from which the event originated and to apply platform-specific adjustments while maintaining compatibility with global analytics functions of the purchasing service. Platform-specific adjustments may include handling differences in tax treatment, currency rounding, partial capture behaviors, or refund semantics that vary among providers. By tagging each event with its origin platform, the system can apply these adjustments when computing benefits or reporting metrics, while still treating the event uniformly for higher-level analysis.

At block 1320, the system is configured to generate analytics reports that combine normalized transaction data from multiple external commerce platforms to provide cross-platform insights into product performance and referral activity for the vendor-organization. Reports may include overall sales and referral volumes, conversion rates by source platform, performance comparisons among platforms, and breakdowns by campaign, geography, or time period. These analytics can be presented through dashboards in the vendor portal, exported as data files, or delivered as scheduled reports, allowing the vendor-organization to understand how referral-enabled purchasing performs across their integrated commerce channels.

In some aspects, a system can be configured to implement integrations as described in connection with method 1300. The system can include one or more processors and memories storing instructions that, when executed, cause the system to present an integrations dashboard, receive and store authorization data for external commerce platforms, retrieve catalog and transaction data via platform APIs, map external products to internal product objects, and normalize transaction events into a unified event model. The instructions can further cause the system to correlate normalized events with prior interactions to identify qualifying second-buyer purchases, apply benefit-granting rules, monitor integration health and surface status information, provide sandbox testing capabilities, store origin-platform identifiers and apply platform-specific adjustments, and generate cross-platform analytics reports. Together, these capabilities allow the purchasing service to treat diverse external commerce platforms as coherent sources of referral-aware transaction events while giving vendors a unified view of performance across all connected channels.

FIG. 13B illustrates an example method 1330 relates to how a purchasing service maintains, for each first buyer, a monetary or cash-equivalent user balance representing accumulated reward value from qualifying second-buyer purchases. The user balance may be stored in an account controlled by the purchasing service and may increase as additional referred purchases occur. The first buyer may redeem all or part of the user balance by applying it directly to new purchases made through the service, by transferring value to an external financial account, or by using a payment credential or debit-type instrument provisioned into a digital wallet and backed by the stored balance. When the credential is used at participating merchants, the purchasing service can authorize transactions based on the available user balance and settle payments from the central account.

Referring now to FIG. 13B, an example method 1330 illustrates operations that may be performed by a purchasing service to maintain user reward balances and to support redemption and payment-credential usage backed by those balances. Method 1330 may be implemented, for example, by one or more server systems of the purchasing service in cooperation with user devices, payment networks, and external financial institutions. The example method 1330 can encompass any one or more steps in any order of the steps discussed in connection with FIG. 13B.

At block 1332, the system is configured to maintain, in an account database, a user balance for each of a plurality of user accounts. Each user balance can represent a monetary or cash-equivalent amount accrued by a corresponding user from qualifying referral activity or other reward-generating events. The account database may store, for each user account, a current balance value, currency information, and metadata such as account status and configuration options for how the user is permitted to redeem the balance.

At block 1334, the system is configured to, for a transaction identified as a qualifying second-buyer purchase attributed to a first user account, compute a reward amount based on one or more benefit rules. A qualifying second-buyer purchase may be identified when a second buyer completes a purchase after scanning a product object, receiving an NFC payload, or activating a shareable link that is associated with the first user. The system applies benefit rules that may depend on factors such as the product, the applicable campaign, the first user's status tier, or the transaction amount to calculate a reward that should accrue to the first user's balance.

At block 1336, the system is configured to credit the computed reward amount to the user balance of the first user account. Crediting can include increasing the stored balance value by the reward amount and recording an entry in an internal ledger associating the reward with the underlying transaction. In some implementations, the credit operation may be subject to settlement, clawback, or vesting rules—for example, delaying crediting until a return period expires or reversing a credit if a transaction is refunded—while still treating the user balance as an account maintained by the purchasing service.

At block 1338, the system is configured to receive, from a device associated with the first user account, a request to apply at least a portion of the user balance to a new purchase made through the purchasing service. The request may be initiated when the first user selects an option at checkout to “use balance” or “apply rewards” toward the purchase. The request can specify that the user wishes to apply the entire available balance or a particular portion up to the purchase amount.

At block 1340, the system is configured to, in response to the request, apply the portion of the user balance to reduce an amount charged to a funding source for the new purchase and to update the user balance accordingly. Applying the portion can include determining the maximum balance that may be used, subtracting that amount from the purchase total, and charging any remaining amount to a payment instrument such as a credit card or bank account. The system then decrements the stored user balance by the applied amount and records the redemption in the account ledger.

In some implementations, method 1330 further includes block 1342, where the system is configured to receive, from the device associated with the first user account, a request to transfer at least a portion of the user balance to an external financial account and to initiate an electronic funds transfer of the portion to the external financial account. The external financial account may be, for example, a bank account, stored-value account, or other payment account identified by routing and account numbers or network tokens. The system may perform risk checks, verify ownership, and then initiate a transfer through an appropriate payment rail, such as ACH or a real-time payment network, and update the user balance when the transfer is initiated or settled.

At block 1344, the system is configured to generate a payment credential associated with the user balance of the first user account, the payment credential being usable to initiate payment transactions at participating merchants. The payment credential may correspond to a debit-type card number, tokenized card representation, or another network-compatible credential issued by or on behalf of the purchasing service. The credential is linked to the user's balance account such that authorizations using the credential can be funded by the balance rather than or in addition to external funding sources.

At block 1346, the system is configured to provision the payment credential into a digital wallet application on a user device associated with the first user account. Provisioning can include transmitting tokenized credential data to a wallet provider (for example, a mobile operating system wallet), performing any required verification steps, and enabling the credential to be selected by the user for in-store or online transactions. Once provisioned, the user may present the credential via contactless payments, in-app payments, or browser-based checkout flows at merchants that accept the relevant payment network.

At block 1348, the system is configured to, upon receiving an authorization request for a purchase initiated using the payment credential, determine whether the user balance is sufficient to cover at least part of a purchase amount and to authorize the purchase by debiting the user balance up to an available amount. The system inspects the authorization request, identifies the associated user account, and retrieves the current balance. If the balance is sufficient to cover the full amount, the system may fund the transaction entirely from the balance; if not, the system may fund a partial amount and rely on a backup funding source for the remainder, depending on configuration. After determining the funding allocation, the system responds to the authorization request in accordance with the payment network's requirements and updates the user balance and any backup funding records to reflect the transaction.

At block 1350, the system is configured to maintain a transaction history for the first user account that records accruals to and redemptions from the user balance and to provide, to the device associated with the first user account, a statement view that lists the transaction history. The transaction history may include entries for rewards earned from specific referred purchases, redemptions applied to purchases, transfers to external accounts, fees if any, and payments executed via the payment credential. The statement view can be presented within a mobile application or web portal, allowing the user to review dates, amounts, and descriptions of balance-related activity.

In some embodiments, method 1330 further includes block 1352, where the system is configured to support balances in multiple currencies and to apply currency conversion rules when rewards are earned or redeemed in a currency different from a base currency of the user account. For example, rewards may be generated in the currency of the transaction (such as the currency of the merchant or buyer), and the system can convert reward amounts into the user's base currency using exchange rates available at the time of accrual. Similarly, when the user redeems the balance in a different currency, the system can convert from the base currency to the transaction currency and adjust the balance accordingly, maintaining an internally consistent ledger across currencies.

In some aspects, a system can be configured to implement reward balances and payment credentials as described in connection with method 1330. The system can include one or more processors and memories storing instructions that, when executed, cause the system to maintain monetary balances for user accounts, compute and credit reward amounts from qualifying second-buyer purchases, and support redemption of balances toward new purchases or transfers to external financial accounts. The instructions can further cause the system to generate and provision payment credentials backed by user balances, process authorization requests by debiting balances and coordinating with payment networks and backup funding sources, maintain detailed transaction histories, and handle multi-currency accrual and redemption with appropriate conversion rules. Together, these capabilities enable the purchasing service to function as a balance-holding and payment-initiating platform that integrates referral rewards with flexible, cash-like redemption options.

FIG. 13C is an example method 1360 related to techniques for supporting a local-sale or “garage-sale” mode enabling sellers to rapidly list multiple physical items for local purchase. A seller device associated with a seller account may enter a local-sale mode in which the seller specifies item descriptions and prices for numerous items. The system can generate item-specific machine-readable codes (e.g., QR codes) and arrange them in a print layout aligned with adhesive label sheets for consumer printers. The seller can affix the printed codes to the physical items; a buyer scanning a code is presented with a purchase interface for that item, and payment proceeds are credited to the seller account. The service can support inventory status tracking, multi-item carts for buyers scanning multiple codes, selection among different payment providers, optional location-based gating to ensure proximity to the sale site, offline creation of codes with later synchronization, and seller-facing summaries of local-sale performance.

Referring now to FIG. 13C, an example method 1360 illustrates operations that may be performed by a purchasing service to facilitate a local multi-item sale or “garage-sale” mode for a seller. Method 1360 may be implemented, for example, by one or more server systems of the purchasing service in cooperation with a seller device, one or more buyer devices, and associated data stores. The example method 1360 can encompass any one or more steps in any order of the steps discussed in connection with FIG. 13C.

At block 1362, the system is configured to receive, from a seller device associated with a seller account, a request to initiate a local-sale mode. The request may be generated when the seller selects a “garage sale,” “local sale,” or similar option within a mobile application or web interface of the purchasing service. In response, the system may establish a local-sale session associated with the seller account, assign a session identifier, and retrieve any relevant configuration data, such as default currency, location information, or previously stored item templates.

At block 1364, the system is configured to present, on the seller device, an interface that allows the seller to enter item information for a plurality of physical items offered for sale, the item information including at least a description and a price for each physical item. The interface may present a list or grid where the seller can quickly add items by typing short descriptions (for example, “bike,” “lamp,” “child's chair”) and specifying prices, and optionally add photos, categories, or condition notes. The interface may be optimized for speed, allowing the seller to add multiple items in sequence with minimal input, since local-sale contexts often involve many low-priced items.

At block 1366, the system is configured to generate, for each physical item, a machine-readable code that encodes an item identifier associated with the seller account. Generating the machine-readable code can include creating a QR code or other scannable symbol that, when read by a buyer device, resolves to a record that identifies both the seller account and the particular item within the local-sale session. The item identifier may be unique within the seller's account or for the session, and the system stores item records linking the identifier to the entered description, price, and any additional attributes.

At block 1368, the system is configured to generate a print layout that arranges the machine-readable codes for printing on a plurality of labels. The print layout may be designed to align the codes with predefined regions on a sheet of adhesive labels suitable for a consumer printer, such that each code appears within a distinct label space. In some implementations, the seller can select a label template from a list (for example, common label sheet formats), and the system adjusts sizing and spacing to match the template. The layout may include optional human-readable text, such as a short item description or price, beneath or alongside each code.

At block 1370, the system is configured to receive, from a buyer device, scan data obtained by scanning one of the machine-readable codes affixed to a corresponding physical item. The buyer may use a mobile application of the purchasing service or a compatible code-scanning application to read the code from the item's label. The scan data is transmitted to the purchasing service and includes or allows derivation of the item identifier and seller account, and may also include context such as a timestamp and location of the buyer device.

At block 1372, the system is configured to, in response to the scan data, present on the buyer device a purchase interface for the corresponding physical item. The purchase interface can display the item's description, price, and any additional details entered by the seller, along with payment options supported by the purchasing service. In some cases, the interface may also display the seller's name or display name, a brief explanation of the local-sale mode, and applicable taxes or service fees if any. The buyer may confirm that they wish to purchase the item and proceed to payment.

At block 1374, the system is configured to receive payment information for the corresponding physical item from the buyer device. The payment information may include selection of a stored payment credential, entry of new card or account details, or authorization of a digital wallet or other funding source. The system may perform standard payment processing operations, such as validation of credentials, fraud checks, and preparation of an authorization request to a payment processor or financial institution.

At block 1376, the system is configured to process a payment transaction based on the payment information and to credit proceeds of the payment transaction to the seller account. Processing the payment transaction includes sending authorization and capture requests through a payment network and recording the transaction as completed when approval is received. The system updates the seller's balance or earnings ledger to reflect the credited proceeds, which may be net of any fees or charges retained by the service. In some implementations, the system also updates an inventory status associated with the item identifier from available to sold, so that subsequent scans of the same code will reflect that the item has already been purchased.

In some implementations, method 1360 further includes block 1378, where the system is configured to handle multiple scans and a virtual cart for a buyer. At block 1378, the system is configured to, after receiving scan data for a first machine-readable code, receive scan data for a second machine-readable code associated with a second physical item offered by the same seller account, to add the second physical item to a virtual cart, and to process a combined payment transaction for multiple physical items in the virtual cart. This allows a buyer to walk through a local sale, scan several items of interest, and pay for all of them in a single transaction, reducing friction and streamlining checkout for both buyer and seller.

In some embodiments, method 1360 also includes block 1380, where the system is configured to determine, based on location information from at least one of the seller device and the buyer device, that the buyer device is within a threshold distance of a location associated with the local-sale mode and to enable display of the purchase interface only when the buyer device satisfies the threshold distance. For example, the system may require that the buyer be within a specified radius of the seller's reported location or of the location at which the local-sale session was initiated. This location gating can reduce misuse of the codes outside the intended local context and reinforce that the sale is tied to a physical, local event.

At block 1382, the system is configured to generate the machine-readable codes and the print layout while the seller device operates in an offline mode and to synchronize the item identifiers and corresponding item information with the purchasing service when network connectivity is restored. In an offline scenario, code generation and layout may be performed locally on the seller device using cached application logic, and the item records are queued for later upload. When the seller device reconnects to the network, the system receives the queued item data, associates the item identifiers with the seller account in the central data store, and ensures that buyer scans of the codes are correctly recognized.

At block 1384, the system is configured to present, via the interface on the seller device, a summary of local-sale activity including at least a count of items sold, total proceeds credited to the seller account, and identifiers of unsold items. The summary may be updated in near real time as transactions complete, and may be displayed as a simple dashboard at the end of a sale session or on demand. The seller can review which items sold, which remain unsold, and how much revenue was generated, and may use this information to adjust pricing, decide whether to continue the sale, or plan future events.

In some aspects, a system can be configured to implement the local-sale mode as described in connection with method 1360. The system can include one or more processors and memories storing instructions that, when executed, cause the system to initiate local-sale sessions for seller accounts, present interfaces for entering item information, generate item-specific machine-readable codes and corresponding print layouts adapted to consumer label sheets, and receive and interpret scan data from buyer devices. The instructions can further cause the system to present purchase interfaces, process individual and multi-item payment transactions, update inventory statuses for items, enforce optional location-based gating, support offline creation and later synchronization of item records and codes, and provide sellers with summaries of sale activity and proceeds. Together, these capabilities allow the purchasing service to act as a lightweight point-of-sale and settlement platform for ad hoc, local multi-item sales such as garage sales, estate sales, or pop-up markets.

FIG. 13D is an example method 1386 related to a website or enterprise-grade portal that exposes additional tools, including an add-on or plug-in marketplace, an application programming interface (API) library, and sandbox environments that enable developers and larger merchants to extend or integrate the purchasing service with existing systems. These tools can support custom integrations, specialized analytics modules, experimental campaign types, and enterprise reporting dashboards. Vendor-facing, consumer-facing, and platform-operator dashboards may present rich metric sets including, for example, sales volume, referral counts, conversion rates, average order values, scan-to-purchase ratios, repeat-purchase behavior, demographic and device breakdowns, geographic heat maps, and aggregated balances and cash-flow data maintained by the service. Such metrics can be used by vendors to optimize product offerings and campaigns, by consumers to understand their own referral performance and reward accumulation, and by the service operator to monitor ecosystem health, liquidity, and growth.

Referring now to FIG. 13D, an example method 1386 illustrates operations that may be performed by a purchasing service to operate an extensible platform including an add-on marketplace, APIs, sandbox environments, and analytics capabilities. Method 1386 may be implemented, for example, by one or more server systems of the purchasing service in cooperation with vendor-organization devices and developer systems. The example method 1386 can encompass any one or more steps in any order of the steps discussed in connection with FIG. 13D.

At block 1388, the system is configured to provide, via a website or enterprise portal, access to an add-on marketplace that lists a plurality of third-party or first-party extensions for the purchasing service. The add-on marketplace can present, for each extension, information such as a name, description, provider identity, required permissions, pricing or billing terms if applicable, and compatibility information. The marketplace may be organized by categories (for example, analytics, marketing, integrations, or reporting) and may include search and filter controls that help vendor-organizations discover extensions relevant to their use of the purchasing service.

At block 1390, the system is configured to expose, through the same website or enterprise portal, documentation for one or more application programming interfaces (APIs) that enable integration of the extensions with the purchasing service. The documentation can include API endpoint specifications, authentication requirements, request and response schemas, event formats, rate limits, and example code snippets. In some implementations, the portal provides interactive tools such as API explorers or sample requests that developers can use to test calls to the purchasing service in conjunction with their extensions.

At block 1392, the system is configured to receive, from a developer or vendor-organization, registration information for an extension. The registration information may identify the extension, its provider, and its technical endpoints, and may specify requested scopes or permissions, configuration parameters, and contact information. The system validates the registration information, stores it in an extension registry, and may subject the extension to an approval or review workflow. Once approved, the extension becomes available in the add-on marketplace for vendor-organizations to enable.

At block 1394, the system is configured to enable at least one vendor-organization to select the extension from the add-on marketplace and to configure the extension for use with the vendor-organization's account on the purchasing service. Enabling may include presenting configuration screens that allow an authorized user of the vendor-organization to authorize data access, set extension-specific options, and agree to any applicable terms of use or billing arrangements. When configuration is completed, the system records that the extension is enabled for that vendor-organization and stores the vendor-specific configuration so that subsequent interactions between the purchasing service and the extension are tailored to that account.

At block 1395, the system is configured to provide a sandbox environment in which the extension can be executed against test data generated by the purchasing service, thereby allowing the developer or vendor-organization to validate operation of the extension before enabling the extension in a production environment. The sandbox may include synthetic or anonymized transaction records, referral events, and user profiles that mimic real-world scenarios. The system routes sandbox events to test endpoints designated by the extension, captures the extension's responses, and exposes logs or traces through the portal so that behavior can be verified and debugged without impacting live users or financial balances.

At block 1396, the system is configured to manage, for each vendor-organization, a set of enabled extensions and associated permissions, and to enforce the permissions when the extensions access data or functionality of the purchasing service. Managing the set of enabled extensions can include maintaining records indicating which extensions are active for each vendor, which data categories and operations each extension is authorized to use, and any limits or quotas that apply. When the purchasing service sends data to an extension or processes API requests originating from an extension, the system checks the recorded permissions and denies, logs, or alerts on any attempts to access resources outside the granted scopes.

At block 1397, the system is configured to receive, from enabled extensions via the APIs, event data and metric data describing extension-driven activity and to aggregate the event data and metric data with core transaction data of the purchasing service. For example, an extension may report additional user engagement events, campaign impression metrics, or augmented attribution data. The system normalizes and stores these extension-originated records together with internal records of purchases, referrals, streak metrics, and campaign performance to produce an enriched, aggregated data set for further analysis.

At block 1398, the system is configured to generate dashboards for at least one of vendors, consumers, and a platform operator that visualize the aggregated data, including metrics such as sales volume, referral counts, conversion rates, and liquidity metrics across the purchasing service ecosystem; to use at least a subset of the aggregated data as input to automated decision processes that adjust recommendation algorithms, campaign configurations, or marketplace rankings within the purchasing service; and to provide export interfaces that allow a vendor-organization or developer to retrieve at least a portion of the aggregated data for external analysis or reporting. The dashboards may highlight the impact of individual extensions on performance, help vendors and operators compare results across products and campaigns, and surface trends over time. Automated decision processes can, for example, promote high-performing extensions or campaigns in the marketplace, adjust targeting strategies, or refine default recommendations. Export interfaces may include downloadable reports, scheduled data feeds, or programmatic APIs exposed through the portal, all subject to access controls and privacy policies.

In some implementations, marketplace rankings for extensions, campaigns, products, or vendor offerings are generated using a multi-factor ranking model that combines performance metrics (for example, conversion rate, revenue per impression, retention impact, refund rate, and user satisfaction signals), operational metrics (for example, error rate, latency, compliance status, and support burden), and trust or integrity metrics (for example, anomaly scores, fraud indicators, or detection of coordinated manipulation). The purchasing service can recompute ranking scores on a periodic schedule (e.g., hourly, daily, or weekly), can apply smoothing or decay functions so that older activity contributes less than recent activity, and can enforce minimum-data thresholds before an item becomes eligible for a top-ranked position. In some implementations, the purchasing service supports manual overrides and audit logs for ranking changes and stores the inputs, computed scores, and rule outcomes used to generate a given ranking presentation.

In some aspects, a system can be configured to operate the extensible platform as described in connection with method 1386. The system can include one or more processors and memories storing instructions that, when executed, cause the system to provide a web-based portal that exposes an add-on marketplace and API documentation, receive and register extensions, and enable vendor-organizations to select and configure extensions for their accounts. The instructions can further cause the system to provide sandbox environments for testing, maintain and enforce per-vendor extension permissions, ingest and aggregate extension-generated events with core purchasing-service data, generate dashboards and visualizations over the aggregated data, drive automated adjustments to recommendations, campaigns, or rankings based on those signals, and expose export mechanisms for external analysis.

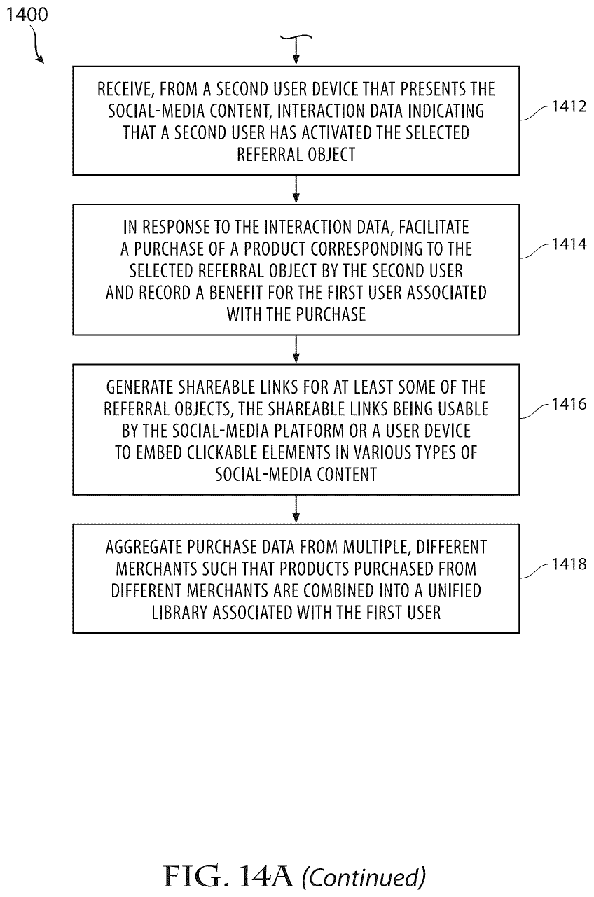

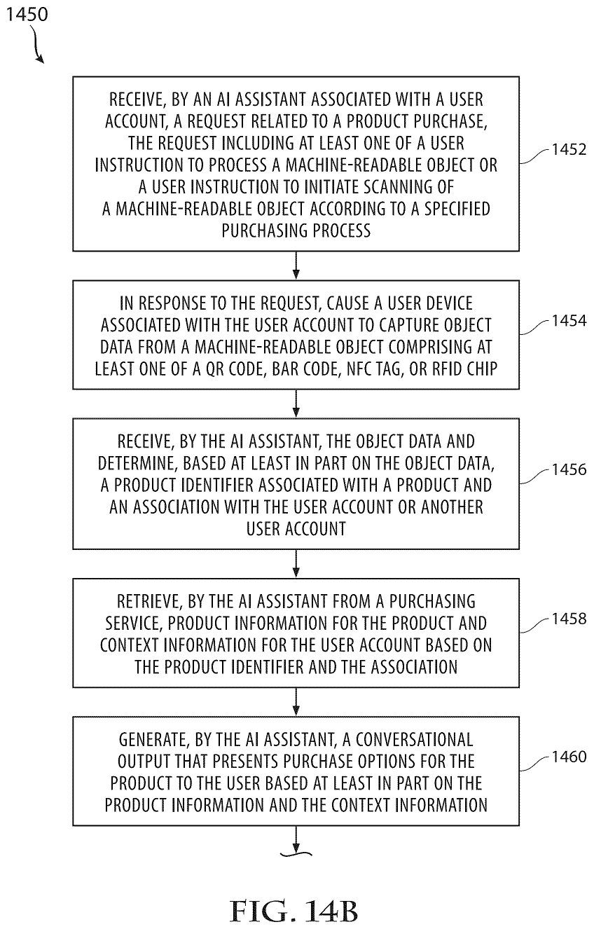

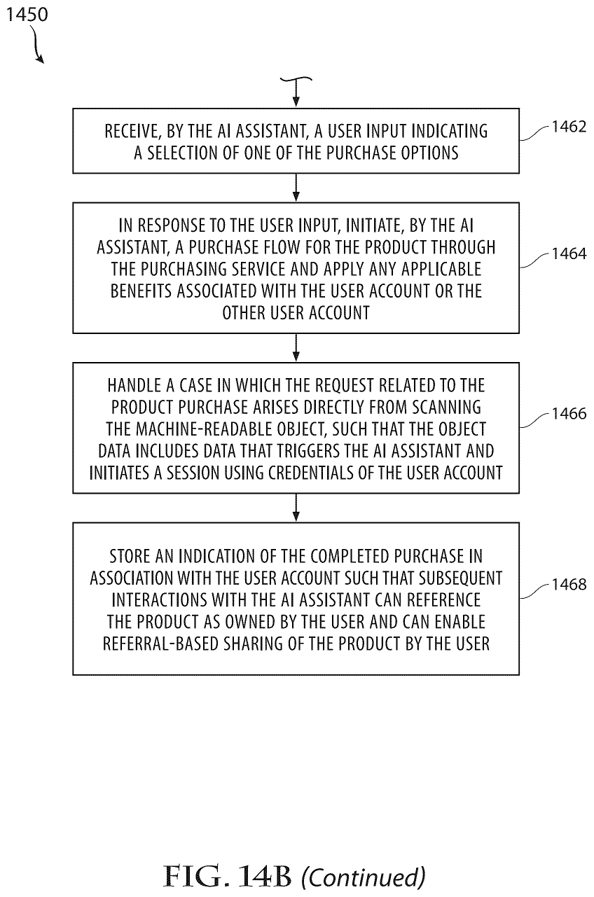

Referring now to FIG. 14A, an example method 1400 illustrates operations that may be performed by a purchasing service to support a social-media widget that enables users to embed referral-enabled product objects in social-media content. Method 1400 may be implemented, for example, by one or more server systems of the purchasing service in cooperation with merchant systems, social-media platforms, and user devices. The example method 1400 can encompass any one or more steps in any order of the steps discussed in connection with FIG. 14A.

At block 1402, a system is configured to store, in one or more data stores of a purchasing service, purchase records that associate a plurality of user accounts with respective products purchased by the user accounts from one or more merchants. The purchase records may be created when users buy products from merchant websites, social-commerce storefronts, or other sales channels and may include identifiers of the purchasing users, product identifiers, and merchant identifiers. In some implementations, the system receives purchase information from merchant systems via application programming interfaces and updates the purchase records to reflect that particular users are associated with particular products for referral purposes.

At block 1404, a system is configured to receive, from a social-media platform, a request corresponding to a content-creation session of a first user of the social-media platform and identifying the first user. The request may be triggered, for example, when the first user opens a reel or post creation interface and selects a control to add a commerce or product object to the content. The request can include a token or identifier that allows the purchasing service to correlate the first user on the social-media platform with a corresponding user account in the purchasing service.

At block 1406, a system is configured to, based at least in part on the purchase records, determine one or more products previously purchased by the first user and, for each such product, determine that the product is eligible for referral-based purchasing through the purchasing service. Determining eligibility can include verifying that the product is enrolled in a referral program, that the first user's purchase was made under conditions that support downstream benefits, and that any merchant-specific or campaign-specific restrictions are satisfied. The result of this step is a set of candidate products that the first user may feature in social-media content with embedded purchase objects.

At block 1408, a system is configured to transmit, to the social-media platform, data describing one or more referral objects corresponding to at least a subset of the eligible products, the referral objects being configured to be embedded in social-media content created by the first user. The data may describe, for each referral object, a product name, image, or icon, and an underlying token, link, or identifier that the social-media platform can attach to a tappable element in the reel, story, or post. The social-media platform may present the referral objects in a composition interface, such as a widget that allows the first user to browse or search products they own, and to select one or more of them to include in the content.

At block 1410, a system is configured to receive, from the social-media platform, an indication that the first user has selected at least one of the referral objects for inclusion in social-media content. The indication can include a reference to the selected referral object and to the particular content item (for example, a draft reel) being created. The system may log the association between the content item, the first user, and the selected product, and may prepare tracking data to attribute future interactions with the embedded object to the first user's referral.

At block 1412, a system is configured to receive, from a second user device that presents the social-media content, interaction data indicating that a second user has activated the selected referral object. The interaction data may be generated when the second user taps or clicks a product icon or button embedded in the social-media content while viewing the reel or post in the social-media application. The interaction data can include an identifier of the referral object, a device or session identifier for the second user, and information about where the interaction occurred.

At block 1414, a system is configured to, in response to the interaction data, facilitate a purchase of a product corresponding to the selected referral object by the second user and to record a benefit for the first user associated with the purchase. Facilitating the purchase can include, in some implementations, causing the social-media platform to present a native commerce interface in which the second user completes the purchase, and receiving transaction information from the social-media platform sufficient to attribute the purchase to the first user. In other implementations, facilitating the purchase can include redirecting the second user device to a checkout flow hosted by a merchant or by the purchasing service, and then receiving confirmation of the completed transaction. In either case, the system identifies the first user as a referrer based on the referral object that was activated and updates benefit records, discount entitlements, or reward balances for the first user.

In some embodiments, method 1400 further includes block 1416, where the system is configured to generate shareable links for at least some of the referral objects, the shareable links being usable by the social-media platform or a user device to embed clickable elements in various types of social-media content. The shareable links can encode both the product identifier and the referrer's user identifier and may be used by the social-media platform as an implementation detail for the embedded referral objects.

At block 1418, the system may be configured to aggregate purchase data from multiple, different merchants such that products purchased from different merchants are combined into a unified library associated with the first user. When the social-media platform requests eligible products, the system selects products from this unified library without regard to which merchant originally fulfilled the purchase, enabling a single widget to surface all referral-enabled products the first user owns.

In some aspects, a system can be configured to implement the social-media widget as described in connection with method 1400. The system can include one or more processors and memories storing instructions that, when executed, cause the system to store purchase records linking users and products across multiple merchants, respond to content-creation requests from social-media platforms by identifying eligible products and generating referral objects, and support embedding of those objects in social-media content. The instructions can further cause the system to receive interaction data from viewers of the content, facilitate purchases through on-platform or off-platform checkout experiences, and record benefits for referring users. Additional instructions may cause the system to generate shareable links for referral objects and to provide a unified, cross-merchant product library that social-media widgets can present to users when creating content.

Referring now to FIG. 14B, an example method 1450 illustrates operations that may be performed by an artificial intelligence (AI) assistant that serves as a primary interface to a purchasing service. Method 1450 may be implemented, for example, by an AI model or AI-powered service in cooperation with user devices and backend purchasing-service components. The example method 1450 can encompass any one or more steps in any order of the steps discussed in connection with FIG. 14B. The AI assistant can be any AI system such as ChatGPT or Grok, for example, The model can be trained on data related to the operations disclosed herein.

At block 1452, a system is configured to receive, by an AI assistant associated with a user account, a request related to a product purchase, the request including at least one of a user instruction to process a machine-readable object or a user instruction to initiate scanning of a machine-readable object according to a specified purchasing process. The request may be provided as a natural-language message to the AI assistant, for example asking to “buy this product using the referral process” or to “scan a QR code for a purchase,” or may be generated when a machine-readable object is scanned and a payload encoded in the object triggers the AI assistant.

At block 1454, a system is configured to, in response to the request, cause a user device associated with the user account to capture object data from a machine-readable object comprising at least one of a QR code, bar code, NFC tag, or RFID chip. Causing the user device to capture the object data can include instructing an application on the user device to activate a camera or NFC interface and to scan the object, or to read data from a tag that the user brings into proximity with the device.

At block 1456, a system is configured to receive, by the AI assistant, the object data and to determine, based at least in part on the object data, a product identifier associated with a product and an association with the user account or another user account. The object data may encode or reference information that identifies a product object in the purchasing service and may optionally include an identifier of a prior purchaser whose referral should be credited if the present user completes a purchase. The AI assistant can parse or interpret the object data and query the purchasing service to resolve the product and any associated account identifiers.

At block 1458, a system is configured to retrieve, by the AI assistant from a purchasing service, product information for the product and context information for the user account based on the product identifier and the association. The product information can include details such as product name, description, price, availability, and any applicable discount or benefit rules. The context information can include previous purchases by the user, existing benefit balances, and any referral relationships relevant to the product or to another user associated with the object data.

At block 1460, a system is configured to generate, by the AI assistant, a conversational output that presents purchase options for the product to the user based at least in part on the product information and the context information. For example, the AI assistant may describe the product and its price, explain available discounts, indicate whether completing the purchase would grant benefits to another user, and offer different payment or shipping options. The AI assistant can present these options in natural language and may request confirmation or selection from the user.

At block 1462, a system is configured to receive, by the AI assistant, a user input indicating a selection of one of the purchase options. The user input may be provided as a conversational response (for example, “Yes, buy it with my saved card”) or through a user interface element presented in conjunction with the AI assistant's output.

At block 1464, a system is configured to, in response to the user input, initiate, by the AI assistant, a purchase flow for the product through the purchasing service and to apply any applicable benefits associated with the user account or the other user account. Initiating the purchase flow can include invoking application programming interfaces of the purchasing service to create an order, select or obtain a payment method for the user, and finalize the transaction, while the AI assistant remains the primary conversational interface that explains progress to the user. Applying applicable benefits can include discounting the purchase price based on the user's benefit balance and crediting referral rewards to another user if the object data indicated a prior purchaser to whom referral credit should be given.

In some implementations, method 1450 further includes block 1466, where the system is configured to handle the case in which the request related to the product purchase arises directly from scanning the machine-readable object, such that the object data includes data that triggers the AI assistant and initiates a session using credentials of the user account. In this case, the AI assistant can begin the conversation by explaining the product referenced by the scanned object and offering to proceed with a purchase.

At block 1468, the system may be configured to store an indication of the completed purchase in association with the user account such that subsequent interactions with the AI assistant can reference the product as owned by the user and can enable referral-based sharing of the product by the user. For example, the AI assistant can later help the user generate referral objects, links, or codes for the product in response to conversational requests.

In some aspects, a system can be configured to implement the AI-assistant embodiment as described in connection with method 1450. The system can include one or more processors and memories storing instructions that, when executed, cause the system to operate an AI assistant capable of receiving conversational and object-based requests, coordinating with user devices to capture object data, interpreting object payloads, and querying a purchasing service for product and user context information. The instructions can further cause the system to generate and present conversational purchase options, accept user selections, orchestrate underlying purchase flows via purchasing-service APIs, apply appropriate discounts and referral benefits, and update account histories so that future conversations can leverage knowledge of prior purchases and referral relationships.

Note that the various methods and systems described above are not meant to be framed as separate embodiments. Any step or feature of any single example or “embodiment” can be mixed and matched with any other step or feature from another example or embodiment. The description is of an overall ecosystem that can change the way products purchases occur within society and any set or subset of features disclosed can be combined to arrange or configure the ecosystem.

In some aspects, the purchasing service and referral logic can be embedded directly into the AI model, such as a large language model-based conversational assistant, instead of being implemented in a standalone mobile application or dedicated website. In this approach, the AI model serves as the primary user interface layer: a user can simply open an AI chat session and say “help me register this product” or “scan this code for my Grapevine rewards,” and the model orchestrates the necessary back-end calls. A QR code or NFC tag on a product can encode a token or URL that, when scanned, launches or resumes an AI session tied to the user's account on the purchasing service. The AI model parses the embedded token, identifies the product and the context (e.g., whether the scan is occurring at the time of purchase or later at home), and guides the user through conversational prompts to confirm identity, consent to participation, and registration of the product in the referral ecosystem. The result is that the same core process of associating a first buyer with a specific product instance and an object (e.g., QR or NFC) is executed, but the entire front-end experience is presented through a conversational AI instead of a custom app interface.

In one example, when a first buyer completes a purchase at a merchant, the point-of-sale or order-confirmation flow can present an option such as “Add this purchase to your AI assistant.” Selecting this option can cause the merchant or purchasing service to send a structured event to the AI model's back-end, including product identifiers, transaction metadata, and a user token. The next time the user interacts with the AI (for example, “what products can I share with friends?”), the model can query a product-wallet or referral-graph service and describe the registered products in natural language, optionally generating links or codes on demand. The AI can also be used to configure benefit rules and sharing preferences in plain English, such as “if any of my friends buys this sweatshirt from my tag, give them 10% off and give me points I can use at this brand,” which the AI translates into structured policy data for the purchasing service. In this way, operations that would otherwise require clicking through multiple vendor-specific screens can be expressed as simple instructions to the AI model, while still producing the same underlying association of first buyer, product, and benefit policy.

For a second buyer, the AI-integrated flow can begin directly from the product itself. A QR code or NFC chip on a unit of the product can encode a reference that, when scanned by a second buyer device, invokes an AI session associated with the purchasing service. The AI model receives the token, determines that it corresponds to a particular first buyer and product, and then engages the second buyer with a contextual conversation such as “You're looking at the backpack Alex purchased—would you like to buy your own?” The model can gather necessary parameters (size, color, shipping address, preferred payment method) via natural language dialog, present price or promotional options, and then call an underlying checkout or payment API to complete the second purchase. Because the scan token is linked to the first buyer's earlier registration, the AI model (or a companion back-end service it calls) can record the transaction as a qualifying second-buyer purchase attributed to that first buyer, without the second buyer ever needing to download a dedicated app or visit a special website.

Once the second purchase is completed, the AI-centric architecture can also manage benefits and downstream interactions. The purchasing service can update the first buyer's reward balance, streak metrics, or status tier, and an event describing the update can be surfaced through the AI model the next time the first buyer interacts (“you just earned five hundred points because a friend bought your sweatshirt link—would you like to apply them to your next purchase?”). The AI model can answer ad-hoc questions about referral performance (“how many people have bought from my codes this month?”), suggest new ways to share objects (“generate a caption and link I can paste into my social-media post”), or help vendors debug and configure physical objects and benefit rules using conversational instructions instead of technical dashboards. In some embodiments, a system embodiment may thus comprise one or more processors and memories executing an AI model that is configured to receive QR/NFC data, converse with users, invoke purchasing-service APIs to associate first and second buyers with products, and cause benefits such as money, points, or miles to be granted, thereby implementing any of the methods described herein through an AI-driven interface. Any concept or process in whole or in part disclosed herein can be imbedded or incorporated into an AI model or generative response engine.

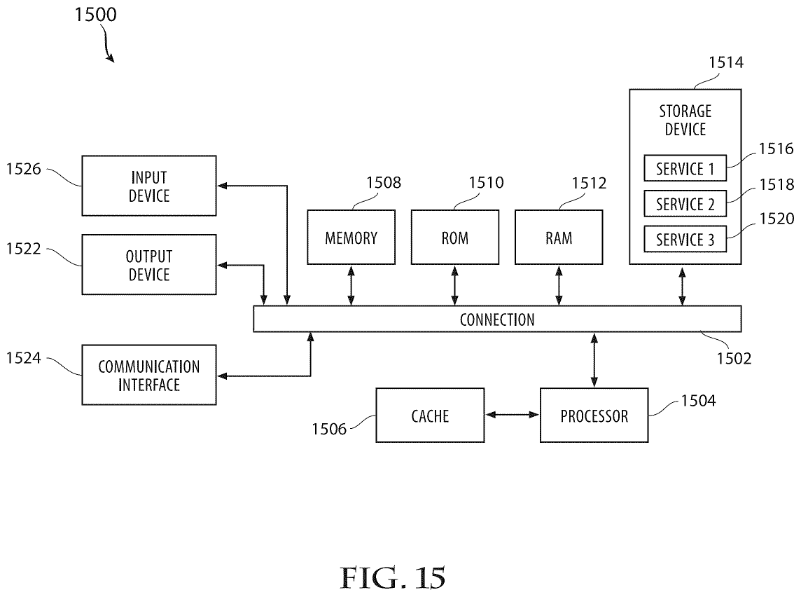

FIG. 15 shows an example of computing system 1500, which can be, for example, any computing device making up any mobile device, computer server, point-of-sale device 112, or any component thereof in which the components of the system are in communication with each other using connection 1502. Connection 1502 can be a physical connection via a bus, or a direct connection into processor 1504, such as in a chipset architecture. Connection 1502 can also be a virtual connection, networked connection, or logical connection.

In some embodiments, computing system 1500 is a distributed system in which the functions described in this disclosure can be distributed across a data center, multiple data centers, a peer network, etc. In some embodiments, one or more of the described system components represents many such components, each performing some or all of the function for which the component is described. In some embodiments, the components can be physical or virtual devices.

Example computing system 1500 includes at least one processing unit (CPU or processor) 1504 and a connection 1502 that couples various system components, including system memory 1508, such as read-only memory (ROM) 1510 and random access memory (RAM) 1512, to the processor 1504. Computing system 1500 can include a cache of high-speed memory 1506 connected directly with, in close proximity to, or integrated as part of processor 1504.

Processor 1504 can include any general-purpose processor and a hardware service or software service, such as services 1516, 1518, and 1520 stored in storage device 1514, configured to control processor 1504, as well as a special-purpose processor where software instructions are incorporated into the actual processor design. Processor 1504 may essentially be a completely self-contained computing system, containing multiple cores or processors, a bus, memory controller, cache, etc. A multi-core processor may be symmetric or asymmetric.

To enable user interaction, computing system 1500 includes an input device 1526, which can represent any number of input mechanisms, such as a microphone for speech, a touch-sensitive screen for gesture or graphical input, keyboard, mouse, motion input, speech, etc. Computing system 1500 can also include output device 1522, which can be one or more of a number of output mechanisms known to those of skill in the art. In some instances, multimodal systems can enable a user to provide multiple types of input/output to communicate with computing system 1500. Computing system 1500 can include communication interface 1524, which can generally govern and manage the user input and system output. There is no restriction on operating on any particular hardware arrangement, and therefore, the basic features here may easily be substituted for improved hardware or firmware arrangements as they are developed.

Storage device 1514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1514 can include software services, servers, services, etc., that when the code that defines such software is executed by the processor 1504, it causes the system to perform a function. In some embodiments, a hardware service that performs a particular function can include the software component stored in a computer-readable medium in connection with the necessary hardware components, such as processor 1504, connection 1502, output device 1522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

A communication interface associated with any system may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

A communications interface may also include one or more GNSS (global navigation satellite system) receivers or transceivers that are used to determine a location of a computing system based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

A storage device can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device can include software services, servers, services, etc., that when the code that defines such software is executed by a processor, it causes the system to perform a function. In some aspects, a hardware service that performs a particular function can include the software component stored in a computer-readable medium in connection with the necessary hardware components, such as the processor, a connection, an output device, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

Aspects of this disclosure can include any feature such as a step or operation described in connection with any aspect which can be combined with any individual feature or operation of another aspect. There is no requirement of individual “embodiments” that are separate from each other conceptually. Claims can be directed to processes from the standpoint of a point-of-sale device, a mobile device, a product itself, a software package or module, an application or “app”, a payment or benefits system as described herein, with all the associated processes such as generating data, transmitting data, receiving data, handling a benefit, making a payment, receiving a payment and so forth being potentially recited for a claim from the standpoint of the respective entity that is being claimed. This disclosure introduces an entire ecosystem that can change the way products are sold and purchased throughout the economy in a way that enhances friendships and relationship between people around the products people love.

Claim clauses include the following:

### Clause Set 1—Social Graph, Friends List, Streaks, Favorites, and User Analytics

Clause 1. A computer-implemented method for managing social referral relationships in a purchasing service, comprising: storing, in one or more data stores, user account records for a plurality of users of the purchasing service; receiving, from a first user device, user identifying data specifying one or more candidate friends of a first user; based at least in part on the user identifying data, establishing and storing a friends list associated with the first user; receiving purchase activity data identifying product purchases made by one or more users on the friends list; and generating, for display on the first user device, a user interface that presents information describing recent purchases made by at least a subset of the users on the friends list.
Clause 2. The method of clause 1, wherein establishing the friends list comprises importing contact information from an address book on the first user device and matching the contact information to user account records of the purchasing service.
Clause 3. The method of clause 1, wherein establishing the friends list further comprises adding a second user to the friends list in response to detecting at least a threshold number of referral transactions between the first user and the second user through the purchasing service.
Clause 4. The method of clause 1, further comprising computing, for the first user, a streak metric representing a sequence of time periods during which at least one qualifying second-buyer purchase attributed to the first user occurred in each time period, and updating the streak metric as additional second-buyer purchases occur or fail to occur.
Clause 5. The method of clause 4, further comprising adjusting at least one benefit parameter associated with the first user, including increasing a reward rate or unlocking a higher tier of status, when the streak metric satisfies a defined threshold condition.
Clause 6. The method of clause 1, further comprising receiving, from the first user device, an indication that the first user has designated one or more products as favorite products, and maintaining a favorites list associated with the first user that identifies the favorite products.
Clause 7. The method of clause 6, further comprising generating, for display on the first user device, an analytics dashboard that presents historical performance metrics for at least the favorite products and top-selling products associated with the first user, the metrics including referral counts, conversion rates, and cumulative rewards earned by the first user.

### Clause Set 2—Phone-to-Phone NFC Exchange, Shareable Product Links, and Link “Wallet”

Clause 8. A computer-implemented method for sharing product objects between users of a purchasing service, comprising: identifying, at the purchasing service, a product object associated with a product and a first user account; responsive to a share request from a first user device associated with the first user account, preparing share data that encodes at least a product identifier and a referrer identifier for the first user; transmitting at least a portion of the share data from the first user device to a second user device using a proximity-based communication interface or a network-based link; receiving, from the second user device, the share data or a token derived therefrom; and in response to the receiving, presenting on the second user device a purchasing interface for the product and attributing any completed purchase through the purchasing interface to the first user account.
Clause 9. The method of clause 8, wherein transmitting the share data comprises establishing a near-field communication (NFC) session between the first user device and the second user device and sending a payload containing the product identifier and the referrer identifier from the first user device to the second user device over the NFC session.
Clause 10. The method of clause 8, wherein transmitting the share data comprises generating, at the purchasing service, a shareable product link that encodes the product identifier and the referrer identifier, and providing the shareable product link to the first user device for posting to a social-media platform or messaging application.
Clause 11. The method of clause 10, further comprising storing the shareable product link in association with the first user account as a virtual object in a wallet or library of shareable objects that can be redisplayed on the first user device for later sharing or redemption.
Clause 12. The method of clause 10, further comprising, upon detecting activation of the shareable product link by the second user device at a time later than posting, determining that the activation corresponds to the first user account based on the referrer identifier and attributing a subsequent purchase of the product by the second user device to the first user account.
Clause 13. The method of clause 8, wherein presenting the purchasing interface comprises including, in the interface, referral messaging that identifies the first user as a recommender of the product and displaying any referral discount or benefit that is applicable to the second user device based on the share data.
Clause 14. The method of clause 8, further comprising assigning an expiration time or usage limit to the share data and disabling presentation of the purchasing interface for activations of the share data that occur after the expiration time or after the usage limit is exceeded.
Clause Set 3—Campaigns, promotions, and sponsored placement
Clause 15. A computer-implemented method for managing promotional campaigns in a purchasing service, comprising: receiving, from an administrator or vendor device, campaign configuration data that defines a campaign including at least one modification to a baseline benefit rule or discount rule of the purchasing service; storing the campaign configuration data in association with one or more eligible products, user segments, or geographic regions; for a transaction event associated with a product object, determining whether the transaction event satisfies eligibility criteria of at least one campaign; when the transaction event satisfies the eligibility criteria, applying the campaign configuration data to adjust at least one benefit amount, discount amount, or streak progression parameter associated with the transaction event; and causing a user interface associated with at least one of a first buyer device or a second buyer device to display a visual indication that the transaction event is subject to the campaign.
Clause 16. The method of clause 15, wherein the eligibility criteria include at least one of: a time window, a geographic location of a buyer device, a product category, or a characteristic of a user segment to which a buyer belongs.
Clause 17. The method of clause 15, wherein the campaign configuration data specifies that the campaign is time-limited, and wherein the visual indication includes at least one of a countdown timer, a badge, or a banner that highlights a remaining duration of the campaign.
Clause 18. The method of clause 15, wherein applying the campaign configuration data comprises increasing a reward rate credited to a first buyer for a qualifying second-buyer purchase or increasing a discount provided to the second buyer for the qualifying second-buyer purchase.
Clause 19. The method of clause 15, wherein applying the campaign configuration data further comprises accelerating a streak metric of the first buyer by counting the transaction event as multiple time periods or by preventing a break in the streak metric when the transaction event occurs within the campaign.
Clause 20. The method of clause 15, further comprising receiving bid data from a plurality of vendors requesting promotional placement within a campaign interface, ranking products based on the bid data and at least one performance metric, and displaying a ranked listing of products within a campaign-specific region of a user interface.
Clause 21. The method of clause 15, further comprising collecting real-time performance metrics for the campaign, including conversion rates and revenue uplift, and dynamically updating at least one campaign parameter based on the performance metrics.

### Clause Set 4—Vendor Application and Dashboards

Clause 22. A computer-implemented method for providing a vendor portal in a purchasing service, comprising: providing, via a network, a web portal to a vendor user associated with a vendor-organization; through the web portal, receiving input that enrolls a new product of the vendor-organization into the purchasing service, including product metadata comprising at least a product name and price information; generating, based on the product metadata, a product object associated with the new product; presenting, within the web portal, a checkout simulation interface that emulates a consumer purchase flow for the product object; and presenting, within the web portal, a statistics interface that displays performance metrics for the product based on transactions recorded by the purchasing service.
Clause 23. The method of clause 22, further comprising maintaining, for the vendor user, associations with a plurality of vendor-organizations and enabling the vendor user to switch, via the web portal, between management views for different vendor-organizations.
Clause 24. The method of clause 22, wherein generating the product object comprises generating a machine-readable code, URL, or NFC payload that encodes a product identifier and a vendor-organization identifier, and wherein the web portal provides controls for downloading or exporting the machine-readable code for placement on packaging or marketing materials.
Clause 25. The method of clause 22, wherein presenting the checkout simulation interface comprises rendering, in the web portal, the same or similar screens that would be shown to a first buyer or second buyer device upon interacting with the product object in the field, thereby enabling the vendor user to verify pricing, discounting, and referral messaging prior to deployment.
Clause 26. The method of clause 22, further comprising providing, within the web portal, an account configuration interface that enables the vendor-organization to manage branding assets, store locations, benefit-policy defaults, and fulfillment regions used by the purchasing service.
Clause 27. The method of clause 22, further comprising implementing role-based access controls in the web portal, including receiving invitations issued by an administrator user to additional team members, assigning roles to the team members, and logging administrative actions performed through the portal.
Clause 28. The method of clause 22, wherein the statistics interface correlates administrative changes made via the web portal to subsequent changes in performance metrics for one or more products, thereby enabling the vendor-organization to assess the impact of portal-configured actions.

### Clause Set 5—Integrations Dashboard and Unified Event Model

Clause 29. A computer-implemented method for integrating third-party commerce systems with a purchasing service, comprising: providing, to a vendor-organization via an integrations dashboard, options to connect the purchasing service to a plurality of external commerce platforms; receiving, from the vendor-organization, a selection of an external commerce platform and authentication data sufficient to authorize access to an account of the vendor-organization on the selected platform; retrieving, via one or more application programming interfaces of the selected platform, catalog data and transaction event data associated with the account; mapping products represented in the catalog data to product objects of the purchasing service; normalizing transaction event data from the selected platform into a unified event model used by the purchasing service; and determining, based on the unified event model, when a transaction event corresponds to a qualifying second-buyer purchase associated with a particular product object and applying benefit-granting rules of the purchasing service to the transaction event
Clause 30. The method of clause 29, wherein the integrations dashboard enables the vendor-organization to connect the purchasing service to multiple external commerce platforms, and wherein normalizing the transaction event data comprises transforming heterogeneous event formats from the multiple platforms into a common schema.
Clause 31. The method of clause 29, further comprising monitoring health status of each integration with an external commerce platform, detecting errors or stale connections, and presenting integration status indicators and error notifications within the integrations dashboard.
Clause 32. The method of clause 29, further comprising providing a sandbox or testing mode in which simulated transaction events are generated and processed through the unified event model to validate benefit-granting rules before the rules are applied to live transaction events from the external commerce platform.
Clause 33. The method of clause 29, wherein determining when a transaction event corresponds to a qualifying second-buyer purchase comprises correlating the transaction event with a prior interaction with a product object, the interaction including at least one of a scan of a code, an NFC exchange, or activation of a shareable link.
Clause 34. The method of clause 29, further comprising storing, in association with each normalized event in the unified event model, an identifier of the external commerce platform from which the event originated and applying platform-specific adjustments while maintaining compatibility with global analytics functions of the purchasing service.
Clause 35. The method of clause 29, further comprising generating analytics reports that combine normalized transaction data from multiple external commerce platforms to provide cross-platform insights into product performance and referral activity for the vendor-organization.

### Clause Set 6—Monetary User Balance and Payment Credential

Clause 36. A computer-implemented method for managing a reward balance for users of a purchasing service, comprising: maintaining, in an account database, a user balance for each of a plurality of user accounts; for a transaction identified as a qualifying second-buyer purchase attributed to a first user account, computing a reward amount based on one or more benefit rules; crediting the computed reward amount to the user balance of the first user account; receiving, from a device associated with the first user account, a request to apply at least a portion of the user balance to a new purchase made through the purchasing service; and in response to the request, applying the portion of the user balance to reduce an amount charged to a funding source for the new purchase and updating the user balance accordingly.
Clause 37. The method of clause 36, further comprising receiving, from the device associated with the first user account, a request to transfer at least a portion of the user balance to an external financial account and initiating an electronic funds transfer of the portion to the external financial account.
Clause 38. The method of clause 36, further comprising generating a payment credential associated with the user balance of the first user account, the payment credential being usable to initiate payment transactions at participating merchants.
Clause 39. The method of clause 38, further comprising provisioning the payment credential into a digital wallet application on a user device associated with the first user account.
Clause 40. The method of clause 38, further comprising, upon receiving an authorization request for a purchase initiated using the payment credential, determining whether the user balance is sufficient to cover at least part of the purchase amount and authorizing the purchase by debiting the user balance up to an available amount.
Clause 41. The method of clause 36, further comprising maintaining a transaction history for the first user account that records accruals to and redemptions from the user balance and providing, to the device associated with the first user account, a statement view that lists the transaction history.
Clause 42. The method of clause 36, wherein maintaining the user balance includes supporting balances in multiple currencies and applying currency conversion rules when rewards are earned or redeemed in a currency different from a base currency of the user account.

### Clause Set 7—Local-Sale/“Garage-Sale” Mode

Clause 43. A computer-implemented method for facilitating local multi-item sales using a purchasing service, comprising: receiving, from a seller device associated with a seller account, a request to initiate a local-sale mode; presenting, on the seller device, an interface that allows the seller to enter item information for a plurality of physical items offered for sale, the item information including at least a description and a price for each physical item; generating, for each physical item, a machine-readable code that encodes an item identifier associated with the seller account; generating a print layout that arranges the machine-readable codes for printing on a plurality of labels; receiving, from a buyer device, scan data obtained by scanning one of the machine-readable codes affixed to a corresponding physical item; in response to the scan data, presenting on the buyer device a purchase interface for the corresponding physical item; receiving payment information for the corresponding physical item from the buyer device; and processing a payment transaction based on the payment information and crediting proceeds of the payment transaction to the seller account.
Clause 44. The method of clause 43, wherein generating the print layout comprises aligning the machine-readable codes with predefined regions of a sheet of adhesive labels sized for a consumer printer.
Clause 45. The method of clause 43, further comprising maintaining, for each item identifier, an inventory status that is updated from available to sold when the payment transaction for the corresponding physical item is successfully processed.
Clause 46. The method of clause 43, further comprising receiving, from the buyer device, scan data for a second machine-readable code associated with a second physical item offered by the seller account, adding the second physical item to a virtual cart, and processing a combined payment transaction for multiple physical items in the virtual cart.
Clause 47. The method of clause 43, further comprising determining, based on location information from at least one of the seller device and the buyer device, that the buyer device is within a threshold distance of a location associated with the local-sale mode and enabling display of the purchase interface only when the buyer device satisfies the threshold distance.
Clause 48. The method of clause 43, wherein generating the machine-readable codes and the print layout is performed while the seller device lacks network connectivity, and further comprising synchronizing item identifiers and corresponding item information with the purchasing service when network connectivity is restored.
Clause 49. The method of clause 43, further comprising presenting, via the interface on the seller device, a summary of local-sale activity including at least a count of items sold, total proceeds credited to the seller account, and identifiers of unsold items.

### Clause Set 8—Add-on Marketplace, APIs, Sandbox, and Metrics Dashboards

Clause 50. A computer-implemented method for operating an extensible purchasing-service platform, comprising: providing, via a website or enterprise portal, access to an add-on marketplace that lists a plurality of third-party or first-party extensions for the purchasing service; exposing, through the website or enterprise portal, documentation for one or more application programming interfaces (APIs) that enable integration of the extensions with the purchasing service; receiving, from a developer or vendor-organization, registration information for an extension; and enabling at least one vendor-organization to select the extension from the add-on marketplace and to configure the extension for use with the vendor-organization's account on the purchasing service.
Clause 51. The method of clause 50, further comprising providing a sandbox environment in which the extension can be executed against test data generated by the purchasing service, thereby allowing the developer or vendor-organization to validate operation of the extension before enabling the extension in a production environment.
Clause 52. The method of clause 50, further comprising managing, for each vendor-organization, a set of enabled extensions and associated permissions, and enforcing the permissions when the extensions access data or functionality of the purchasing service.
Clause 53. The method of clause 50, further comprising receiving, from enabled extensions via the APIs, event data and metric data describing extension-driven activity and aggregating the event data and metric data with core transaction data of the purchasing service.
Clause 54. The method of clause 53, further comprising generating dashboards for at least one of vendors, consumers, and a platform operator that visualize the aggregated data, including sales volume, referral counts, conversion rates, and liquidity metrics across the purchasing service ecosystem.
Clause 55. The method of clause 53, further comprising using at least a subset of the aggregated data as input to automated decision processes that adjust recommendation algorithms, campaign configurations, or marketplace rankings within the purchasing service.
Clause 56. The method of clause 50, further comprising providing export interfaces that allow a vendor-organization or developer to retrieve at least a portion of the aggregated data for external analysis or reporting.

### Clause Set 9—Vendor Application and Dashboards

Clause 1. A method for providing a vendor portal in a purchasing service, comprising: providing, via a network, a web portal to a vendor user associated with a vendor-organization; through the web portal, receiving input that enrolls a new product of the vendor-organization into the purchasing service, including product metadata comprising at least a product name and price information; generating, based on the product metadata, a product object associated with the new product; presenting, within the web portal, a checkout simulation interface that emulates a consumer purchase flow for the product object; and presenting, within the web portal, a statistics interface that displays performance metrics for the product based on transactions recorded by the purchasing service.
Clause 2. The method of clause 1, further comprising maintaining, for the vendor user, associations with a plurality of vendor-organizations and enabling the vendor user to switch, via the web portal, between management views for different vendor-organizations.
Clause 3. The method of clause 1, wherein generating the product object comprises generating a machine-readable code, URL, or NFC payload that encodes a product identifier and a vendor-organization identifier, and wherein the web portal provides controls for downloading or exporting the machine-readable code for placement on packaging or marketing materials.
Clause 4. The method of clause 1, wherein presenting the checkout simulation interface comprises rendering, in the web portal, the same or similar screens that would be shown to a first buyer or second buyer device upon interacting with the product object in the field, thereby enabling the vendor user to verify pricing, discounting, and referral messaging prior to deployment.
Clause 5. The method of clause 1, further comprising providing, within the web portal, an account configuration interface that enables the vendor-organization to manage branding assets, store locations, benefit-policy defaults, and fulfillment regions used by the purchasing service.
Clause 6. The method of clause 1, further comprising implementing role-based access controls in the web portal, including receiving invitations issued by an administrator user to additional team members, assigning roles to the team members, and logging administrative actions performed through the portal.
Clause 7. The method of clause 1, wherein the statistics interface correlates administrative changes made via the web portal to subsequent changes in performance metrics for one or more products, thereby enabling the vendor-organization to assess the impact of portal-configured actions.
Clause 8. The method of clause 1, wherein receiving input that enrolls the new product comprises receiving, through the web portal, additional product attributes including at least one of a stock-keeping unit (SKU), category designation, descriptive text, or image assets, and storing the additional product attributes in a product catalog associated with the vendor-organization.
Clause 9. The method of clause 1, wherein presenting the statistics interface comprises aggregating transaction data for the product to compute the performance metrics, the performance metrics including at least one of total sales volume, a number of scans or link activations, conversion rates, referral counts, and revenue attributable to one or more campaigns.
Clause 10. The method of clause 9, wherein presenting the statistics interface further comprises providing controls that enable the vendor user to filter the performance metrics by at least one of a selected time range, a geographic region, a sales channel, or a campaign identifier.
Clause 11. The method of clause 9, wherein the statistics interface highlights top-performing products for the vendor-organization and presents trend information showing changes in at least a subset of the performance metrics over time.
Clause 12. The method of clause 9, further comprising updating the statistics interface in response to additional transactions involving the product being recorded by the purchasing service so that the performance metrics reflect more recent transaction activity
Clause 13. A system comprising: at least one processor; and a memory storing instructions that, when executed by the at least one processor, cause the system to: provide, via a network, a web portal to a vendor user associated with a vendor-organization; through the web portal, receive input that enrolls a new product of the vendor-organization into a purchasing service, the input including product metadata comprising at least a product name and price information; generate, based on the product metadata, a product object associated with the new product; present, within the web portal, a checkout simulation interface that emulates a consumer purchase flow for the product object; and present, within the web portal, a statistics interface that displays performance metrics for the product based on transactions recorded by the purchasing service.
Clause 14. The system of clause 13, wherein the instructions further cause the system to maintain, for the vendor user, associations with a plurality of vendor-organizations and to enable the vendor user to switch, via the web portal, between management views for different vendor-organizations.
Clause 15. The system of clause 13, wherein generating the product object comprises generating a machine-readable code, URL, or NFC payload that encodes a product identifier and a vendor-organization identifier, and wherein the web portal provides controls for downloading or exporting the machine-readable code for placement on packaging or marketing materials.
Clause 16. The system of clause 13, wherein presenting the checkout simulation interface comprises rendering, in the web portal, the same or similar screens that would be shown to a first buyer or second buyer device upon interacting with the product object in the field, thereby enabling the vendor user to verify pricing, discounting, and referral messaging prior to deployment.
Clause 17. The system of clause 13, wherein the instructions further cause the system to provide, within the web portal, an account configuration interface that enables the vendor-organization to manage branding assets, store locations, benefit-policy defaults, and fulfillment regions used by the purchasing service.
Clause 18. The system of clause 13, wherein the instructions further cause the system to implement role-based access controls in the web portal, including receiving invitations issued by an administrator user to additional team members, assigning roles to the team members, and logging administrative actions performed through the portal.
Clause 19. The system of clause 13, wherein the statistics interface is configured to correlate administrative changes made via the web portal to subsequent changes in performance metrics for one or more products, thereby enabling the vendor-organization to assess the impact of portal-configured actions.
Clause 20. The system of clause 13, wherein the performance metrics displayed in the statistics interface include at least one of total sales volume, number of scans or link activations, conversion rates, referral counts, and revenue attributable to specific campaigns, and wherein the statistics interface provides controls enabling filtering of the performance metrics by at least one of time range, geography, channel, or campaign.

### Clause Set 10—Vendor Application and Dashboards

Clause 1. A method for providing a vendor portal in a purchasing service, comprising: providing, via a network, a web portal to a vendor user associated with a vendor-organization; through the web portal, receiving input that enrolls a new product of the vendor-organization into the purchasing service, including product metadata comprising at least a product name and price information; generating, based on the product metadata, a product object associated with the new product; presenting, within the web portal, a checkout simulation interface that emulates a consumer purchase flow for the product object; and presenting, within the web portal, a statistics interface that displays performance metrics for the product based on transactions recorded by the purchasing service.
Clause 2. The method of clause 1, further comprising maintaining, for the vendor user, associations with a plurality of vendor-organizations and enabling the vendor user to switch, via the web portal, between management views for different vendor-organizations.
Clause 3. The method of clause 1, wherein generating the product object comprises generating a machine-readable code, URL, or NFC payload that encodes a product identifier and a vendor-organization identifier, and wherein the web portal provides controls for downloading or exporting the machine-readable code for placement on packaging or marketing materials.
Clause 4. The method of clause 1, wherein presenting the checkout simulation interface comprises rendering, in the web portal, the same or similar screens that would be shown to a first buyer or second buyer device upon interacting with the product object in the field, thereby enabling the vendor user to verify pricing, discounting, and referral messaging prior to deployment.
Clause 5. The method of clause 1, further comprising providing, within the web portal, an account configuration interface that enables the vendor-organization to manage branding assets, store locations, benefit-policy defaults, and fulfillment regions used by the purchasing service.
Clause 6. The method of clause 1, further comprising implementing role-based access controls in the web portal, including receiving invitations issued by an administrator user to additional team members, assigning roles to the team members, and logging administrative actions performed through the portal.
Clause 7. The method of clause 1, wherein the statistics interface correlates administrative changes made via the web portal to subsequent changes in performance metrics for one or more products, thereby enabling the vendor-organization to assess the impact of portal-configured actions.
Clause 8. A system or computer-readable medium storing instructions to configure the system or one or more processors to perform any one or more operation of any previous clause.

What is claimed is:

1. A method comprising:
presenting, via a vendor interface, a product-management view;
receiving, through the product-management view, one or more of:
product data for a product offered for sale;
configuration input associated with a respective physical object to be configured with or on units of the product, the respective physical object comprising at least one of a near field communication tag or a graphical code; and
a benefit rule specifying a benefit to be provided to a first buyer of the product when a second buyer purchases a second product based on interaction between a second buyer device and the respective physical object; and
storing, in a database of a purchasing service, configuration records associating the product, the respective physical object, and the benefit rule, wherein when the second buyer device interacts with the respective physical object and the second buyer purchases the second product, the purchasing service provides the benefit to the first buyer.

2. The method of claim 1, further comprising:
presenting, via the vendor interface, an option to enable recording on a blockchain network of data confirming an association between the product and the first buyer, and receiving vendor input selecting the option such that the configuration records specify that blockchain recording is to occur when the product is purchased.

3. The method of claim 1, further comprising:
receiving, via the vendor interface, configuration input specifying that, at a point-of-sale for the product, the respective physical object showing the graphical code is to be printed or provisioned; and
storing workflow parameters in association with the product to cause the respective physical object to be generated or provisioned when the product is purchased.

4. The method of claim 1, further comprising:
receiving, via the vendor interface, selections of sharing channels through which the respective physical object or an image thereof may be presented to second buyers, the sharing channels comprising at least one of: printing the graphical code on the product or its packaging, displaying the graphical code on a first buyer device, embedding the graphical code in a communication from the first buyer device, or embedding the graphical code in a social-media posting of the first buyer, and storing the selections as channel configuration data for the product.

5. The method of claim 4, wherein the communication from the first buyer device comprises at least one of a text message, a voicemail, or an email, and wherein the vendor interface further receives template content or formatting parameters for such communications and stores the template content in association with the channel configuration data.

6. The method of claim 1, further comprising receiving, via the vendor interface, configuration settings that specify how the purchasing service is to interpret interactions between a second buyer device and the respective physical object, including at least optical scanning of the graphical code and reading of stored data from the near field communication tag, and storing the configuration settings so that the purchasing service can map received interactions to identification of the product.

7. The method of claim 1, further comprising:
presenting, within the vendor interface, a preview flow that simulates a purchasing interface to be shown on a second buyer device when the second buyer device interacts with the respective physical object, and applying, within the preview flow, the benefit rule associated with the product as configured by a vendor-organization.

8. A method comprising:
presenting, via a vendor interface, a batch-configuration view for configuring a group of products;
receiving, via the batch-configuration view, input associated with the group of products, wherein a respective unit in the group of products is to be made with a respective physical object that is unique to the respective unit and configured with or on the respective unit;
storing, in a database, records associating the respective unit with the respective physical object; and
based on the records, enabling an implementation via a purchasing system of operations comprising:
identifying a first buyer and the respective physical object and storing data in a database associating the first buyer and the respective physical object;
receiving data based on an interaction with the respective physical object by a second buyer device associated with a second buyer;
accessing, based on the interaction with the respective physical object from the second buyer device, the records to identify the respective unit and the first buyer;
processing a sale of a second product associated with the respective unit to the second buyer; and
automatically providing a benefit to the first buyer based on the sale of the second product.

9. The method of claim 8, further comprising:
receiving, via the vendor interface, configuration input specifying that when the respective unit is purchased, a first buyer is to be identified and an association between the first buyer and a respective physical-object identifier for that unit is to be stored in the database, and storing rule data indicating that subsequent interactions by a second buyer device with the respective physical object will cause identification of the first buyer.

10. The method of claim 8, wherein the respective physical object for the respective unit comprises one of a radio frequency computer chip or a graphical code, and wherein export data comprises programming or printing instructions for the radio frequency computer chip or for a rendered version of the graphical code.

11. The method of claim 8, further comprising:
receiving, via the vendor interface, configuration data defining benefit parameters that specify at least one of money, a discount, a coupon, a gift, a registration, or access to a venue to be provided to a first buyer when a second-buyer purchase is attributed to the respective unit from the group of products, and storing the benefit parameters in association with the records.

12. The method of claim 8, further comprising:
receiving, via the vendor interface, configuration data specifying that data from the respective physical object are to be obtained by scanning the respective physical object using the second buyer device; and
storing protocol parameters indicating how a scan received from the second buyer device are to be interpreted to identify the respective unit.

13. The method of claim 8, further comprising:
storing, in association with a plurality of unique physical-object identifiers, network-access information that enables the second buyer device, upon interacting with a respective physical object, to access a network-based purchasing service to enable purchase of the second product associated with the respective unit.

14. The method of claim 8, further comprising:
presenting, via the vendor interface, analytics summarizing, for the group of products, sales of second products and benefits provided to first buyers based on interactions with a plurality of unique physical objects, and receiving, via the vendor interface, updated configuration parameters for the group of products in response to the analytics.

15. A method comprising:
presenting, via a vendor interface, a product-management view;
receiving, through the product-management view, one or more of:
product data for a product offered for sale;
configuration input associated with a respective object to be configured in a manner associated with the product, the respective object comprising at least one of a near field communication tag, a graphical object for display on a user interface, or a graphical code; and
a benefit rule specifying a benefit to be provided to a first buyer of the product when a second buyer purchases a second product based on interaction between a second buyer device and the respective object; and
storing, in a database of a purchasing service, configuration records associating the product, the respective object, and the benefit rule, wherein when the second buyer device interacts with the respective object and the second buyer purchases the second product, the purchasing service provides the benefit to the first buyer.

16. The method of claim 15, wherein the respective object comprises the respective object configured on or with the product.

17. The method of claim 15, wherein the respective object comprises the graphical object displayed on one or more of an application, a social media platform, a first buyer account in a benefit management application, or a website.

18. The method of claim 15, wherein the vendor interface further receives configuration input specifying whether a second buyer who activates a shareable digital object is to complete a purchase through a checkout flow hosted within a social-media platform or through a checkout flow hosted by an external purchasing service, and stores routing rules reflecting the configuration input.

19. The method of claim 15, further comprising enabling a vendor-organization, via the vendor interface, to define eligibility parameters controlling when first buyers become permitted to embed a shareable digital object in their own social-media postings, the eligibility parameters comprising at least one of a minimum number of purchases of the product, a registration status of the first buyer with the purchasing service, or an opt-in indication by the first buyer.

20. The method of claim 15, further comprising providing, via the vendor interface, a link generator that allows a vendor-organization to create multiple distinct shareable digital objects for a same product, each corresponding to a different campaign or marketing channel, and storing attribution data for associating second-buyer purchases with a corresponding campaign when the multiple distinct shareable digital objects are activated.
